(19) United States
(12) Patent Application Publication
(10) Pub. No.: US 2005/0065855 A1
(43) Pub. Date: Mar. 24, 2005

(54) Virtual server consumer authorization, verification and credit update method and article

(75) Inventor: Barry Ira Geller, Sunland, CA (US)

Correspondence Address: MCDERMOTT, WILL & EMERY, 600 13TH STREET, N.W., WASHINGTON, DC, 20005-3096, US

(73) Assignee: Extreming, Inc.

(21) Appl. No.: 10/670,128

(22) Filed: Sep. 23, 2003

(51) Int. Cl. G06F 17/60

(52) U.S. Cl. 705/26

(57) ABSTRACT

An intelligent financial card system, process and article that allows more secure E-commerce transactions with Internet merchants by avoiding the transfer of financial card information to the merchants, while at the same time advantageously employing portions of infrastructure already used in conventional financial card E-commerce transactions. The intelligent financial card verifies itself and acts as its own transaction authorization agent during an E-commerce transaction, thus eliminating the need for a third-party transaction authorization agent and resultant costs to the merchant. The intelligent financial card better protects a merchant against fraudulent E-commerce transactions by providing a customer identity verification system that more reliably verifies that the person using financial card information for the E-commerce transaction is the actual person authorized to do so.

### RELATED APPLICATIONS

The present disclosure relates to U.S. patent application Ser. No. 09/639,364, titled “E-Commerce Enabling Virtual Streaming Multimedia Server, System, Method And Article”, filed Aug. 15, 2000, which is incorporated herein by reference.

### FIELD OF THE INVENTION

The present invention relates to methods and articles for providing payment for E-commerce transactions, and, in particular embodiments, to methods and articles for providing payment for E-commerce transactions in a more secure and private manner.

### BACKGROUND OF THE INVENTION

A typical E-Commerce experience will commonly involve a user who has a computer system equipped with a monitor, a graphics card, a sound card and a connection to the Internet, for example, through a modem. The modem will commonly be used to connect the user's computer via the telephone line to an E-Commerce web site on the Internet.

A user who desires to purchase, lease or otherwise obtain a particular item may employ such a computer system to access a website that provides such items for sale, lease or otherwise. In order to determine which sites provide the desired type of items, the user may employ a search engine and search for the items. A user may also know from experience, advertising, word-of-mouth or a variety of other sources, one or more sites that carry the particular item that the user is seeking.

Alternatively the individual may surf the Internet and, by chance, happen upon item he or she wishes to purchase. This type of buying is commonly termed impulse buying. Impulse buying on the Internet commonly occurs quickly, often in as little as one second, with the click of a mouse. If the impulse purchase is not concluded quickly, the impulse may pass and the sale may be lost.

If the user is searching for a particular item and has found an appropriate site, the user may access the site and then proceed to attempt to locate the desired item. The amount of time that is necessary to find the item to be purchased depends on a variety of factors. The amount of time that it takes to find the desired item is critically important because surveys have shown that, the longer that it takes to find the item to be purchased, the more likely that the user will not complete the purchase. Once the desired item is found, however, the user may fail to complete a purchase for a variety of reasons. One reason that an individual may fail to complete the purchase is that they may become discouraged by the amount of time required to complete the transaction, even after finding the item. Generally the time to complete a transactions depends directly on the speed at which an individual can navigate through the website at which the purchase is to be made. The speed of navigation of an E-Commerce website depends on a variety of factors.

Before a user may attempt to purchase a desired item on a particular website, the user must find the link on the website home page that allows the user to “go shopping.” In addition, once the user has found the link that allows the user to go shopping, the user may be required to select from a series of different categories of products which can be found on that particular website. Adding to the delay of navigating to the correct web page is the delay that is encountered in displaying a particular web page, finding what is pertinent on the page, and then selecting a further web page that is then sent to the user by a server computer. Some web pages are highly complex containing involved graphics, animation files, accompanying sound, video streaming or the like. Such web pages may contain hundreds of kilobytes or even megabytes of data which must be delivered to the user's computer in order to properly display the web page or the user's video selection. The speed with which the data comprising a web page can be delivered to a user also depends on the speed at which the web server is able to stream data to the user. The speed at which the web server is able to stream data to a user may, in turn, be dependant on how many users are simultaneously accessing the website, which can be in the 10's of thousands or even millions, and how many are currently being served by the web server. The speed of delivery of data also depends on how fast the connection is between the web server and the user's computer as well as the capabilities and configuration of the user's machine. The speed of delivery of the data can also be impacted by the time of day, because the traffic on the Internet tends to vary at different times.

A further delay that is encountered, once the user has located the particular item to be purchased, is the process of “checking out.” Checking out may involve the delivery of several different checkout pages and forms to the user as well as several data interchanges between the user's system and the E-Commerce web server. Some surveys show that more than half of the users who start to purchase a product on-line do not end up actually purchasing the product because of site slowdown. Additionally, during peak periods it has been found there may be 100% packet loss of at least one segment of network connection streams due to packets being dropped at Internet connection points.

E-Commerce can provide an order of magnitude improvement in speed over the common brick and mortar type of commerce. To purchase an item using a typical brick and mortar type of commerce a buyer must physically travel (for example, drive) to a location, such as a mall, which sells the desired type of item. The buyer must then park and enter the store. After entering the store the buyer must locate the item desired. While shopping, the buyer may also buy other items on impulse. The likelihood that a buyer will complete an impulse purchase is related to the ease with which the buyer can locate the impulse article. This principle seems to apply whether the buyer is shopping utilizing an E-Commerce website or traditional bricks and mortar type store.

Once the buyer has found the desired item in the store, the buyer may proceed to the checkout to wait in a checkout queue. Additional delays may be encountered in the checkout queue. The checkout queue may be long and individuals ahead of the buyer in the queue may take long periods to complete their transaction. If for example an item is not located within the checkout scanner computer and the price must be located, if a person checking out is paying with a credit card that needs an inordinately long period to authorize, or if an individual who is writing a check has difficulty in procuring the proper authorization, the time spent in the checkout queue can be burdensome. Excessive time spent in actually purchasing an item is a major factor in causing users to abort their transactions.

Although one of the advantages of E-Commerce is that it can be orders of magnitude faster and easier than traditional brick and mortars commerce. The ease and speed with which a transaction can be completed are still major factors in determining whether the transaction is actually completed.

In order to keep the shopping experience relatively fast and, therefore, more pleasant, many E-Commerce website designers attempt to optimize web pages to allow quick navigation through their sites. For example, web page designers may limit the amount of graphics, the resolution of the graphics, and the size of the graphics images so that the amount of data which must be streamed to a user is minimized. If the amount of data which must be streamed to a user is minimized, the website navigation speed can be increased. The tradeoffs for the accelerated navigation may be lower resolution graphics, smaller graphics displays, and very little use of transmission packet intensive techniques, such as video streaming and audio streaming. Website designers may, generally, trade off extensive graphics and data intensive techniques, such as video streaming, in order to promote a faster shopping experience. By limiting the amount of data which must be streamed to a user in order to enable the user to navigate the E-Commerce website, the speed of navigation of a site may be increased.

The shopping experience is also highly dependent on the user's computer system. If a user does not have the particular software necessary to receive data streamed from an E-Commerce website, the user will encounter delays in the shopping experience. Users may be forced to locate and download the necessary software, such as browser plug-ins, which will enable them to access the data from the E-Commerce website. Additionally, older equipment, lack of computer memory and slow modem speeds may render a user's system incapable of handling some of the more demanding web pages.

Other factors that increase delays for the user can significantly diminish the shopping experience. Some delays, however, are endemic to the nature of the Internet. Data transport across the Internet to a remote site, as well as packetizing information into discreet data packets, takes a finite amount of time and therefore produces delay. Whether a user can switch between web pages within a second or two or must wait 20 or 30 seconds to access successive web pages or even return to a previous page can be a critically important factor in determining which transactions complete with a sale, and which complete with the user aborting the shopping experience. Delays beyond 8 seconds in loading a web page can be extremely detrimental to the probability that the user will complete the website interaction with a purchase. Additionally, faster websites will generally develop a reputation as providing an enhanced shopping experience. Such a reputation can provide great advantages in the E-Commerce industry. This is similar to brick and mortar shopping experience, in that the difficulty and bottlenecks inherent in the shopping experience can adversely affect the likelihood of completing a purchase while faster checkout lines can provide an advantageous reputation.

The E-Commerce shopping experience can also be compared to a print catalog shopping experience. A catalog shopping experience is a method of direct marketing, in which a person is provided a printed catalog and then researches the catalog in order to determine which items to order. Once the individual decides on the item or items to be purchased, the individual must then perform a separate action to complete the purchase. The action may involve filling out a form and mailing it to a company or it may involve the calling of an order line, such as an “800” telephone number. Such 800 telephone number order lines may have their own annoying attributes. Commonly, 800 numbers do not connect a person directly to a sales clerk who will take an order. Instead, the caller typically must go through a series of telephone menus and keypad entries in order to select the proper routing of the call. For example, the same 800 number may be used for taking orders and may also be used for procuring return authorization, customer inquiries, billing questions, shipping inquiries or a variety of other uses.

A printed catalog, however, can have advantages over E-Commerce shopping. A person using a printed catalog can quickly flip through the pages and access a large variety of high definition product images within mere seconds, without having to download or wait for an image to build on a computer display.

However, direct marketing through printed catalogs also have difficulties. For example, even though printed catalogs are often sent to a targeted audience, only a very small percentage of the catalogs result in actual product orders. Additionally, when a printed catalog is sent, aside from the name, address and whatever criterion caused the printed catalog to be sent out in the first place, typically little is known about the person to whom the printed catalog is sent. E-Commerce ordering, on the other hand, provides considerable information about the person ordering a product. Because E-Commerce ordering is an interactive experience, a customer may be asked to provide answers to questions, directly. Additionally, when a user shops using an E-Commerce site, the particular items in which the user has expressed an interest may be observed or recorded, by observing or recording which website pages were opened onto the purchaser's computer. It is almost impossible, with a print catalog, to find out which pages provided the most customer appeal. While there is some indication of user preferences from the amount of orders generated for the items on each page, there is no indication of how much time a catalog recipient spends looking at the various pages in a print catalog. In contrast, and E-Commerce provider may observe or record how much time was spent viewing each web page. Such customer data can provide valuable feedback to a merchant.

In the last few years there has been an increasing trend of purchasing, leasing, or otherwise obtaining products and services on Internet E-Commerce sites. The prevalent method of payment for products or services purchased, leased, or otherwise obtained on an E-Commerce site is through the use of credit cards, debit cards, or other financial cards having numbers or other information unique to a particular individual or individuals. If the consumer wishes to obtain a product or service from a particular merchant's E-Commerce site, the consumer typically enters his or her financial card information into a form, such as an HTML form, displayed by the merchant's E-Commerce site.

After the consumer enters the financial card information, a financial card authorization and verification process may take place in order to verify that the financial card appears to be valid and may be authorized. This authorization and verification process may vary, based on the merchant from which goods and services are purchased. Larger, well established merchants may transfer the financial card information provided by the consumer, transaction amount, and merchant identification directly to a banking/financial institution network (“clearing bank”) for fund availability verification. However, smaller or newer merchants, or those with a smaller sales volume, may be required to pay fees to a transaction authorization agent to perform financial card payment processing services for the merchant due to the reluctance of the clearing bank to deal directly with these smaller or newer merchants.

In that case, the smaller merchant or a merchant with a lower sales volume may transfer the financial card information, transaction amount, and merchant identification to the transaction authorization agent. The transaction authorization agent, in turn, may transfer the information to the clearing bank for fund availability verification. The clearing bank verifies that the consumer has sufficient funds available for the transaction.

Once the consumer's funds are verified by the clearing bank, the clearing bank notifies the transaction authorization agent that the consumer's funds are verified. The transaction authorization agent then notifies the merchant of this fact and the merchant may then create an invoice for the transaction and ship the product or provide the service to the consumer. Thus, although these smaller merchants may obtain from the clearing bank the same verification information as the larger merchants, the use of a transaction authorization agent is an significant additional cost of doing on-line business for these merchants.

As an additional part of the authorization and verification process, the clearing bank also typically sends a funds transfer order to the merchant's acquiring bank (“merchant bank”), which holds the merchant's account, as well as to the bank that issued the financial card to the consumer (“issuing bank”). The merchant bank then transfers funds into the merchant's account and receives in exchange the right to collect on the debt owed by the consumer. The issuing bank maintains the consumer's credit card account and must pay out to the merchant's account for the financial card transaction during a subsequent settlement process. The issuing bank then bills the consumer for the debt. Thus, the entry of the consumer's financial card information into the on-line form results, after the authorization and verification process, in a bill to the consumer for the product or service obtained during the E-commerce transaction.

As use of financial cards to obtain goods and services over the Internet has become more and more prevalent, the issue of financial card fraud has become a key concern for both consumers and merchants doing business on the Internet. In addition, the consumer typically is concerned with keeping his or her personal information private.

On the one hand, consumers are reluctant to provide their financial card information over the Internet because they fear that there is a hacker “eavesdropping” and ready to intercept their financial information as soon as they transmit it to the merchant. In addition, consumers are generally aware that their personal information may be sold to others by the merchant.

On the other hand, merchants are reluctant to accept financial card information for a transaction when the cardholder and card are not both physically present. When the cardholder and card are physically present in a brick and mortar merchant store, the merchant may receive a consumer signature and may take an imprint of the financial card. In contrast, during an Internet transaction, it is more difficult for the merchant to ensure that the consumer is actually the person authorized to use the financial card, or even that the financial card is a genuine one. The reluctance of the merchant to accept a transaction on a “Cardholder Not Present” basis is only increased when the merchant knows that he or she will almost always be responsible for any losses incurred if the transaction turns out to be fraudulent. This may be the case even if the merchant has made reasonable efforts to obtain authorization for the transaction from the issuing bank. Thus, accepted fraudulent financial card transactions may significantly affect a merchant's bottom line.

Efforts have previously been made to address the concerns of both the merchant and the consumer. First, in order to address consumers' concerns about the security of their financial information on the Internet, encryption protocols have been developed for secure transmission of financial information over a network. An example of such a protocol is Secure Sockets Layer (“SSL”), which provides reasonably secure transmission of financial card information over the Internet. Most current browsers incorporate SSL and it is supported by most Web servers. Thus, financial transactions carried out on the Internet, and specifically the transaction of obtaining products and services using a financial card, are reasonably well protected against access to financial card information by unauthorized persons.

However, the majority of unauthorized access to consumers' financial card information occurs not during the transaction, but after the transaction is completed and the financial card information is in the possession of the merchant. For example, the merchant may store the consumer's information in a database that is not secure. Unauthorized access to the merchant's database, for example by one of the merchant's employees or by a hacker, may result in the consumer's financial card information being obtained and used in fraudulent transactions. Thus, the consumer's financial card information is currently not well-protected once in the possession of the merchant. Furthermore, once the merchant is in possession of the consumer's financial card information, the merchant has a financial incentive to sell to other merchants information about the consumer such as the consumer's name, e-mail address, and product preferences.

Second, in order to address merchants' concerns about verification of financial card information when the cardholder is not present, various fraud prevention techniques have been made available to merchants. One example is the address verification system (“AVS”) that is used to verify that the address given by the consumer matches that of the cardholder. The transaction authorization agent may provide the AVS functionality to the merchant. A merchant employing AVS may receive an AVS response code for a given E-commerce transaction. The response code may notify the merchant, for example, whether or not the address and zip code used in the E-commerce transaction match those of the cardholder. Thus, if a consumer purchases a product over the internet and gives a shipping address that is different than the address on the financial card, the AVS system may detect this and alert the merchant.

However, although a merchant may be provided with limited protection by using an AVS, he or she may still be vulnerable to more determined and resourceful perpetrators of Internet fraud. For example, in some cases, as a result of identity theft, the perpetrator has more information about the legitimate cardholder than the issuing bank. Thus, the address of the consumer may be known to the perpetrator, and the address given by the perpetrator may match that of the cardholder.

Furthermore, it is possible that algorithms used to produce legitimate financial card numbers, and that are freely available on the Internet, may be used to generate fictitious financial card numbers that will pass existing verification tests. Thus, a totally fictitious financial card may be created and used to bypass the verification safeguards employed by the merchant.

Thus, although verification systems exist for the purpose of verifying that a financial card transaction is genuine, a resourceful Internet criminal can readily bypass the systems and appear to be an authorized user of the financial card. The systems do not verify that use of a financial card is authorized, or even that the financial card is genuine, but only verify that it appears that the financial card is genuine and that it appears that the transaction is authorized.

To ensure the continued growth of E-commerce, both the concerns of consumers for the safety and privacy of their financial information, as well as the concerns of merchants for avoiding Internet financial card fraud, must be addressed.

### SUMMARY OF THE DISCLOSURE

Accordingly, to overcome limitations in the prior art described above, and to overcome other limitations that will become apparent upon reading the present specification, preferred embodiments of the present invention relate, to systems, methods and articles of manufacture which provide a shopping experience which combines many of the advantages of bricks & mortar and catalog shopping with an improved E-Commerce experience.

In particular, preferred embodiments of the present invention provide an “Interactive Media Site” (IMS). The Interactive Media Site is a new way to provide an E-Commerce site to individuals desiring an interactive media shopping experience without delays and drawbacks of shopping from conventional Internet websites. The IMS provides an E-Commerce site integrated and placed on a portable mass storage media, for example, but not limited to, a CD-ROM or DVD (Digital Versatile Disk). Such an Interactive Media Site (IMS) can be loaded from the mass storage media onto the local memory of a user's “host device,” and kept in memory for fast access.

Because the IMS is actually local to the user's computer system, bottlenecks, such as an Internet connection, between the merchant site and the individual customer may be removed. Such a system, loaded from the mass storage media onto the “host device”, may supply all of the necessary pieces to provide a shopping experience similar to, but more advantageous in many ways over, an E-Commerce shopping experience taking place over the Internet. An IMS may contain several components. One component of an IMS is a virtual streaming multimedia server (VSMS). The VSMS performs the same function as a merchant's remote Internet server in a common E-Commerce System, except the IMS is loaded into the memory of the user's local “host device.”

The VSMS will appear to a user to stream multimedia content to the user's host device just as would a common Internet connected web site. However, since the VSMS is in the local memory of the host device, the streaming from the Internet is eliminated or reduced. Because multimedia content is available from the local memory within the host device, all streaming delays associated with the Internet are eliminated with respect to such local content. Streaming may take place from local memory, for example, from the local IMS CD ROM controlled by the VSMS.

In preferred embodiments, the IMS contains a search engine to allow the user to search for different products advertised or described within the IMS. The IMS may be configured to provide a user interface that appears to the user to be very similar to conventional browsers. In this way the user may be familiar with the interface and may not have to learn a new interface for interacting with the IMS.

Also in preferred embodiments, the IMS contains a software module to run transactive content, that is to manage the user/machine E-Commerce interactions. The transactive content engine, or TCE, may be equipped with multimedia capabilities, including a sound and video player, which could be optimized during the installation process of the IMS software on a user's “host device,” thereby taking into account variations inherent in different user systems. The TCE may perform some functions similar to conventional browsers and plug ins. However, unlike conventional browsers the TCE may be optimized during installation.

Current Internet technology is based upon a “Client-Server” model, whereby a merchant's Internet Server is designed to accommodate (i.e., “Serve”) 10's of thousands of user's computers (“Clients”) accessing the server via the Internet at the same time. In contrast, preferred embodiments of the VSMS (also known as the eX-Virtual Server) with its E-Commerce engine serve only a single client or user at a time, and user's files are loaded from the IMS source. Since the files to be loaded are located locally, delays associated with file loading from an Internet site and data packet transmissions, both on the Merchant's server as well as to the user's host device connection, are eliminated with respect to such files.

The VSMS can eliminate many of the drawbacks of current E-Commerce services. For example, because the VSMS is a virtual server and contained within the IMS system on the user's host device, all operations may be conducted within the host device. Additionally, the use of a telephone modem and the consequential tying up of the telephone line for E-Commerce shopping or any other Internet use is eliminated.

Loading an IMS onto a user's system launches a Virtual Streaming Multimedia Server (VSMS). The VSMS is an enclosed software operating system which may provide such facilities as a shopping-cart mechanism and E-Commerce server, and a Streaming Multimedia Transactional Conditioner (SMTC). The SMTC is an assembly of memory management algorithms and rules used during the loading of the VSMS to perform an analysis of the user's host device and to determine the thresholds of optimal operation for the IMS's transactive content. For example, if a user's host device has low memory the VSMS may load less memory intensive routines for performing necessary functions. In addition, the VSMS may save a user's system settings and insert its own settings for use by the IMS system. When the IMS system is no longer in use, then the user's previous settings may be restored. In this manner, the user's host device may be modified during the period of time that the IMS system is being run, in order to optimize the local resources for the IMS's needs.

An entire IMS system may be contained on a CD ROM media and may be designed to fit on CD media having dimensions resembling, for example, a credit card or larger. The IMS may also contain video files, sound files, graphics images, client product catalogues as well as shopping and checkout pages. The user would be able to privately shop and buy products from the VSMS system and then have his or her purchases processed by the VSMS interface without the necessity of being on-line in order to view content and make product selections and register purchases. The VSMS interfaces may then provide an EPO (Electronic Purchasing Order), which may be sent to a company server in merely a few seconds. Additionally, the EPO may be sent via a variety of other means. For example, the order may be sent to a remote site using simply a telephone modem on the user system. In this way a merchant may have an E-Commerce presence without having an actual Internet website.

Alternatively, the IMS system may be programmed to generate an order, which may be sent via e-mail or even printed out and sent to the merchant via a postal mail service or faxed to the merchant directly. This flexibility provides the ability for a customer to choose the mode of ordering with which they feel most comfortable. Commonly the IMS system will place an order to a server that is provided for that purpose. Such a dedicated server (eX-Mother Server) may be located, for example, at a local ISP. Orders generated by the VSMS may then be sent, for example, via modem to the local ISP where they will be routed directly to the dedicated eX-Mother Server. Because the eX-Mother Server is located at the ISP, an order generated at a VSMS can travel to the eX-Mother Server without ever traversing the Internet.

Additionally since the eX-Mother Server is dedicated to IMS commerce, it can provide updates to the IMS, for example, providing new pricing for items on sale or adding items to a catalogue. This may be done, for example, when an IMS in first put into a user's PC. At that time, the IMS may send a query to the eX-Mother for any updates for a particular company or merchant. If there is an update, or if there is a special “sale” of the products on that particular IMS, instructions are given to the VSMS to create/generate the required new pages, either hard coded or virtually, seamlessly for the user. Such “instructions” may be given by from an HTML page generation template which the VSMS has present. The entire transmission may take less than 2 seconds. Additionally the data which is communicated between the IMS and the eX-Mother Server is small as compared with typical Internet E-Commerce data transfers.

Upon a customer placing an order to the remote server (“eX-Mother Server”), the eX-Mother Server may enable preferred E-Commerce credit card processing through a standard credit card authorization clearinghouse company which will return coded authorization status. The eX-Mother Server will then send back approval/disapproval data to the VSMS on the IMS which may then be viewed in a newly created HTML window by the user on the user's local host system. For example, a new browser window generated by the VSMS may produce a message on the user's display to inform the user that the credit card has been disapproved, such as: “Sorry your credit card was not approved or you entered the wrong card number. Please try again with another card.”

In other preferred embodiments, the VSMS can be used in conjunction with a link to merchants sites. Such a link, of course, may be the Internet, a telephone line, a cable modem, a wireless link including radio frequency RF, microwave or satellite, or a variety of other communications links. Through such a link, the VSMS may provide credit card data directly to the merchant, for example, to allow the merchant to provide approve or disapprove and provide an appropriate response to the VSMS, which may then operate with the user's host system, as described above.

Because the VSMS can contain many of the large files and streaming video that would otherwise have to be transmitted across a communications connection, remote pages may be loaded much faster due to Localized Memory Caching (LMC) techniques which may be a part of the Streaming Multimedia Transactional Conditioner. The use of LMC may further enhance the user shopping experience and eliminate many of the delays inherent in the transfer of large data files, which are so common with other forms of Internet E-Commerce.

A user may, for example, make use of the IMS which can link the IMS to a remote server. While the user, effectively, never leaves the Interactive Media Site that is provided by loading the IMS on the user's system, the IMS may be in contact with and controlling a remote server through the use of embedded commands, such as may be provided by a language designed for that purpose. Such command may be embedded within HTML pages on the IMS or may exist as extensions to the eX-Virtual Server (VSMS). By having much of the functionality of the Interactive Media Site and the data needed for the transactive experience resident locally, commonly experienced Internet bottle-necks may be eliminated or, at least, minimized.

Embodiments of the present invention have applicability for user profiling and “data mining” techniques that may be utilized to track the user's path through an IMS's transactive content. This data may then be later sent to the merchant or company that provided the IMS, for example, when an order is generated. Such user profiling and data mining techniques may provide to the merchant, or others, valuable insights into shopping habits of the purchaser.

The user may also take advantage of the data mining. For example, when a catalogue recipient thumbs through a print catalogue, certain pages may be of interest to the recipient. Later, if the recipient decides to procure a product seen on one of the pages of the print catalogue, the recipient may find it difficult to locate the particular page that contains that product. By using embodiments of the present system, the user may be presented with a trail of “product pages” or items, which had previously been accessed by the user, within the IMS. In addition, or as an alternative, the user may select and “bookmark” pages of interest, as the user browses through the content in the IMS. The VSMS may be configured to fashion customized pages from the bookmarked selections entered by the user as the IMS product pages are viewed. For example, after one or more shopping or browsing experiences, a user may generate a timeline, based upon category and interest of their past shopping or browsing behavior, in order to help the user quickly locate items which interested them.

Using such historical data, a merchant or company promoting their products on the IMS may determine how long a potential customer spends on different pages and views different products. The merchant or company can also find out what content a user accessed and what products the user viewed, even if no purchase occurred. For example, the user's IMS history may be sent to eX-Mother for data-mining when the user next logs on to the Internet or, alternatively, the VSMS itself may automatically log the user's modem onto the Internet and send this data. When the user finally does purchase a product the merchant or company is able to tell how long it took to finally make the sale.

Additionally the historical data can reveal a user's interest that can then be used to arrange the future presentation of items on the IMS. For example if a user is shopping for running shoes the historical data may show such an interest. Then, if another IMS is loaded on the user's host device, it can detect this interest and rearrange the IMS to present pages featuring running shoes to be presented first. In other words a user's preferences could be used to determine the presentation of future information, content, web page arrangement, and the like, such as may be on further IMSs.

Further embodiments of the present invention overcome disadvantages in conventional financial card E-commerce transactions by providing a virtual server consumer authorization, verification and credit update method and article that allows more secure E-commerce transactions with Internet merchants by avoiding the transfer of financial card information to the merchants, while at the same time advantageously employing portions of infrastructure already used in conventional financial card E-commerce transactions.

Yet further preferred embodiments of the present invention advantageously increase Internet merchants' profits by providing an intelligent financial card that verifies itself and acts as its own transaction authorization agent during an E-commerce transaction, thus eliminating the third-party transaction authorization agent and resultant costs to the merchant.

Additional preferred embodiments of the present invention better protect a consumer's financial card information as well as privacy by enabling an E-commerce transaction with an Internet merchant while avoiding the transfer to the merchant of not just the customer's financial card information, but any personal customer information at all. The merchant merely receives a customer identification number.

Yet further preferred embodiments of the present invention better protect a merchant against fraudulent E-commerce transactions by providing a customer identity verification system that more reliably verifies that the person using financial card information for the E-commerce transaction is the actual person authorized to do so.

Preferred embodiments of the invention may include on the IMS storage medium embedded and encrypted financial card information of the consumer. The embedded data may be an actual encrypted or unencrypted financial card number. In addition, or in the alternative, the embedded data may be data that may be linked in some manner to the actual financial card number. For example, the data may be a data string containing identification information such as, but not limited to, various passwords, PINs, or other identification information known to the bank customer. In addition, or in the alternative, the identification information may be a machine identification such as, but not limited to, an IP address of a computing type platform. Access to the actual financial card number may then be dependent on the bank customer providing the correct identification information during a query/response process.

The consumer's IMS financial card information embedded on the IMS storage medium may include credit or debit card information (depending, for example, on the credit status of the consumer). In one embodiment, a bank may issue the IMS financial card to preferred bank customers, for example in a targeted mailing campaign. The receipt of the IMS storage medium by the bank's customers would be similar to a bank customer receiving a new ATM or credit card from their bank in the mail. In other preferred embodiments, the bank may require a customer wishing to receive the IMS financial card to pre-register with the bank. Thus, only customers who specifically requested an IMS financial card may receive one.

In one embodiment, the bank customer may be required to register or activate the received IMS financial card in a manner similar to the activation of a new ATM or other financial card received by mail. The registration process may, in some preferred embodiments involve the designation by the bank customer of one or more passwords or personal identification numbers (“PIN”) that may later be used to verify that the person using the IMS financial card for an E-commerce transaction is authorized to do so. In some preferred embodiments, the bank customer's existing PIN (for example, an existing ATM card PIN) may be used in combination with one or more registered passwords or additional registered PINs for verification purposes.

In some preferred embodiments, the IMS storage medium may include financial card information of the bank customer, along with one or more virtual stores or virtual shoppable catalogs provided by one or more merchants. A virtual store may comprise one or more shoppable catalogs containing, for example, related items such as furniture, toys, sports equipment, apparel, and other products and/or services. In some embodiments, the IMS storage medium may include a merchant identification number and merchant account data for each merchant providing a virtual store on the IMS storage medium. The merchants represented on the IMS storage medium may, in some embodiments, have contracted with the bank to provide the virtual stores on the IMS storage medium in a business relationship similar to the present practice of including the merchants' promotional fliers within the customers' monthly bank statements. Thus, the bank may advantageously use the business relationship with the merchant to generate additional revenue from financial card sales. Similarly, the merchant may advantageously use the business relationship with the bank to promote its products and/or services to new customers.

In some preferred embodiments of the present invention, the VSMS/IMS system running an Interactive Media Site enables a consumer to engage in an off-line E-commerce transaction with the merchant's virtual store on the IMS storage medium, as previously described in detail above. Thus, the consumer does not need to be connected to the Internet to engage in E-commerce transactions. Instead, the consumer's local host device launches the VSMS contained on the IMS storage medium which in turn controls an Interactive Media Site that may connect to an eX-Mother Server via a communications link such as, but not limited to, a modem and a live telephone line or a continuous connection via a DSL line, wireless, via a cable modem, or other suitable communication medium.

The consumer may privately shop and buy products from the merchants' virtual stores and then have his or her purchases processed by the VSMS interface without the necessity of being on-line in order to view content and make product selections and register purchases. Orders placed by the consumer and generated by the VSMS may then be sent, for example via telephone modem, cable modem, DSL, a wireless interface, or other suitable communication medium, to the dedicated eX-Mother Server. In preferred embodiments, the consumer's IMS financial card information is not provided to the merchant involved in the E-commerce transaction.

In other preferred embodiments of the present invention, the consumer may shop and buy products on-line from one or more merchants' websites. Thus, the Interactive Media Site may include one or more links to one or more merchants' on-line websites. By selecting a particular link, the consumer may be connected to a merchant website via, for example, the Internet. The consumer may then obtain products or services from the merchants' websites. In preferred embodiments, once the products or services have been selected by the consumer, the ordering process may be transferred back to the eX-Mother Server to avoid providing the IMS financial card information to the merchant involved in the E-commerce transaction. However, in other embodiments of the present invention, even if a link to a merchant's website is included on the IMS storage medium to enable the consumer to visit the merchant's website, all shopping and ordering functions of the E-commerce transaction may nevertheless be performed only off-line within the merchant's virtual store or catalog located on the IMS storage medium.

In some preferred embodiments, the merchant website's servers may be running proprietary plug-in software that communicates with the eX-Mother Server, identifies the merchant, for example by an encrypted merchant identification number, and stores in a database consumer's orders and corresponding encrypted consumer identification numbers. The proprietary software may be provided to the merchant for a fee or at no cost by the operator of the eX-Mother Server.

In preferred embodiments of the present invention, whether the selection and ordering of products or services is made off-line or on-line, the financial card information of the consumer may not be provided to the merchant. Instead, the financial card information may be sent to the eX-Mother Server directly by the media on which embodiments of the invention reside (i.e., whatever the medium the VSMS or IMS is stored on or operative from). The eX-Mother Server may, in turn, directly transfer the financial card information, as well as the transaction amount and merchant identification, to a clearing bank without use of a transaction authorization agent and without a merchant ever receiving the financial card information. The IMS financial card thus acts as its own transaction authorization agent during an E-commerce transaction according to embodiments of the present invention, eliminating the third-party transaction authorization agent and resultant costs to the merchant. In some embodiments, a clearing bank may employ proprietary plug-in software that communicates with the eX-Mother Server and receives and decrypts data sent from the eX-Mother Server. The proprietary plug-in software may be licensed to the clearing bank by the operator of the eX-Mother Server.

Other embodiments of the invention do provide the financial card information to the merchant. However, because the financial card information is embedded on the IMS storage medium, it may be loaded into memory of a host device when the IMS storage medium is accessed by the host device and sent to the merchant without the consumer having to enter the financial card information into an on-line form. Thus, embodiments of the present invention provide a more enjoyable E-commerce transaction for the consumer.

Various embodiments of the present invention described below employ various levels of verification and authorization security for ensuring that the consumer using the financial card information embedded on the IMS storage medium for an E-commerce transaction is the person authorized to do so. Some embodiments of the present invention do not include a verification and authorization process, but instead send purchase information, merchant identification, customer identification, and financial card information for a particular E-commerce transaction directly to a clearing bank. Other embodiments of the present invention employ a conventional financial card authorization and verification process to verify and authorize the use of the IMS financial card.

Preferred embodiments of the present invention employ an interactive authorization and verification sequence (“IAVS”) that includes entry by the consumer of one or more passwords and/or PINs in response to queries from the eX-Mother Server or the issuing bank. Yet other preferred embodiments employ an IAVS using modular re-constructive re-sequencing identity validation algorithms to more reliably verify and authorize the use of the IMS financial card.

These and other features and advantages of embodiments of the present system will become apparent by reading and understanding the present specification in conjunction with the drawing provided herein.

### BRIEF DESCRIPTION OF THE DRAWINGS

Referring now drawings in which consistent numbers refer to like elements throughout the drawings.

FIG. 1 is a block diagram of prior art E-Commerce system illustrating a user's computer coupled to an E-Commerce server via the Internet.

FIG. 2A is a graphic illustration of a system contained within a host device according to embodiments of the invention.

FIG. 2B is a graphic illustration of a system according to further embodiments of the invention, including portions of the system contained within a host device and portions of the system outside of the host device.

FIG. 3 is a flow diagram illustrating a process of checkout and installation of software on the user's host device according to an embodiment of the invention.

FIG. 4 is a flow diagram further illustrating a process of checking user's host device hardware according to embodiments of the invention.

FIG. 5 is a flow diagram further illustrating a process of checking user's host device software according to embodiments of the invention.

FIG. 6 is a flow diagram further illustrating a process of checking user's host device connectivity according to embodiments of the invention.

FIG. 7A is a further illustration of a process of loading software to the host device according to embodiments of the invention.

FIG. 7B is an illustration of further portions of the process of FIG. 7A, showing interaction between an eX-Mother Server and a Virtual Streaming Multimedia Server, according to embodiments of the invention.

FIG. 8 is a block diagram illustrating a functional inner connection between an eX-Virtual Server, an E-Commerce engine and an eX-Browser according to embodiments of the invention.

FIG. 9 is a block diagram further illustrating system functionality according to embodiments of the invention.

FIG. 10 is further illustration of functions of an E-Commerce Engine according to embodiments of the invention.

FIG. 11 is a block diagram showing functions of an eX-Browser according to embodiments of the invention.

FIG. 12 is an illustration of portions of an exemplary electronic catalogue according to embodiments of the invention.

FIG. 13 is a graphical illustration of an exemplary implementation of the shopping diary function according to an embodiment of the invention.

FIG. 14 is an illustration of a conventional authorization and verification system and process for a conventional financial card E-commerce transaction.

FIG. 15 is an illustration of an E-commerce transaction employing an IMS storage medium having embedded and encrypted financial card information, according to an embodiment of the invention.

FIG. 16 is an illustration of an E-commerce transaction employing an IMS storage medium embedded and encrypted financial card information, an encrypted consumer banking identification number, encrypted merchant account information, and a virtual store, according to an embodiment of the invention.

FIG. 17 is an illustration of an E-commerce transaction employing an IMS storage medium including an encrypted data string, according to an embodiment of the invention.

FIGS. 18, 19, 20, 21, and 22 illustrate a flow diagram of an embodiment of the present invention illustrated in FIG. 17.

FIG. 23 is an illustration of an E-commerce transaction employing an IMS storage where no financial card information is provided to a merchant, according to an embodiment of the invention.

### DETAILED DESCRIPTION OF PREFERRED EMBODIMENTS

In the following description, reference is made to the accompanying drawings, which form a part hereof, and in which is shown by way of illustration specific embodiments in which the invention may be practiced. It is to be understood that other embodiments may be utilized as structural changes may be made without departing from the scope and inventive concepts of the present disclosure.

Accordingly embodiments of the present invention relate, generally, to an E-commerce system which may run on a variety of computing platforms. However, for the purposes of simplifying this disclosure, preferred embodiments are described in detail herein with relation to embodiments of the disclosed E-Commerce system, which run on host devices, for example, personal computers. This exemplary embodiment is chosen as an example likely to be familiar to those skilled in the art, but is not intended to limit the invention to the example embodiments. The examples disclosed are intended to illustrate the inventive aspects of this disclosure, which will apply in kind to other computing platform including, but not limited to, cable boxes.

As used herein, the term “host device” is intended to mean any device, which can display to the user associated electronic content encoded in remote and/or local storage media. The host device may be equipped with a peripheral device suitable for retrieving associated electronic content encoded in a local storage media. Also, the host device may be equipped with communications hardware and software suitable for retrieving associated electronic content encoded in a remote storage media through a remote server. In accordance with example embodiments of this invention, a host device may comprise, but is not limited to, an IBM personal computer (or clone), Macintosh computer, 3DO platform, Sega platform, or an interactive television set top device.

As used herein, the term “storage media” is intended to mean media for storing digital data and/or code such as, but not limited to, optical disks (for example, compact disks (CDs), flexible disks (for example, 51/4 floppy disks), rigid disks (for example, hard disks), tapes, game cartridges, memory cards (for example, PCMCIA card), memory chips, programmable hardware (for example erasable programmable read only memory (“EPROM”) on peripheral component interconnect (“PCI”) or other motherboard bus cards) or any other media suitable for use in a host device which performs the function of information storage. In one embodiment the storage media is removable from a host device, although permanent media or other storage media (for example, on a remote server) may also be used in accordance with this invention.

As used herein, associated electronic “content” includes, but is not limited to, selections which can contain information found in a conventional printed publication such as book, magazine, catalog or other printed document, or as found in other electronic platforms. As used herein, the term “selection” is intended to mean data and/or code and includes a grouping or combination of one or more files such as, but not limited to, software, still graphics, picture, text, audio recording, video recording or other data related to one another, suitable for display by a host device. For example, a selection may include the multimedia equivalent of a magazine article or a television program or a digitized song or a video game software program or a spread sheet for financial information. While in one embodiment, data and/or code selections are in multimedia form suitable for use in a multimedia host device, a single media host device may also be used with suitable selections in accordance with embodiments of the invention.

As used herein, the term “interactive media” is intended to mean any communication media with which a user may interact, such as, but not limited to, a computer, an interactive television or a video game machine.

As used herein, the term “display” is intended to mean presenting one or more selections by the host device in a form suitable for use by a human on a display device such as, but not limited to, a monitor/screen, a speaker/headset or a printer. Display may include running a software program, playing a sound recording (through a speaker/headset), showing a video recording (on a monitor/screen) or printing a graphics image (on a printer). As used herein, the term “use” is intended to include display, as well as any other use (processing use) in a host device.

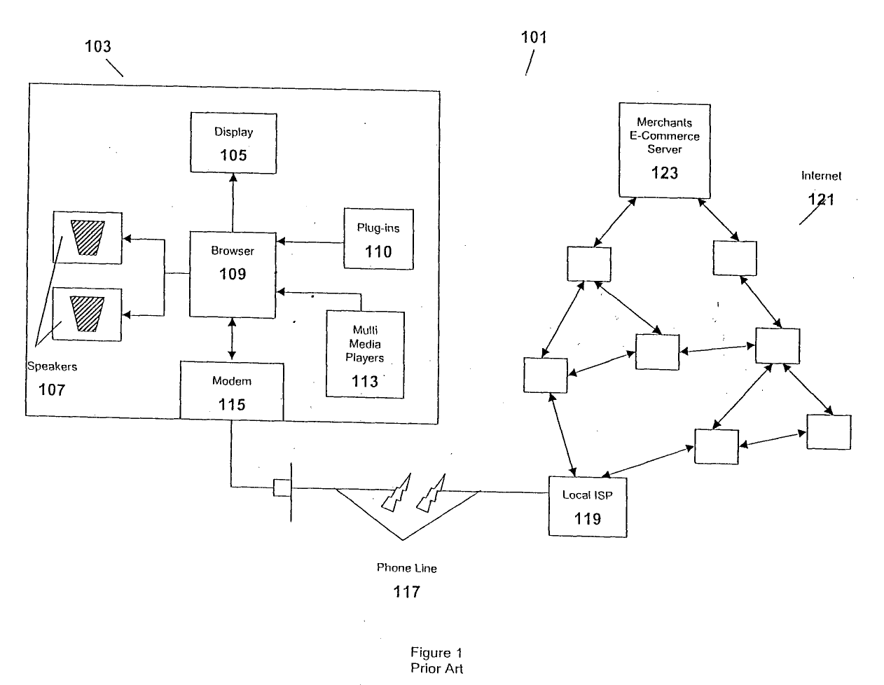

FIG. 1 is a block diagram of an exemplary prior art E-Commerce system 101 implemented utilizing a personal computer 103. Within the personal computer 103, a browser 109 is present. The browser sends graphic files to the display 105. Browser 109 may use multimedia player software 113 or plugins 110 in order to produce visual content for the display. The browser also provides signals for the speakers 107. The browser may rely on multimedia player software 113 or plugins 110 in order to produce the audio signals for speakers 107.

The browser is connected to a network via modem 115. The modem 115 couples the computer system 103 into the telephone line 117. The telephone line 117 then further couples the computer 103 to a local Internet Service Provider (ISP) 119. Other embodiments may employ other methods for Internet connectivity such as Digital Subscriber Line (DSL) Cable Modem or wireless.

The computer 103 is located at a user's (for example, a buyer's) location and is coupled, via the telephone line 117, through the Internet 121 with the merchant E-Commerce server 123. Visual displays, audio content, web pages and other data are communicated between the merchant's remote E-Commerce server 123 and the buyer's computer 103, via file download or video streaming techniques. In addition, the buyer's computer may also access the Internet in order to download data from different sites, multimedia players 113 or plugins 110 which are necessary for the browser 109 in order to run, load or stream different types of media files provided by the merchant's E-Commerce server 123.

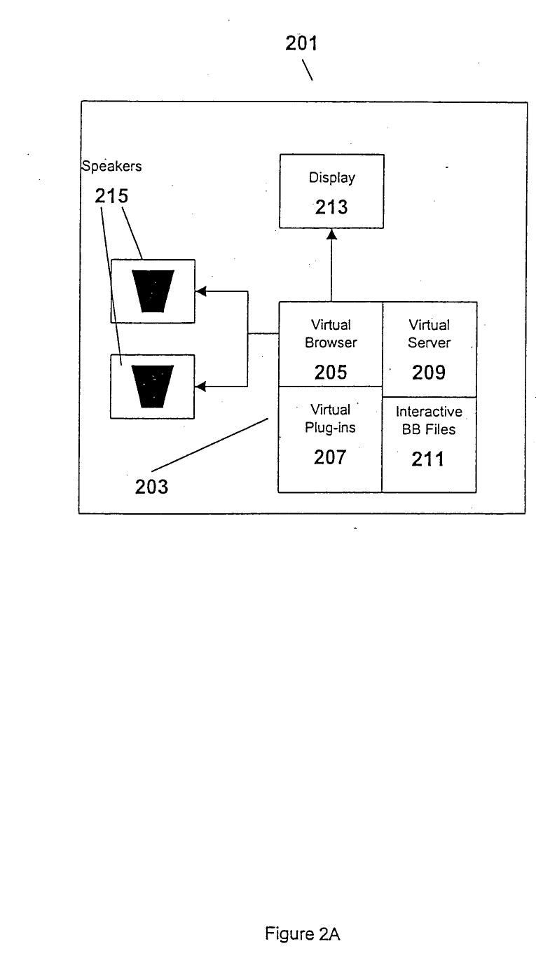

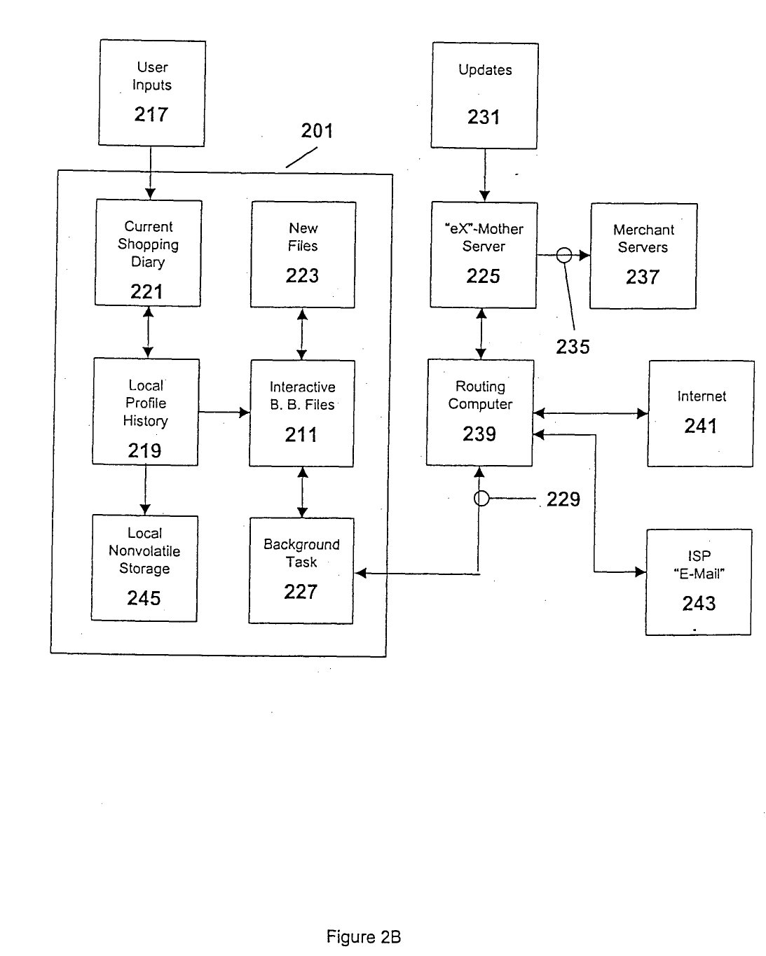

FIG. 2A is a block diagram of a simplified exemplary embodiment of the present invention. The embodiment of the present invention illustrated in FIG. 2A comprises a software system 203 composed of software stored on computer readable media. In the illustrated embodiment, the software system 203 is contained within a user host device which, as an exemplary embodiment, comprises a personal computer 201. For example, the software system 203 may be stored on a hard disk or may be stored on a portable medium, including, but not limited to, a CD, a floppy disc, a digital tape or the like, which may be loaded into and read by the computer 201.

The VSMS/IMS software system 203 according to an exemplary embodiment is composed of a virtual browser 205, which interacts with a virtual server 209. The virtual server 209 draws upon interactive files 211 on the IMS which may comprise such content items as video and audio graphics files, web page files, JPEG files, GIF files, etc. The virtual browser 205 interprets files provided to it by the virtual server module 209 and may use virtual plug-ins 207. The embodiment 203 may use the aforementioned components to provide audio to speakers 215 and graphics to display 213. A user of IMS Interactive Media Site may not even be aware that the site being accessed is local to the user's host device, except that a significant performance improvement will be present over an interactive website connected via the Internet.

FIG. 2A does not show a connection to the telephone line, an Internet service provider, the Internet or a remote commerce server because those pieces are not necessary to produce an interactive, transactive, or E-Commerce experience according to certain embodiments of the present invention. Accordingly, the delays associated with those pieces have been eliminated. The appearance, however, and look and feel of an on-line Internet E-Commerce shopping experience may be maintained and effectively improved and enhanced. One way in which the shopping experience may be improved is that all elements within the present embodiment are tightly integrated and work when they are loaded.

Embodiments of the present invention have a highly reliable operation because when the IMS system is installed from an IMS mass storage media (e.g., CD ROM) to the user's system, the system can be checked to assure that it will run the software present on the IMS media. In contrast, when a user browses an on-line website, the individual may never be sure if his or her computer will be able to access the site properly. The user's computer may not contain the requisite hardware, and software—such as audio video players, which may have to be downloaded from other websites.

If a system without the proper plugins connects to a merchant's Remote Internet server, the shopping session may have to be lengthened or stopped in order to find and load the plugins 110 necessary to interpret data from the merchant's E-Commerce server 123. Also, if the user's system is lacking the requisite hardware, the E-Commerce session may have to be terminated. Thus, a user may initiate an E-Commerce session only to find out that the session cannot be completed without additional installation of hardware or software into their system.

In contrast, a loaded IMS system as exemplified in FIG. 2A will work upon commencement of the software program loaded from the IMS on the user's host device because the IMS checks and optimizes the user's system prior to attempting to run. The IMS also may inform the user of the shortcomings of the user's system that may prevent the IMS from performing optimally. For example, if the user's system does not have the proper TCP/IP drivers installed, during the IMS installation and host system analysis, the user might receive a message such as, “Please install your Windows Dialup Networking (click here for instructions) so that the IMS can communicate to our Internet server to place your orders.” Because the software delivered to the user's computer system by the IMS is contained within a mass storage device, it may be installed to a user system in such a way as to optimize its performance. The VSMS Installation System may install certain drivers or other components as necessary to optimize the host system's memory or video resources as needed.

During the installation process, the IMS content may be updated. If the IMS is not the latest version or if the product prices have been changed as in a sale, then some of the product information contained within the IMS may be out of date. During the installation, the IMS can establish a connection to the eX-Mother Server and provide version information of the IMS to the eX-Mother Server. The eX-Mother Server then can respond with any update necessary to bring the IMS into a current configuration. Such updates may be stored to the user's hard disk or may be loaded into RAM memory.

In addition, the IMS may communicate profiling information to the eX-Mother Server. The eX-Mother Server may then use this profiling information, for example, to rearrange the pages of a catalogue according to the user's interests in past products. The eX-Mother Server may also present and/or highlight information such as sales that are pertinent to the user's profile. In other words, the eX-Mother Server can receive information about the user's preferences and tailor specific communications to those preferences.

FIG. 2B is a block diagram of a simplified exemplary embodiment of the present invention. The embodiment of the present invention illustrated in FIG. 2B is contained within a user host device. The user host device may be any one or combination of a variety of computing type platforms such as, but not limited to, a television set top box, a gaming console, a personal computer or a PDA (personal digital assistant). The principles illustrated in FIG. 2B are not limited to a single computing platform but may be applied to a variety of computing platforms. For the sake of simplifying the present disclosure, however, FIG. 2B is illustrated with respect to a personal computing platform.

FIG. 2B illustrates a personal computer on which IMS software has been loaded. The IMS software comprises a virtual browser 205, a virtual server 209, virtual plugins 207 and interactive IMS files 211 as illustrated at 203 in FIG. 2A. The embodiment in FIG. 2B contains software for producing an Interactive Media Site (IMS) on a user's host system, in this case a PC. Because the software necessary to produce an interactive media site is located locally within the user's host PC 201, the performance of the interactive media site is limited only by the speed of the platform on which it runs. There are no limitations or bottlenecks associated with streaming or downloading files from another location over a network connection.

Although bottlenecks caused by the necessity of streaming files or downloading files from a remote site have been eliminated, embodiments of the invention may nonetheless comprise an external link 229. The external link 229 need not be used for streaming files that are to be displayed to a user. Instead the external link 229 is coupled to a background task 227 within the computing system 201 and may be used for a variety of other purposes.

The background task 227 and external link 229 is coupled to an eX-Mother Server 225. The eX-Mother Server 225 is a local type of server and the external link 229 is a local type of link. A local link is a high speed direct connection between a background task and the eX-Mother Server 225. A local link does not contain a series of intermediate links. A local link also does not traverse a portion of the Internet. A local link connects the user's computing system 201, via a background task 227, to the eX-Mother Server 225 in a site to site type connection. By site to site connection it is meant that the first site comprises the user's computing system 201 and the second site comprises the site which houses the—eX-Mother Server 225.

Such a site may also comprise a routing computer 239. This is because the eX-Mother Server may be located at an Internet service provider's (ISP) site. The Internet service provider would receive communications in its routing computer 239 and then route the communications to the proper destination. The routing computer may route the communications to the Internet 241, to an ISP e-mail service 243 or in the case of the present embodiment, may route the communications, such as 229, to the eX-Mother Server 225. The eX-Mother Server 225 may be, in turn, coupled to merchants' servers 237 across an Internet connection 235. The Internet connection 235 will not, however, affect the speed of the interactive media site as hosted on the computer system 201.

The IMS interactive media site hosted on computer system 201 is substantially self-contained. The user of the system accesses files which are resident on the system only. The external connection 229 may be used for purposes such as providing new interactive IMS files 211. Any material or files which are delivered to the computer system 201 via an external link 229 are not available to the user until they are completely resident on the user's computer system 201. The external connection 229 may also be used to transfer a purchasing order to merchants' servers 237 via the eX-Mother Server 225. This transfer may occur as a background task or it may occur when the user is no longer accessing the interactive media site. In either case, there is no waiting for files to be delivered from a remote site.

As an example, an IMS system may be used to create an interactive media site which sells office supplies. The office supply merchant may also have a promotion or sale during a certain period of the year. If the user of an IMS system connects to the eX-Mother Server via a background task 227 and external link 229, sales material relating to an office supply sale may be downloaded as interactive IMS files 211. The choice, however, to view these interactive IMS files 211 which represent the yearly sale of the office supply merchant, are not present to the user as a choice for viewing until the entire file has been downloaded by the background task 227 and is resident as an interactive IMS file 211. If a choice were available such as prompting a user if they wished to download a sales file, then the user would experience the normal type delays to download the files during the experience. In preferred embodiments of a VSMS/IMS system running an Interactive Media Site, however, no choice is presented to the user until the files are present as interactive IMS files 211. By not presenting a choice to a user to view a file until it is actually present on the user's machine, delays associated with downloading files from remote sites are eliminated. These delays are eliminated whether the file being viewed by the user is one of the original files loaded from the IMS media, for example, CD-ROM, or one that has been downloaded by a background task 227. Once the files have been downloaded by the background task 227 the new files 223 are available just as any other interactive IMS file 211.

A significant difference between IMS interactive commerce and normal E-Commerce is illustrated by the one-way communications direction between the eXtreming mother server 225 and the merchant's server 237. In a conventional E-Commerce experience a user would access web pages from a merchant's server, which would be streamed to the user. As the user changed web pages, further web pages would be streamed from the merchant's server to the user. The display of all web pages on a user's system would, therefore, involve a handshaking between the merchant's server and the user's system. A user would call for a new web page and the merchant's server would then stream the web page to the user. If the user wished to access one of the links on the web page, the user would activate the link which would then be communicated to the merchant's server. The merchant's server would then stream the necessary page represented by the link to the user.

Internet Website pages with more than a minimal number of graphics may have to be reloaded each time a user returns to the same page to look at them again. If the loading of a web page originally took 30 seconds to 1 minute to load from the Internet, it probably will probably take the same amount of time to load again. With the IMS System, pages and graphics may be background loaded into the user's host device's RAM Memory either upon installation or when first accessed and remain in memory. Many pages and graphics may be simultaneously loaded into RAM, independent of control from a browser. Accordingly, when a shopper returns to a previously viewed page the IMS webpage can load instantly from local RAM every time.

Additionally the IMS system of FIG. 2B does not require such a handshaking link between the eX-Mother Server 227 and the user's system 201. The user's system 201 preferably contains within it all of the merchant's pages that will be used by the system 201 including forms which the user may need to complete their purchase. If a user clicks on a link displayed on the IMS's Interactive Media Site, the page to link to is immediately available. The linked page is immediately available because it is resident in RAM in the user's system 201. Once the ordering process has been completed on the user's system 201, the order may be sent to the merchant's server through the background task 227 or may be delayed and sent at a future time. In either case, the user completes the interactive media or shopping experience as well as the filling in of any forms using only files available locally on their system.

The user may transfer a request or purchasing order via the background task 227 to the merchant's server 237. The request or purchasing order represents a relatively small data file when compared with the transfer of web page files. Additionally, the transfer is made in one direction, from the user's computer system 201 to the eX-Mother Server 225 where it is processed and may be further sent to the merchant's server 237.

Even if the merchant's server 237 is down or experiencing delays, the user's order may be held in the eX-Mother Server 225 and delivered to the merchant's server 225 at a later time. Because the connection between the user's computer system 201 and the eX-Mother Server 225 is a direct immediate type connection, any order which is transferred from the IMS system running on the interactive media site may be transferred to eXtreming mother server very quickly.

Another advantage provided by IMS software system is that several merchants may participate in the interactive media site running on the user's computer system 201. The user may complete orders from several different merchants and such orders may be sent in a short period of time, comprising seconds, to the eX-Mother Server 225. The eX-Mother Server (eXtreming mother server) 225 may then relay the orders to the proper merchants' servers 237.

A further advantage of IMS type commerce is that a user's profile, including credit card information, may be stored on the user's system 201, for example, in local non-volatile storage 245. Because this storage is local, it can be used by multiple IMS's. For example, if the user receives a first IMS from a first merchant and completed a local profile 219 identifying the user's name, address, phone number, and preferred method of shipping, etc., that profile could be stored on local non-volatile storage 245, such as a user's hard disk. When the user inserts a second IMS from the same or another merchant into the user's system 201 at a later time, there would be no need to enter in their registration profile information again as it would all be available locally in the local non-volatile storage 245. Such local non-volatile storage would enable a user to make multiple purchasing orders from multiple merchants and may never have to re-enter their user information. The user information would be stored in a local non-volatile storage 245 in a form accessible to all IMS's which the user were to use. In this manner, an order could be completed by a single click and the user's information, and purchasing order, which are both resident in the user's system 201, could then be sent. Additionally, the information in the local non-volatile storage 245 could be used to automatically fill in purchasing orders that are printed out and sent by traditional mail or by facsimile transmission. The local non-volatile storage 245 would thereby enhance the user's shopping experience by doing away with the necessity of entering in purchase information every time a new merchant was contacted and by providing a method by which a single action, such as a mouse click, could complete and send an order.

The eX-Mother Server can also facilitate the purchasing of items from multiple vendors. Billing information, such as user address, shipping means and credit card information, can be sent to the eX-Mother Server. The eX-Mother Server then can communicate with the various vendors and provide the individual vendors with particular information that they demand to complete the transaction.

The VSMS uses an automatic html page generator to generate new or on sale HTML shopping cart pages, which are created from instructions received by the eX-Mother Server. The eX-Mother Server gets updates from polling participating merchant's Internet web servers, accessing previously setup databases, translating the database data, then directing each IMS system to update its pages accordingly. Additionally, the Product Catalog File on the IMS can be updated to allow further searches and enable the E-Commerce engine on the IMS to select new products. All these actions may occur completely seamlessly without the user being aware that his modem is turning on for a few seconds communicating data then turning off. Graphics for certain “Sale” items or products, in anticipation or in coordination with the merchant's sales strategy, may already be present on the IMS, as would be an HTML page creation template, which can enable users having out of date IMSs to see the latest sale prices without ever knowing that they had been updated.

This form of communication between the IMS software system, eX-Mother Server, merchant, and back again to the IMS (in the case of credit card approval or disapproval for purchases) occurs by way of small data packet transmission instructions to and from the IMS software system. In this manner a VSMS is able to get E-Commerce credit card approvals and update the Interactive Media Site it operates on the IMS by communicating with the eX-Mother Server. No HTML or graphics images need to be uploaded or downloaded because the forms are resident on the IMS and only necessary data is sent to the eX-Mother Server, so the updates and credit card approvals can occur in mere seconds. The rapidity of the process enhances the user's shopping experience.

A further function of the IMS is that it may create a user's shopping diary. A user's diary may be a diary of bookmarks or bookmark categories which is created by the VSMS and which the user can use at any time to see past categories, pages or products that the user has accessed. The user can then use this diary of bookmarks to return to items or sections of the IMS store they were interested in. The VSMS can create HTML pages of the bookmarks by category and/or in the order that the user viewed them. The VSMS may also mark some of the bookmarks thus created with high interest markers signifying that the user had marked the item for return. The diary of bookmarks may also be used by the eX-Mother Server for the purpose of data profiling.

The VSMS can also search the diary of bookmarks and categorize them by both content and the order in which the items were selected.

The IMS form of commerce also enables new features previously unavailable with conventional print catalogues, both to the merchant and to the consumer, as well as new forms of on-line shopping experiences. One such feature is that of producing a local profile 219. In addition to information such as address, billing and shipping information, a local profile 219 may comprise data associated with a user's shopping habits. For example, when a user interacts with an IMS commerce system, the user provides inputs 217 to the computer system 201. Such inputs can be recorded and categorized in a shopping diary 221. A shopping diary could record the types of items in which a user had been interested in, for example, by recording data corresponding to which specific interactive media system pages were most often visited, how long the user visited the site, items which the user sought further information on by clicking on links and which products were eventually bought, or bought and later canceled This could be used to distinguish interests of a user while utilizing IMS's containing multiple merchants' interactive media sites. In addition, within each merchant's site a particular type of item might be favored by a particular user. In addition to providing a feedback for the user, as discussed elsewhere, information in the shopping diary could be used to produce targeted commercials and promotions. For example, if a user was running an IMS dedicated towards men's wear and had spent a significant amount of the time accessing pages displaying running shoes, such an interest could be recorded within the shopping diary. Once the user had established a connection 229 between their computer system 201 and the eXtreming mother server 225, the local profile containing the product interest showing that the user had been interested in running shoes could be sent to the mother server 225. Once the mother server 225 had received this information it could begin to download interactive IMS files via the background task 227. Such files could represent several pages containing a more extensive offering for the products or lines in which the user showed an interest (e.g., athletic shoes) or it could contain an interactive commercial relating to such products or lines. If a commercial had been downloaded and was complete within the new files 223 within the IMS system, then once a user entered the page showing the athletic shoes, a pop-up prompt such as “Here are more pages relating to running shoes which are now on sale!” could be presented. By signifying their acceptance the user would then be presented with the downloaded pages which contained running shoes which were on sale.

As an alternative, the user might be presented with links to new running shoes pages which were distinguished from previous links, through the use of such visual cues for example, but not limited to, highlighting the link and appending the word “new” to the link. Preferably, neither the commercial nor the new links would be presented to the user until all of the files to establish the link had been downloaded by the background task 227. In this way, although new files may be downloaded, the Interactive Media Site shopping experience within the IMS software is kept fast and pleasant. No delays are required to wait for any files to be downloaded. If the user can access a file, then it is already present upon their system. Because any file that the user may access is already present on the user's system, access to such files is seemingly instantaneous.

In addition, advertisements which could be placed in response to the user's local profile are not only fast but immediate. In the previous example in which a user was shopping for running shoes, once they had accessed the page containing the running shoes, an immediate advertisement could be displayed. The advertisement might further use the shopping diary 221 and local profile 219 in order to personalize the advertisement. For example, instead of informing the user that there was a sale on running shoes and that the user may view pages on the interactive media site containing running shoes which are on sale, the user could be given pertinent information such as, for instance, shipping times and options to their particular address. The system could determine the user's address from the local profile which is stored in local non-volatile storage 245 and could address the user by name. So, instead of merely an advertisement saying that Nike running shoes are on sale, the advertisement could say, “Hello, Mr. Smith, Nike running shoes are on sale now and can be delivered to your home at 1342 Woodland Hills for a shipping charge of $3.00 per pair. Shipping will take 3 days by UPS Ground and for an additional $5.00 can be shipped by UPS Next Day Air.” Additionally, reaction to such commercials could be gauged and stored in the shopping diary 221. If the item were then procured, the merchant would have a gauge of the effectiveness of the commercial. In such a way the interactive commercials could be tailored to the particular user using the shopping diary 221. For example, if the shopping diary showed that the user spent an average of ten seconds on each interactive media site page before clicking to the next page a pop-up advertising might be most effective. In contrast if a user spent 2 minutes considering each page then perhaps just an entry in a current page showing that sale items were available would be more effective. Merchants can also tell if a person does not order anything—what they looked at during their “window shopping” as well as the duration of their stay, because this information can be continuously saved to the user's hard disk and then transmitted to eX-Mother at various intervals. In this manner nothing is lost if the user decides to take out the IMS CD or turn off the host device before all the information is sent. In the event that IMS is removed before the information is sent to the eX-Mother Server, a data packet may be saved to the startup section of the windows registry on the user's host device 245 so that the next time the user turns his host device on, or logs back onto the Internet, the saved profiling information will be automatically sent to eX-Mother.

Additionally, this pre-registration data, using the user's information left by a previous IMS, may be used to fill out new forms with the user's personal data so that the user does not have to re-write such information.

In addition to providing a feedback for the user (items bookmarked by category and personal interest), information in the shopping diary 221 could be used to heighten sales to returning users of IMSs, wherein the user's previously recorded profile history 219 is read when a new IMS is inserted into the user's host device 201. If the category of products are similar in the profile history 219, as on the newly inserted IMS 203, for example, a new clothing catalog from a different manufacturer, then the IMS's VSMS may reorganize its display of new products files 211 to feature or highlight the same category or type of products the user had showed interest in or purchased in the past, according to the user's profile history 219. The contents of each current shopping diary 221 is continuously saved in the local profile history 219. This method, called Intelligent Off-line Media Sales Identification (IOMSI), can speed up and increase a merchant's Point of Sale activity significantly.

Additionally, each IMS has its own serial number. When the user's previously recorded profile history 219 is read, upon inserting a new IMS into his host device 201, the serial numbers of the new and previous IMS are linked in the eX-Mother Server's database. This further enhances the profiling capabilities provided for a merchant by the IMS, beyond those which could be derived from current print catalogs.

Merchants could then refine their future IMS offerings and general sales and marketing strategy by gathering statistics from one or more (and preferably many) user shopping diaries. The merchant could then send targeted promotions and commercials via background tasks to users' interactive media sites via the eX-Mother servers. Merchant's could then observe which types of commercials were the most successful and coordinate the different types of immediate advertisements to the user's behavior as recorded in the shopping diary 221. In such a manner, merchants could gauge the effectiveness of multiple ways of presenting products to individuals who had expressed an interest in that type of product. Because the advertising could be made immediate and not subject to download delays from a remote server, merchants could more effectively gauge the effectiveness of their ads and further promote the use of the IMS Interactive Media Site as an advertising service. For example the eX-Mother Server may be programmed to allow an IMS service provider to examine the user profile in real time. If the user profile 219 and shopping diary 221 indicated an interest in a certain type of item or category of items, data packets containing instructions as to an interactive advertisement, provided by either the same merchant or a merchant affiliate, could be quickly downloaded to the user's system via the eX-Mother Server. Once the advertisement data was downloaded the VSMS it could then be displayed to the user. The IMS issuer could provide these targeted advertisement packets to its merchants. In addition, responses to specially designed interactive ads could then be analyzed in light of the existing local user profile 219 and shopping diary 221. Information from this real time analysis of purchasing demographics may then be provided to merchants as a service. A merchant can literally view how customers are using, viewing and purchasing products from the IMS catalog systems—from the time users begin to access their IMSs.

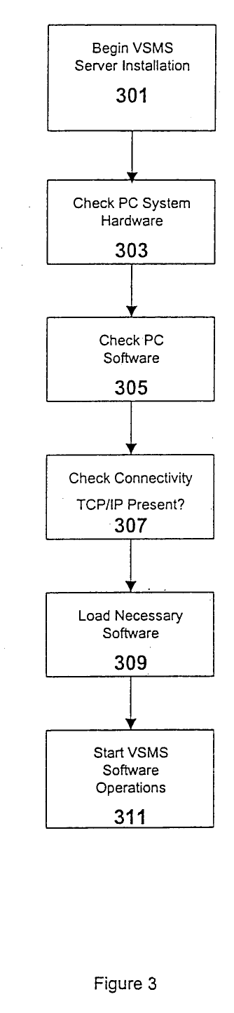

FIG. 3 is a general overview of a user's host system checkout and installation process of the Virtual Streaming Multimedia Server (VSMS) being installed from an IMS to a user's computer system. The VSMS can provide the functionality that would ordinarily be provided by a merchant's E-Commerce Internet website. The process begins in 301, with the beginning of VSMS host device system optimization checkout and installation. The checkout and installation begins once a user has loaded an IMS and begun to run the installation program portion. For example, one of the media from which IMSs may be made available is in the form of a CD ROM. Once the IMS is inserted into the CD ROM drive and the drive closed, the program will begin to load according to conventional loading procedures.

In Block 303 the user's PC system hardware is assessed. The checkout and the installation routine will determine how much RAM memory is available in the host device. The amount of RAM needed could depend upon the IMS application being loaded. An interactive media file that, for instance, makes heavy use of memory, such as displaying video clips, may need 128 megabytes of RAM memory or more on the host device. However, for a typical application, 64 megabytes of RAM memory could generally suffice. Based upon results thus determined, if the host device has low memory or slow memory, the VSMS will decide to load different format video files or graphics which require less RAM memory. Another possibility is if the VSMS finds an old processor, but with enough RAM memory, it may decide to load a file in the conventional manner, instead of fast streaming a video file, which may occur more slowly on systems having older processors.

The installation procedure also checks to ascertain what type of graphics card is present in the system. Sometimes graphics cards are set to less than full capability or are not properly installed. For example, a SVGA graphics card may be set to display VGA graphics. By determining the capabilities of the card, the application may attempt to maximize the quality of the shopping experience by setting the card to an optimal setting. Likewise, the type of sound card is determined. If no sound card is available, the system may be loaded without sound files. In addition, the installation and checkout routine will ascertain if Internet device drivers are properly installed and operational, if there is a modem or other internet connection device and whether or not such device is turned on.

In Block 305 the checkout routine checks the PC software. The system will ascertain what software and operating system is present on the user's system. If, for example, plugins needed by the IMS are already available and operational on the user's system, there may be no reason to reload or install them from the IMS.

In Block 307 the connectivity of the system is checked. The system check procedure 307 may involve determining such factors as whether or not the computer has an outside connection via a modem and a live telephone line or a continuous connection via a DSL line, wireless, or via a cable modem. Additionally, the checkout procedure may determine if there is a connection to an Internet provider. For example, if the computer system has a modem for communication over the Internet, the checkout procedure may determine if the modem is connected to a live telephone line, if the modem is turned on, and if the modem is on-line (connected to an Internet provider), or any one or combination of such factors. If the system check procedure 307 determines that the modem is connected, turned on and on-line, then the program proceeds to Block 309.

On the other hand, if the system check procedure 307 determines that the modem is not connected to a live telephone line, then, in one embodiment, the program provides a display or other form of message, informing the user that the modem is not connected (or, for example, requesting that the user connect the modem to a telephone jack). If the procedure 307 determines that the modem is not turned on, then, in one embodiment, the program provides a signal or instructions to the user's system or modem to effect an automatic turn-on (for example by operating an electronically activated switch to turn on or apply power to the modem). In addition or as an alternative, if procedure 307 determines that the modem is not turned on, then the program provides a display or other form of message, informing the user that the modem is not turned on (or, for example, requesting the user to turn on the modem).

If the modem is not already connected to the Internet, but is connected to a live telephone line, the VSMS may notify the user to turn the modem on, or install a modem if one is not present. If there is a modem connection, the VSMS may cause the modem to connect itself to the Internet. If the procedure 307 determines that the modem is not on-line, but is otherwise connected to a live telephone line (or other Internet connection), then the VSMS may notify the user to turn the modem on, or install a modem if one is not present. If there is a modem connection, the VSMS may cause the modem to connect itself to the Internet

Once the parameters of the system are known, the necessary CD ROM embedded software may be loaded, utilized and/or accessed from the IMS Block 309. Once the necessary software is loaded the VSMS software process 311 may be started and the user may proceed with their E-Commerce shopping experience.

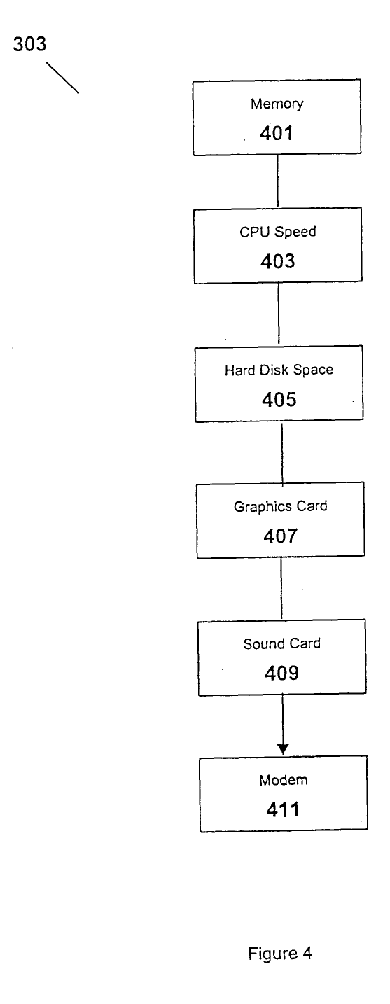

FIG. 4 is a graphic illustration, which elaborates on Block 303 of the installation and checkout routine, the block in which the PC system hardware is checked. For example, in preferred embodiments, an internal optimal performance report is created by determining and recording any one or combination of the factors related to the PC system hardware, including, but not limited to CPU speed 403, hard disk space 405, graphics card 407, sound card 409 and modem 411. The results of the performance report may be used by the VSMS to alter its operations based upon existing, unchangeable conditions of the user's host device, so that the highest percentage of users will be able to operate the IMS media site. In contrast, many conventional CD's containing special programs or music videos completely fail to operate when encountering non-operational conditions on a user's host device.

In Block 403, the CPU speed is ascertained. The CPU speed may determine a variety of parameters. For example, the CPU speed may determine the size of a video display which can be reasonably maintained at a good quality for that particular CPU speed. Because the presentation of the shopping experience may be adversely affected if the CPU speed is not adequate enough to run software in an acceptable manner, tradeoffs might be made during the installation qualification period. The user may be informed, through a display message, that certain video clips, for example, may be slow because of the speed of their system, or the VSMS will substitute different media files which could play in a more optimized fashion on that user's system. If no media is determined to be able to play on the user's system because of the CPU requirements, a message will be displayed to the user, with additional recommendations for optimal use based upon its findings. Additionally, a user may be given a notice such as “your system cannot run full size graphics; The virtual server will adjust itself to your system.”

The amount of available hard disk space is checked in Block 405. The system determines how much hard disk space is available in order to determine how many of the files can be loaded on the hard disk. By loading files on the hard disk an improvement in access time may be obtained over loading such files from, for example, a CD ROM media.

Additionally, in Block 407, the type of graphic system present is determined. This will determine the display quality that the system may produce. It will also determine what types of files will need to be loaded on the system and whether or not the graphics card may be adjusted for a higher resolution. For example, the system may provide a message to the user, informing the user of such factors. By knowing the capabilities of the graphic system, the visual portion of the presentation may be optimized. Additionally, memory 401 may be optimized to enhance graphics data pumping ability.

In Block 409 the presence of a sound card is detected. A system may not have a sound card at all or may be a sound card not capable of handling certain audio players. Determining the sound card further allows the presentation to be tailored to the limitations of the user system, and to prewarn the user of any limitations encountered, for example by displaying suitable warning messages or giving instructions on making manual adjustments.

In Block 411, the existence of Internet TCP/IP dialup communication drivers are determined to be present. Then, the type of modem that is present is determined. If no TCP/IP drivers have been installed on the system, the VSMS will look for network connections or RAS (Remote Access Service) devices. If no RAS devices are present, then it may be the case that an Internet, dialup modem or fax connection is not possible. In that event, the VSMS may provide the user with a display of a suitable message, informing the user that a printed order may be created which may be mailed or otherwise delivered to the merchant by conventional means, such as a conventional telefacsimile machine, a messenger service, the postal service, or the like. Thus, in one embodiment, the entire interactive media site on the IMS may be operated successfully, complete with e-commerce, without any on-line connection in this fashion.

Although the shopping experience is a local shopping experience with the virtual streaming multimedia server (VSMS) being located in the user's host device, the user may choose to send an order at a later time. Sending an order is a relatively light burden on the system compared with sending and receiving files and commands to and from a remote server in a typical on-line interactive environment. An order may be sent at the end of the user's shopping experience through the modem or at any time. If there is no Internet connection detected in the system (as discussed below), the VSMS will establish its own direct Internet connection to the eX-Mother Server or the modem may be used to send data to a dedicated order system. In the latter case, the data may be sent via telephone 800 line without requiring the merchant to have an E-Commerce Internet site. The use of a telephone line not connected to the Internet might also serve to allay fears of a transaction being eavesdropped over the Internet. The user of the system may have the full benefit of an E-Commerce experience without ever having to utilize the Internet. Additionally, an order may be printed and mailed (or sent by telefacsimile) to a merchant, should the user desire to, for example, include a check in lieu of providing credit card information.

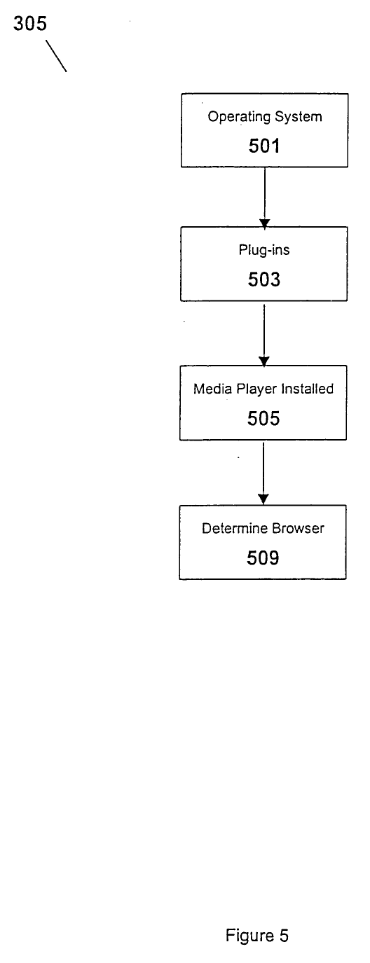

FIG. 5 is a block diagram elaboration of Block 305 in FIG. 3 in which the pre-installation and qualification software checks the software present on the user's PC. In Block 501 the pre-installation and checkout routines attempt to determine the operating system and the version of the operating system which is present. If the operating system and present version is known, then the VSMS routines may be able to optimize the shopping experience.

In Block 503 the system determines which plugins are present. If certain plugins that are needed within the VSMS system are already present, there will be no need to load duplicate copies from the IMS.

In Block 505 the pre-installation routine ascertains what type of media players are already installed. If media players or their plug-ins that will be used by the VSMS software are already present, then they need not be re-installed.

In Block 509 the browsers present on the user system are determined. Although an electronically virtualized IMS custom browser (Virtual X-Browser) may be installed and used to provide the user with their shopping experience, it may be preferable to know what type of browser is already installed. The Virtual X-browser may be configured with the same type of controls the user is familiar with on the user's own default browser.

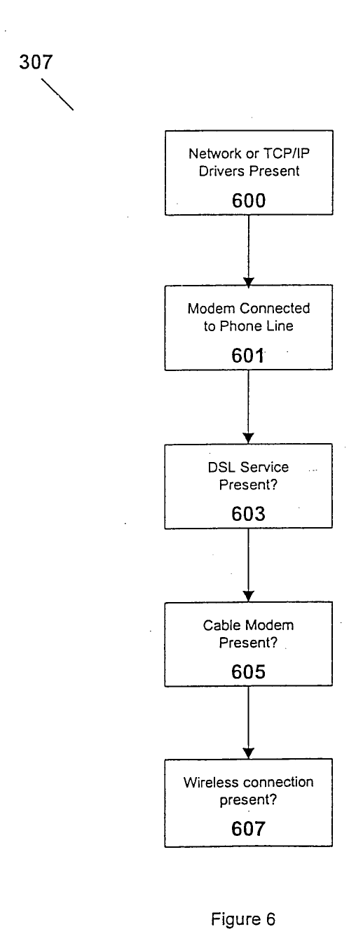

FIG. 6 is a block diagram, which is a expansion of the check connectivity Block 307 of FIG. 3. In Block 600, the installation and the qualification routine will first determine if there is a TCP/IP (Transfer Control Protocol/Internet Protocol) driver present. This will determine if the user has a ready connection to the Internet or is able to be connected to the eX-Mother server by the VSMS, if the connection is not turned on. If a connection to the Internet is available, the VSMS may automatically connect the user's modem to the Internet. If no TCP/IP driver is present then the required media player or TCP/IP drivers may be loaded from the IMS by the VSMS. If no modem, DSL, Cable Modem, or any means of Internet connection is found, the VSMS can save all purchases made and may tell the user to install or connect a modem so that the purchases can be sent and sale items checked. However, the VSMS will also give the user the option of printing out his item checkout page and either faxing it directly from the IMS or later, mailing or faxing the printout, or phoning the order to the merchant.

The pre-installation routine checks to see if there is a modem connected to the telephone line in Block 601. If a modem is present, then the user may complete the shopping experience by placing an order through the modem, if desired. Also, the system checks to determine if there is DSL service present in Block 603.

In like manner, the pre-installation software checks to determine if a cable modem is present in Block 605. If the cable modem is present, it may be preferable to send orders at the end of the shopping episode via cable modem over the Internet or at a more convenient or less congested time decided by the user.

Although the IMS application is designed to be totally resident, the user may eventually want to transfer an order via modem to the merchant's server via the eX-Mother Server. Such a transmission might be accomplished using a system modem if present. In addition, some IMS applications may ask the user if they want to have an update of their catalogue, or if the user wishes to see current sales, or even if the user would like to receive an affiliate's IMS. Other IMS applications will simply download all current data from the eX-Mother server and inform the user, for example, with a direct message on the user's display, of the current sales or updates.

An affiliate's IMS could be received, for example, through the mail or through a download. Affiliate data may also be downloaded to the user system as a background task while the user utilizes the VSMS system to pursue an entirely local shopping experience. The VSMS may query the eX-Mother Server to see if updates to any affiliates or merchant pages are available. Instructions sent to the IMS can cause the VSMS HTML page generator to create dynamic or static pages as required according to the nature of the shopping needs.

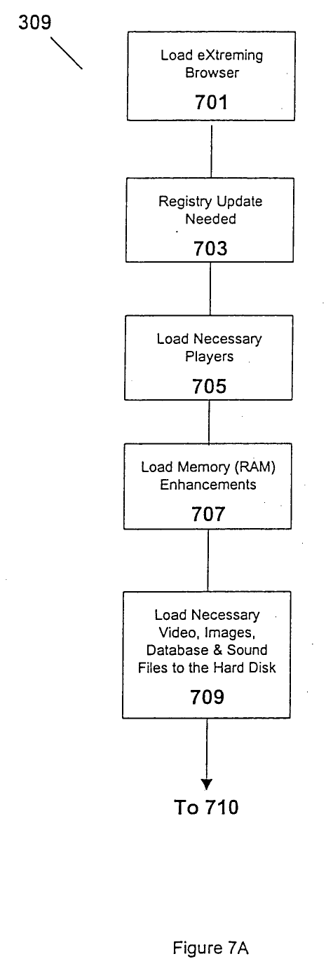

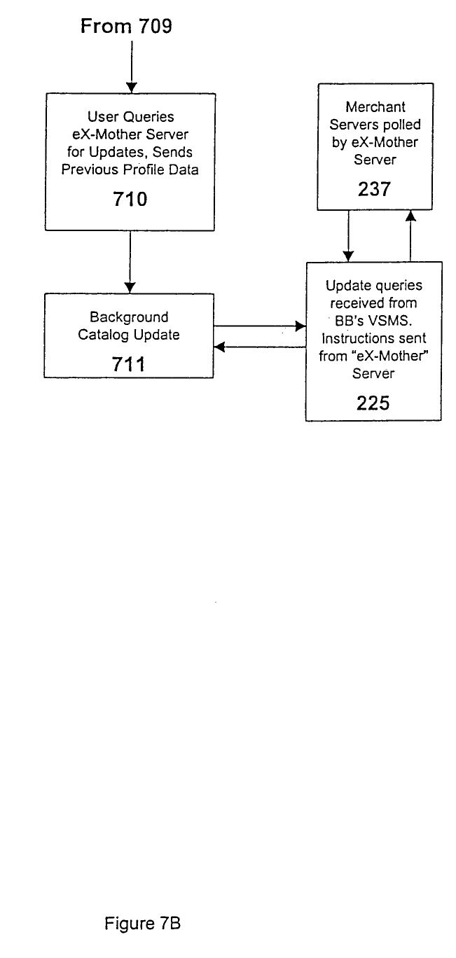

FIG. 7A is a block diagram that further describes the “load necessary software” Block 309 of FIG. 3. In Block 701, the eXtreming browser (eX-Virtual Browser), which is a custom VSMS Internet browser, is loaded on the system. The eXtreming browser (eX-Virtual Browser) is designed to optimize all files on the IMS and work as an integral part of the VSMS server with the other files, which have been determined to be on the system, or which have loaded on the user system by the IMS. In Block 703 the user's computer registry is examined. The purpose of this examination is to ascertain a default user name and to determine if any updating of the system parameters is needed. The user's name may be in the Registry, so a new IMS may be able to greet the user by name. In addition, a previous IMS may have stored user information, address, etc. elsewhere on the disk. (Prior credit card information could be accessed by password.) Storing information locally can eliminate much of the user entry needed to complete an order, thereby enhancing the user's shopping experience. In addition, a previous IMS may have stored user profile information, Block 219, and stored the location into the user's operating system registry. 1001611 In Block 705 the necessary players are loaded. The players that need to be loaded depend on several factors. The first factor being the VSMS application, which will be running on the user system. Some applications may require a type of player whereas other applications may require another type of player. In addition, players that are already loaded on the user system may not need to be loaded from the IMS mass storage device.

In Block 707, any memory enhancements which are used by the VSMS are loaded. This may include the creation of such items as virtual disks or caches for graphic images. In Block 709, the actual application software is loaded. This may include, but is not limited to, video, graphic images, databases and sound files. These files are loaded from the IMS mass storage device, in the present exemplary embodiment a CD ROM, to the user's hard disk. Files which are stored on the user's hard disk may incorporate files.

Further portions of the process of FIG. 7A are shown in FIG. 7B. In Block 710, the user's VSMS may query the eX-Mother Server for updates. Product updates received from a merchant by the eX-Mother Server provide directions to the Product Update HTML Engine, also known as the automatic shopping page generator/engine section of the VSMS. Block 711 represents a background task such as might be used to update the VSMS software with the latest sales, catalogue items, etc. Some applications may have the facility to quickly download sales and new items from a remote server while the user is utilizing the VSMS server for shopping.

Except in instances in which the IMS links to a remote Internet webserver not operated by the eX-Mother Server, all communication from the IMS will go to and through the eX-Mother Server. Preferably, all communications to IMS merchants emanate from the eX-Mother Server.

The VSMS may use its automatic HTML page generator which generates the respective new or “on sale” shopping cart HTML pages which are created from instructions received by the eX-Mother Server. The eX-Mother Server receives these updates and provides them to the IMSs by, for example, polling merchant's Internet webservers, accessing previously configured databases, translating this data, and then directing each IMS system to update its pages accordingly. Additionally, the Product Catalog File is updated to allow further searches and the ability of the E-Commerce engine to select the new products. All of these actions preferably occur seamlessly and invisible to the user, who may only be aware that his or her modem turns on for a few seconds and then turns itself off. Graphics for certain “sale” items or products, in anticipation or in coordination with the merchant's sales strategy, may already be stored on the IMS, as would be the HTML page creation template, so that at the merchant's expected time or duration, users existing IMSs would provide the user with the latest sale prices.

This form of communication between the IMS software system, eX-Mother Server, merchant and return communication to the IMS (in the case of credit card approval or disapproval for purchases) preferably occurs by way of small data packet transmission instructions to and from the IMS software system. No HTML or graphics images need be uploaded or downloaded, so the updates and credit card approvals may occur in mere seconds, or less, and do not interfere with the user's shopping experience.

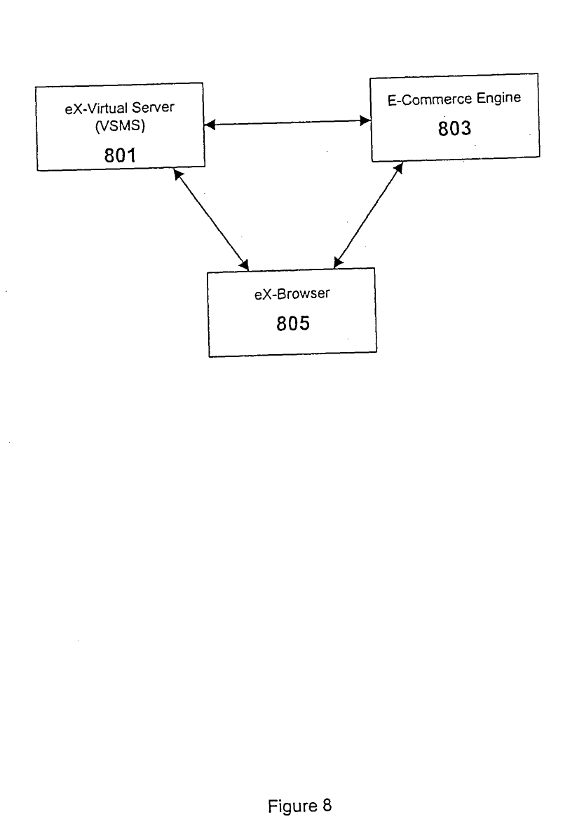

FIG. 8 is a simplified block diagram, which illustrates an IMS VSMS system loaded to and running on a user's computer. Utilizing examples and embodiments of the present VSMS IMS system loaded on a user's computer, the user can participate in E-Commerce without external connections to the user's computer. Utilizing the IMS software a user may participate in E-Commerce even when no telephone, modem, or Internet connection to the user's computer is available. For example, an airline traveler on a long airline trip may utilize a laptop computer to shop from the traveler's seat. The order may then be sent later, for example, when a connection such as a telephone line is available. Users may even use the airline telephone to send their telephone orders. Using conventional processes of interacting with a remote website, it was difficult and expensive for a airline passenger to participate in E-Commerce while traveling on an airline. This is because the telephone connect time an airline is extremely expensive. In addition, because the telephone connection may or may not be as good as a land line connection a computer connection to a website via an airline telephone might have to operate at a lower speed to be assured of reliable data transmission. Speed would merely exacerbate the delays experienced during a normal E-Commerce shopping experience.

By using embodiments of the present invention, a user could enjoy a high quality E-Commerce shopping experience with virtually no delays. Even while traveling on an airline, a user could shop throughout the day, for example while traveling on a plane, at a hotel room, while waiting for meetings to begin, or even during a meeting. The user might also engage an automatic window-shopping mode, where the user is taken on an overview tour of the IMS contents automatically (i.e. no user interaction required).

As illustrated in FIG. 8, the eX-Virtual Browser 805 communicates with the VSMS, just as a normal browser would communicate with an E-Commerce server site. Since the eX-Virtual Browser 805 and the VSMS 801 are resident in the same computer system, the transfer of data is seemingly instantaneous. The eX-server 801 also communicates with the E-Commerce engine 803 that in turn communicates with the eX-Virtual Browser 805. The E-Commerce engine 803 provides for the normal E-Commerce function, such as searching for products, tracking purchases, placing items to be purchased in a virtual shopping cart providing forms for entry of shipping addresses. In some preferred embodiments of the present invention, the E-Commerce engine may be used for tracking shopping experience behavior.

Although FIG. 8 portrays an IMS system, distinctions between the parts of the system are mainly for descriptive purposes. The software is actually an integrated application. Because the software is an integrated application intended to be run on a single host system, it can be made to be highly reliable. It also does not have to cope with incompatibilities between browser and web page files, since they were designed to be compatible.

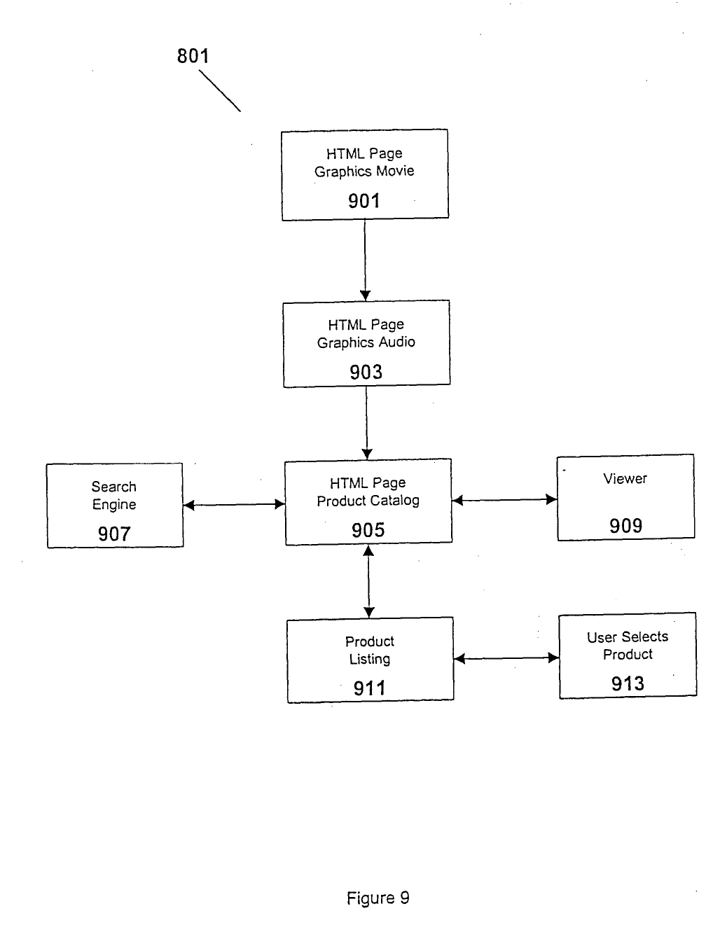

FIG. 9 is a block diagram expanding on the functionality of the VSMS 801 in FIG. 8.

FIG. 9 is an elaboration on the VSMS functions as shown in Block 801 of FIG. 8. The VSMS may provide html page graphics including a video file as shown in Block 901.

The VSMS may provide html page graphics and audio as illustrated in Block 903. The VSMS may provide an html product catalog 905, which may then further interface with a search engine 907 for searching of the html product catalog 905. A product listing may be used for thumbing through the product catalog. A product listing may contain numerous pages of products shown in thumbnail size. The user may jump between product pages just as a user may thumb through a paper catalog and can select different products as in Block 913 in order to expand the thumbnail image within the viewer 909.

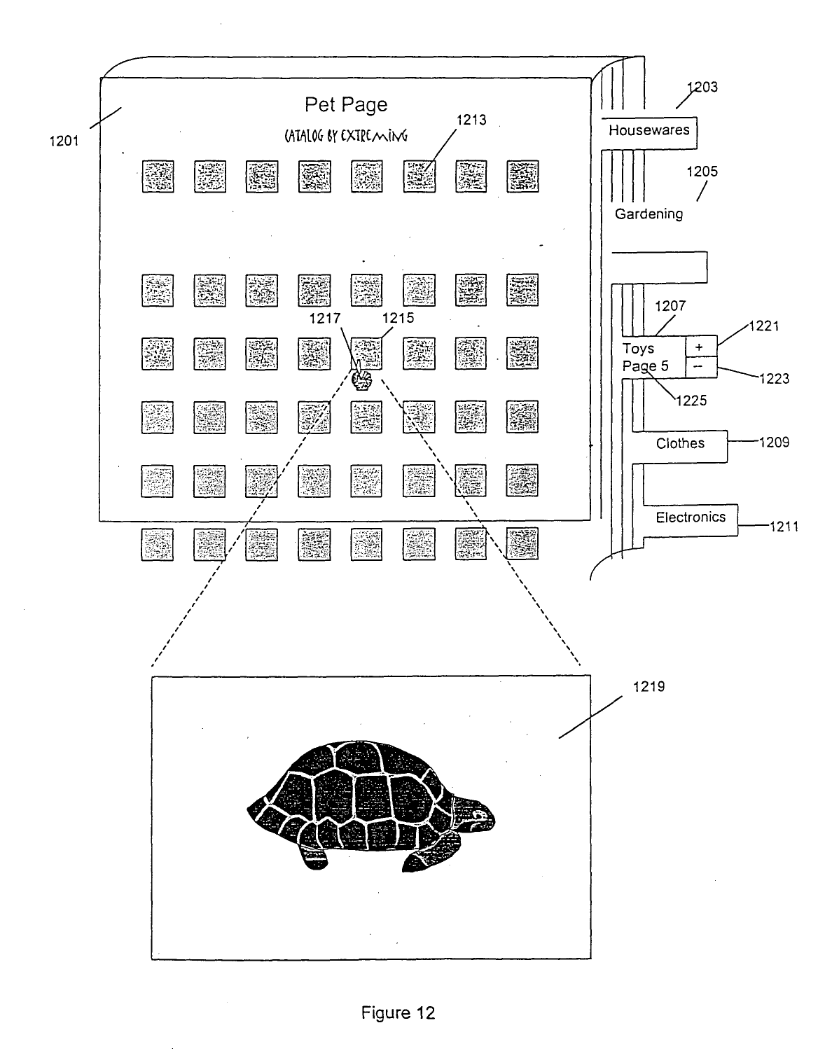

FIG. 12 is a graphical example of an exemplary IMS catalog. In the illustrated example, the catalog is represented on a web page by a display resembling a paper catalog 1201. The display catalog 1201 has a variety of tabs corresponding to different product categories, for example, in a department store, where housewares is 1203, gardening is 1205, toys is 1207, clothes is 1209 and electronics is 1211. The page representing the pet department is currently displayed. By clicking on a tab, the page corresponding to the tab is displayed. Currently, the pet page is being displayed. The pet page comprises a number of thumbnail graphics 1213 representing pictures of different pets. The user chooses the image they want to have enlarged, e.g. 1215, using a common selector mechanism 1217, such as a mouse cursor, and activates it, for example by double clicking the left button of their mouse. Thumbnail 1215 is activated and displayed in the picture 1219.

In addition, tabs may be subjected to multiple clicks in order to display multiple pages. For example, the toys tab 1207 may also have a plus (+) 1221 and minus (−) 1223 graphic on its tab for allowing a user to select other pages either after or before the currently displayed page. By clicking on the “+” the user is shown the next toys page in a sequence of pages. Once the user has reached the end of the toys displayed, the plus (+) symbol 1221 may be grayed out. The user may also activate the minus (−) sign within the tab 1223. By doing so, the pages of the virtual catalog are then advanced in a direction opposite to direction advanced by the plus tab 1221. Additionally, the toys tab may have an insert such as 1225 with a page number indicating the current page being displayed. Not only will this provide a visual cue of where the user of the catalog is browsing, but it also provides a convenient way to identify and reference the different pages. The visual arrangement display in FIG. 12 is merely an example of the type of displays that may be effected utilizing the inventive concepts disclosed herein.

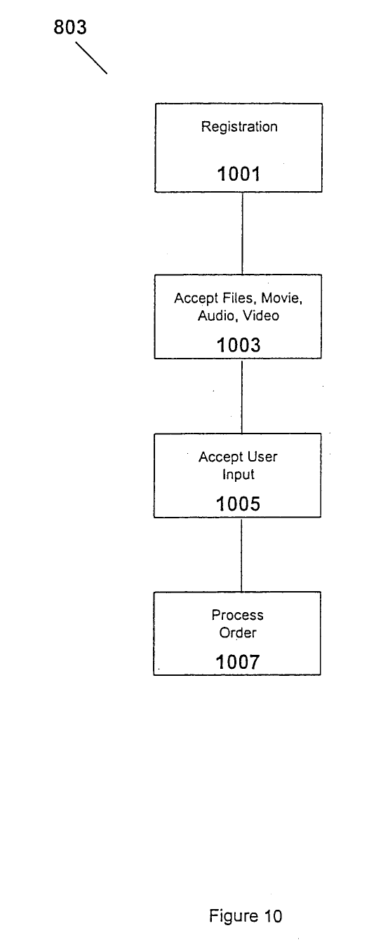

In addition, the product listing function may be used in concert with the shopping diary functions 1113 as will be discussed herein. FIG. 10 is a further illustration of functions of the E-Commerce engine 803 as illustrated in FIG. 8. The E-Commerce engine may provide for a registration of the user 1001. Registration could include, for example, procedures for a user to input user information such as name and address, payment information, for example a credit card or debit card to be used for purchases. In addition, the E commerce engine would accept html files, movies, audios and videos as in Block 1003. This data could also be used to illustrate or compliment product descriptions.

The E-Commerce engine also accepts user input 1005 in order to perform focused searches, place items in shopping carts, begin the checkout process, take items out of shopping carts, estimate shipping costs and the like. Original product data can be stored in a Product Catalog File and accessed by the E-Commerce Engine to deliver shopping cart products and perform focused searches. E-Commerce engine 803 may also contain a facility to process orders 1007. Orders may be completed, for example, when the database engine uses the modem within the user system to communicate with the merchant's remote server via a dedicated 800 number. Using such a scheme, both merchant and the customer-user may participate in an E-Commerce transaction without an Internet connection and without privacy risks that accompany transactions on the Internet. The order processing might also involve the packaging of an order along with approved credit card information 1111 and the sending of the order data and credit card data to the merchant via the eX-Mother Server on the Internet.

A possibility for completing orders is that the user may, after completing an electronic shopping experience, choose to print out an order on their computer's printer and place the order in the mail or send by facsimile transmission.

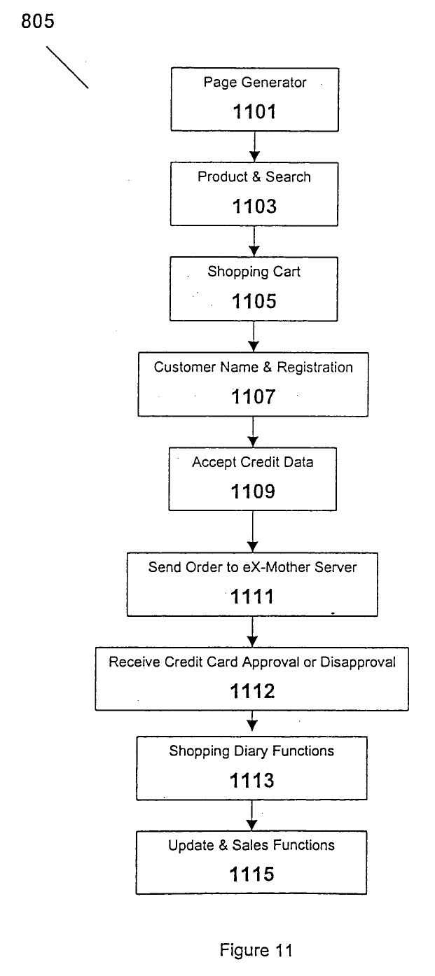

FIG. 11 is a further description of the typical functions of an eX-Browser 805 as shown in FIG. 8. The eX-Browser may perform the normal browser function of accepting and displaying HTML files and shoppable web pages generated by the VSMS 1101. The VSMS also produces pages to be used for information and products searches 1103 as well as provides for a shopping cart for purchases 1105. Additionally, the VSMS can generate shoppable HTML product update and sale item pages. When the eX-Virtual Server (VSMS) queries the eX-Mother Server regarding available product sales or product updates, instructions are sent to the eX-Virtual Server (VSMS) operating on the IMS.

The HTML Page generator function of the VSMS may then use the instructions sent by the eX-Mother Server to generate pages.

The eX-Virtual Browser accepts customer name and registration 1107, credit card data, 1109, couples the information into the E-Commerce engine 803, and assists in sending orders 1111. In Block 1112, the eX-Virtual Browser sends the order for credit card authorization to the Ex-Mother server. The Ex-Mother server then obtains appropriate approvals or disapprovals from a credit authorization company, preferably as an on-line communication with the credit authorization company or sent directly to the merchant for processing. In either case, a verification message is returned to the E-Commerce Engine 803, to cause the E-Commerce engine to generate a message to notify the user of whether the credit card has been approved or disapproved.

In addition, in using the eX-Virtual Browser, shopping diary functions might be activated. Such diary functions provide advantages over print catalog type shopping. By using the shopping diary functions, data about items that the user has displayed is recorded, as well as how long they were displayed, how many times the user returned to those items and whether the user actually ever placed one of those items in a shopping cart.

To use a common paper catalog, a user usually thumbs through the entire catalog, observing pages sequentially or randomly to determine if any of the items within the catalog are of interest. Sometimes a user will compare several articles found in the catalog in order to decide which item is the most appealing. A user may compare description, pricing and a variety of other data associated with the item which the user is considering purchasing and may return to the same page to consider the purchase a number of times. Using the diary function of embodiments of the present invention, a user may similarly thumb through images provided as an electronic catalog within an IMS system several times. The user may then activate the virtual shopping diary, which loads local profile history 219 at a later time, and review which items or product pages have been previously viewed.

A common behavior, when browsing through a print catalog, is to mark interesting items, for later consideration. Paper pages have been marked with bookmarks, the end of the pages folded, small tape tabs appended to the pages or a variety of other ways of “saving” a page for later reference are commonly used. A IMS Interactive Media Site E-Commerce System also provides a user with many different ways of refining their product search. The user's product search may be greatly assisted by the IMS electronic diary function, called a Virtual Shopping Diary. By simply bookmarking the pages of interest, the eX-Browser's bookmark function creates a virtual store which just contains the user's shopping history.

By accessing the shopping diary 1113, a user can see a display of all previously bookmarked items in the same sequential order as they had been displayed previously or the order may be rearranged dynamically by category, number of times the page was displayed, or a variety of other criteria. In such a way, the user could quickly find items that had previously drawn the user's interest. This shopping diary data may be recorded for future use on the user's hard disk. If the user only traverses the catalog without making any purchases, the diary's contents may also be sent to the merchant via the eX-Mother Server during the session, or when the user next logs on to the Internet (if the user removed the IMS before the VSMS had a chance to open up a TCP/IP channel) and relay the information to the eX-Mother Server.

The eX-Mother Server may keep track of all incoming data for customer profiling related to the inherent products and cumulative data mining and product profiling, all of which will be tabulated and sent to the merchant.

Whenever another IMS Interactive Media System containing different products is placed in the user's local computer host device at a later time, the VSMS eX-Virtual Server may read earlier shopping diaries recorded in small files on the user's hard disk. If profiling criteria is appropriately found, the VSMS will dynamically deploy pre-loaded products and shopping pages according to the pre-defined, ACTUAL interests of the current consumer, rendering the user's shopping experience more personal and direct.

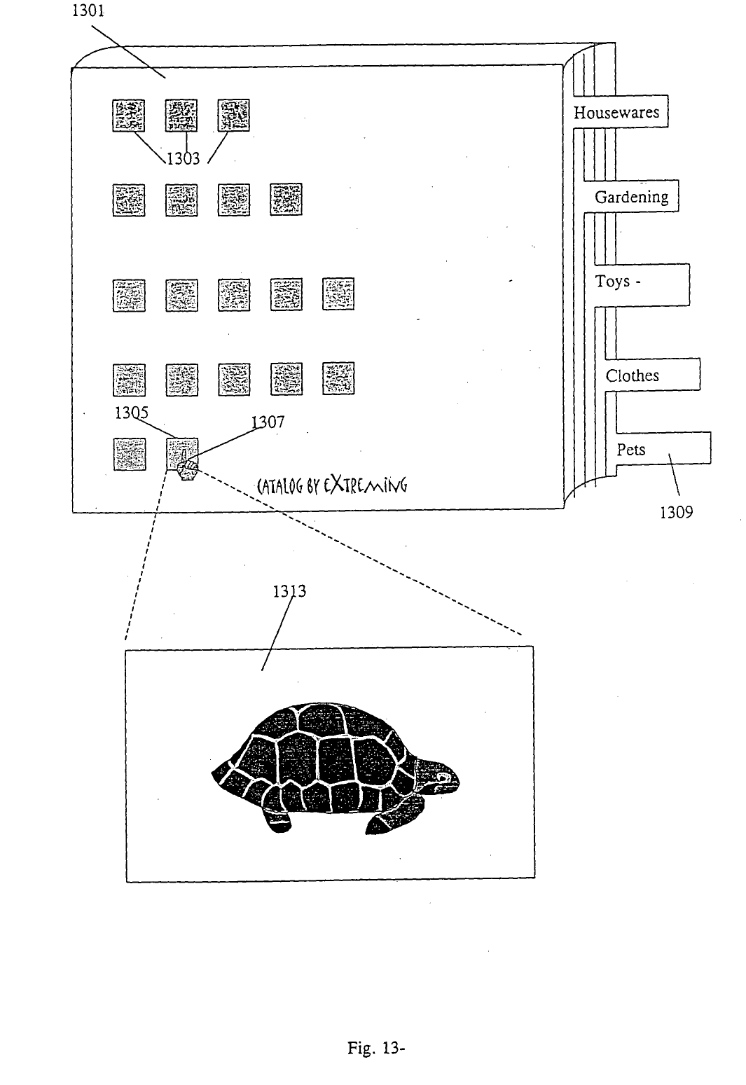

The Virtual Shopping Diary may be used to produce a display such as illustratively shown in FIG. 13. In FIG. 13, the catalog 1301 is once again displayed with thumbnail displays, such as 1303, arranged in conjunction with the different subject tabs. The thumbnails represent displays of items in the catalog that had been accessed by the user. The thumbnails could be placed in such an order as to indicate which items the user was most interested in. A user's interest could be determined by a variety of different methods. For example, a user's interest might be determined by how long a particular image was displayed on the user's screen. Another metric that could be used to determine the catalog user's interest would be to determine how many times a user visited one particular image. Thumbnails of the images that had interested the user could then be displayed on the shopping diary data display 1301. The user could then revisit any image, such as 1305, by selecting it with a pointer 1307 and activating that thumbnail image. Once the user activated the thumbnail image, for example by clicking on it, a larger version of the image would be displayed. In the examples shown in FIG. 13, thumbnail 1305 is selected by pointer 1307. When the user activates pointer 1307 by clicking the mouse button or by entering a return key, the image 1313 that the user had previously viewed is displayed.

A user could also use the same type of display to display items in the user's shopping cart. Because all the items are resident on the user's system, there will be very little delay between the time when a user clicks on a thumbnail image and the time when the full size image is displayed. In contrast, this type of display mechanism may be far less attractive when used with an Internet connection because there might be considerable delay while the full size images are sent from a remote server. When a user clicks on a thumbnail, a larger image must be brought to the screen. If the larger image is retrieved from a local source, such as a CD ROM, RAM, or a hard disk drive, the image may be displayed relatively quickly. Also, a succeeding image may replace the initial image quickly.

However, if the images must be delivered over the Internet, the image must be first requested by the user, which request must then be transmitted over the Internet, and finally received by the remote server. The server must then access the image and communicate it back across the Internet to the user. The delays inherent in such a system could severely limit the technique's usefulness.

No such delays, however, would be noticed in an IMS type application, because all of the images and thumbnails can be stored locally on the CD ROM media of the IMS located on the user's computer host device.

Adaptations of the IMS and the shopping diary could be used for many other purposes. For example, a young couple about to be married might bring home a wedding IMS containing such traditional items as silverware, linen and crystal. The couple might then shop through the catalog clicking on the items that were of interest to them. IMSs containing the shopping diary could then be sent along with the wedding invitations, in order to make the wedding gift giving process much easier. The wedding guests would only need to select an item on the IMS and then order it. The ordering could be done by any of the previously discussed mechanisms of IMS ordering. Shopping diaries could replace “wish lists” in other situations such as birthdays, anniversaries, Christmas or other gift-giving occasions. Services, such as gift-giving, could be easily implemented using the IMS and the shopping diary data.

In addition, this shopping diary data may be provided to the merchant for the purpose of improving catalog delivery or for targeting the user for further IMS application disks. All Virtual Diary bookmark entries, all pages viewed, as well as all items which were displayed for the longest duration of time or the items which were displayed the most number of times (or displayed for a period of time or number of times above a preset threshold period or number) provide the merchant with resources for targeting customers. This information may be sent to a merchant at the time of an order or it may be sent to the merchant the next time that the user logs on to the Internet. The Manager of the IMS electronic catalog application would then obtain data from the users of their IMS catalog in order to refine their presentation. The merchant may also use this user information to target different updates and sales to the current user, as well as placing them on a list to receive future IMS mailings.

An additional application of the Virtual Shopper's Diary enables the IMS to provide real time anonymous customer profiling data on-line to a merchant. Data may be sent to the eX-Mother Server and the merchant can see in real time how the IMS catalogs are actually being used and which products are being purchased. This data can also be recorded and used to provide the merchant with a time line of IMS sales.

The update and sales functions 1115 in FIG. 11 may also be a feature of the eX-Browser. By selecting these functions, or by having them run automatically, the catalog could be quickly updated from a remote server with the new items and sales items. An update function could occur as a background task while the user is using the IMS application to shop normally or if the IMS system was using its deferred ordering function. Sales displayed may then be triggered if the user showed that there was interest in a certain type of product of which a sale was currently being held. The user might also be updated concerning new models and new items available of the type in which they are interested. These functions could take place transparently and in real time in an Internet connected scenario while the user is pursuing an E-Commerce experience or automatically, when a delayed order was being sent to an IMS E-merchant. Such updates and sales functions may be integrated seamlessly so that they do not affect the shopping experience. In other words, while a user was looking at some product images, or while processing a delayed order, the computer could be in the background receiving additional data on new products within the areas in which the user had shown interest.

In a preferred embodiment, an IMS Interactive Media Site has an automatic catalog update function which occurs in the background the moment the IMS is inserted into the user's host device. The VSMS (eX-Virtual Server) can use an existing on-line connection or establish its own TCP/IP Internet connection in order to query the eX-Mother Server and update itself.

If there is no Internet connection detected, the VSMS may allow the user to commence shopping but save all purchases made and may tell the user to install or connect a modem so that the purchases can be sent and sale items checked. Alternately, if no modem is present, the VSMS may give the user the option of printing out his item checkout page and either faxing, mailing, or phoning the order in to the merchant.

Those skilled in the art will realize that the embodiments of the presently disclosed system may be varied to tailor them to individual application needs. IMS marketing may be tailored to individual customers. For example, customers who received a printed seed catalog for gardening purposes may be sent an IMS on gardening supplies to use with their computer. Additionally, IMSs may be tailored to individual consumers. For example, if a user fills out an information request card, such as is often done to request information in magazines and periodicals, the information may be used to send the user a CD ROM containing several IMS applications, that is several stores upon the same IMS. The person may then shop from the electronic stores on the disk, which carry products in which the user has already shown an interest. This may provide advantages over the current E-Commerce systems in that, instead of having to switch websites in order to access products from several different stores, the user may switch between virtual websites, i.e., different stores contained on the same IMS, with virtually no switching latency.

A IMS method of direct electronic marketing in addition to providing improved electronic catalog shopping experiences, which improve over the paper catalogs received in the mail, may provide other types of advantages. One of the other types of advantages is that several stores (for example, multiple different merchants) may be provided on an IMS medium such as, but not limited to, a CD-ROM or even a DVD ROM. DVD ROMS, because of their large capacity, may even provide an electronic mall experience. A user may electronically window shop through multiple stores in an electronic mall and, once the user has found a store containing items of interest, the user may electronically enter the store. Because all of the data and control for the electronic stores are contained locally on the user's computers, the user may window shop rapidly from one store to another, with no delays as would be encountered if the user had to access different websites in an on-line Internet environment.

Some of the new types of shopping experiences enabled by the IMS method of commerce are enumerated herein. Another method of using the inventive principles disclosed herein is to use the IMS storage medium, for example a CD-ROM, to store the large files, which were associated with a remote Internet website and would produce the greatest delays. For example, large graphic files could be stored on the IMS and transferred to the user's hard disk as needed, or may be loaded directly from the CD-ROM by the VSMS while still in contact with a remote Internet website, instead of being transmitted and retransmitted across the web. This could enhance an on-line website experience by providing data intensive applications, such as showing video clips, on the CD ROM. Data intensive techniques are often avoided by web designers because of the inherent delay in transmitting the files between the web server Internet and the user's host system. A IMS Interactive Media System CD could supply those advanced techniques, while the usual load data commands and prompts may be sent back and forth over the Internet. In such a manner, the largest bottleneck (i.e., the transfer of large files from the host website to the user's PC) could be eliminated. Advanced techniques for displaying products and information could then be utilized because of the reduced data transfer requirements.

In another application of IMS VSMS technology in conjunction with an active Internet website, a full media-rich interactive electronic mall may be facilitated. A user may navigate the electronic mall which may comprise basic HTML and minor graphics files, but, with the IMS software application, being able to launch full screen videos and large format graphics using video methods such as a Xing™ Player, Flash™, QuickTime™ or Shockwave™ or even the standard Windows Media Player™ supplied with MS Windows 98, 2000, or NT. Using such graphics and/or video display methods a user is able to simulate a walk through the mall by displaying store fronts in a mall environment. A user may then select a storefront by clicking on it in order to enter that store. A user may then select large graphics files of products or view video product commercials in order to see or purchase the products they are interested in. To accomplish the exact same application over an on-line Internet connection would involve streaming a large amount of video data and thus making it difficult to perform E-Commerce shopping or even normal Internet browsing. However, if the video and graphics files are launched locally (i.e., present on an IMS application and hence run locally on the user's system), the files needed could be loaded from a high capacity media such as an IMS on a DVD (Digital Versatile Disk).

Additionally, the Mall website may actually run the IMS's media content from CGI or other programming instructions inside of the pages which reside on its merchant website's Internet server and are called up by the IMS from the user's local host device (PC). The website's Internet server could then send commands to display various files from the IMS DVD locally on the user's host system representing other portions of the Internet store or the E-Commerce shopping cart and checkout portion of the store. The user may then shop unassistedly from an IMS application, unaware that what he is seeing are the results of a hybrid Internet application. If some new information is desired, such as information regarding new products which have been recently received, products which are on sale, if an item is back ordered, or other promotions within the store, the merchant's Internet Website server could receive the request for information in the background—by sending and receiving update instructions from the merchant's site via the eX-Mother Server the VSMS may create new pre-programmed pages which could request graphics and video files from the IMS concurrently inserted into the user's host device to display. (In such a case the “Client” in traditional terminology, has now been temporarily transposed into a “Client/Server/Client” and the “eX-Mother Server” has been transposed into a “eX-Mother Client.”) A user could even be told that new sales items are about to be downloaded to their host device while the user is using the IMS “E-Commerce” system, in order to give the user the latest and best prices.

Another application of the IMS technology is deployed by having an IMS control a merchant's remote Internet server from the user's host device, with or without the need for an eX-Virtual Server or VSMS. In this scenario, there might not be a VSMS server on the IMS, but the IMS would contain just enough programming and pre-programmed web pages or programming executable to show all media content and send instructions to the remote Internet server to perform E-Commerce and credit card approval, then “returning” the user back to the Interactive Media Site existing on the IMS. The user will not be able to tell the difference or notice that an external website provided the “background” shopping cart, etc.

In this type of application, the IMS takes actual control of the merchant's remote website server. A VSMS (eX-Virtual Server) may not exist on the IMS; however the IMS contains pre-programmed (CGI, Java, PHP, etc.) HTML web pages from which instructions are sent or posted to the remote server. The remote merchant server assumes these instructions are coming from a “visiting client” machine on the Internet when in fact they are being sent by the eXtreming web pages on the IMS software. Thus the “Client-Server” relationship normally found on all Internet applications is reversed by the specialized instructions originating from the IMS and completed by the merchant's remote server, in effect, turning remote servers into a “client.”

Another application of the IMS technology allows for use of the HTML Web Page Update or Generation engine (as previously outlined) to be used to create a dynamic, perpetually updating, Merchant and Affiliations Advertiser's Page. As the IMS is installed into a user's local host device, it may, either in the beginning of the shopping process, or at any time during the process, and as many times as needed during the process, request or send instructions for any of its operations, to the eX-Mother Server. At this time the latest merchant's or advertiser's or affilliate's internet link information is sent to the eX-Virtual Server on the IMS. The eX-Virtual Server may then assemble a dynamic (existing in memory only—not hard coded or physical) HTML page or may create a hard coded HTML page on the user's local hard disk storage media. Merchant advertisers or affiliates graphics may be pre-loaded already on the IMS. In this way dynamic, or “on-the-fly” HTML web pages with the latest advertisers and their links may be displayed to the current IMS user, regardless of when the user installs the IMS into his local host device.

Another application of the IMS technology may be called “IMS-Internet (IMSi)” and can be realized by having the eX-Virtual Server on the IMS act in tandem with a merchant's existing remote website's Internet server. With IMSi technology, all HTML pages reside on the remote website's server, but all graphic files, large video files and searchable Databases are located on the IMSi CD ROM, and operate from the local user's host device. The user inserts the IMSi CD ROM into his local host device and the eX-Virtual Server located on the IMSi CD ROM activates or loads the user's default Internet browser. If the user is not already on-line, the eX-Virtual Server initiates an internet connection, as previously defined as standard IMS activity.

The eX-Virtual Server intelligently causes the user's default browser to locate the merchant's remote server's Internet website, concurrently sending the electronic address or HTTP Internet Protocol (IP) address of the calling IMSi of the user's host device. On the merchant's remote Internet Server website there is a software program waiting to receive the IMSi's HTTP IP address as well as other instructions or directions as to which website pages to load or which place or part of the website store to start the visiting user.

The receiving program specified here on the remote Internet server's website is a portable or compiled software version of the eX-Mother Server (called here an eXP-Mother Server). As the user browses a remote website, the remote eXP-Mother Server sends web pages with pre-programmed instructions to the local user's IMSi to load all graphics and video files, as well as do database searches or perform all database needs as required or requested by the user visiting the remote Internet web site through his browser.

In this type of application, the IMSi and the eXP-Mother Server program on the remote merchant Internet server actually share control of both the merchant's remote website and the user's host device's browser, where the IMSi CD ROM is currently installed. The remote Internet website is built by the merchant and contains the majority of HTML website pages being viewed, however these HTML pages contain embedded, pre-programmed commands from a language by which the eXP-Mother Server communicates with the eX-Virtual Server on the user's host device. This language is called “Virtual Server Markup Language” or “VSML.” These embedded commands instruct the eXP-Mother Server to load the requested internal website HTML pages as well as coordinate the posting (locate and sending of) instructions to the originating IMSi's software, or eX-Virtual Server. These instructions are received by the IMSi residing on the user's host device by linking back to the IP address originally given by the IMSi, then sends instructions as to which graphics, video files, or database searches to perform, completely coordinated with the answering remote server. What the user actually sees is the composite of both actions of the eXP-Mother server loading the website's HTML pages, and the graphics, video files, or database searches being controlled by the eX-Virtual Server on the local IMSi.

These actions happen exceedingly fast since everything but the remote HTML web pages are loaded locally from the IMSi CD-ROM user's host device and, where possible, may be pre-loaded into RAM memory. The user's Internet shopping experience is heightened by the fact that all files and database activity do not have to be transferred from the remote server across the multiple nodes of the Internet, to arrive at the user's host device. Additionally, the user is able to experience video media which would not have been possible or feasible loading from the website.

Additionally, the merchant's remote internet server website is freed from excessive bandwidth usage. For example, many people doing file downloads and loading graphics as well as database file access searches, thousands to hundreds of thousands at the same time, accessing the same Internet server simultaneously. All these activities normally have to be accounted for in building Internet server website hardware and software to accommodate the cumulative needs of each user who comes on-line. The lessening of physical bandwidth requirements and allocations needed for each visitor may allow an Internet server website to safely accommodate multiple amounts of new or additional shoppers on the same server or website without increased costs for adding expensive new Internet server hardware.

When the IMSi initially links to the remote Internet server, the remote Internet server assumes the instructions or requests originating from the IMSi are coming from a “visiting client” machine on the Internet. The remote server allows itself to pass control to the residing eXP-Mother Server software. However, when the eXP-Mother Server takes over to load or serve HTML it also turns itself into a “client” device and communicates back to the calling IMSi's eX-Virtual Server on the user's local host device. The eXP-Mother Server now requests the IMSi to “serve” all graphic, video, and database functionality to itself Thus the “Client-Server” relationship normally found on all Internet applications is again reversed by the specialized instructions originating from the IMSi and completed by merchant's remote Internet server, in effect, turning remote servers into “client/server/clients.”

There are, therefore, a variety of intermediate applications which range between an electronic commerce shopping experience such as might be produced by an IMS “E-Commerce” system and a dedicated connection to a website. These would all be intermediate steps between current E-Commerce and full IMS “E-Commerce”. A major difference between hybrid and full IMS commerce is that, in full IMS commerce, the VSMS is of course supplied by the IMS storage media and runs entirely on the local machine without the need for an on-line connection except to receive authorized credit card approval. The eX-Virtual Server is then resident along with the entire application on a pure IMS “E-Commerce” application. In a hybrid application between pure IMS commerce and current E-Commerce, a merchant's web server could be used to only provide the CGI functionality for adding up purchases, calculating tax, receiving credit card information etc. Only that type of information need be transferred. In such a hybrid IMS “E-Commerce” application, the access speed could be increased considerably as well as increasing the quality of the shopping experience. The hybrid IMS may require the user to be on-line during most of the activity, but it would provide a much faster interactive experience than accessing a conventional website to purchase products because graphic intensive operations are still resident locally on the IMS.

By utilizing the IMS method of Virtual Streaming Interactive media E-Commerce, there are a variety of ways that revenue may be generated.

A first way in which the IMS may be used to generate revenue is to charge to a merchant who received purchases from an IMS transaction a transaction fee for each transaction in the form of a license. This may amount to an 80-90 percent reduction in conventional financial card costs while in addition not adding any additional infrastructure. IP Merchants would be approached and asked if they wish to have an interactive media site on an upcoming IMS mailing or a future IMS distribution. Distribution might take any number of forms, for instance a direct mailing, giveaways in stores, or in response to inquiries. The merchant could pay the costs of manufacture and distribution. Once the store had been created and manufactured for the merchant, the IMS could then be distributed. Once distributed, the merchants may be charged a percentage of each sale that had resulted from the IMS, the merchants may be charged a fixed amount per sale, or by the number of individuals who had made purchases. The purchase statistics would be accessible because sales would either go through the eX-Mother Server, or the information could be accessed or a special code may be added to IMS orders which were mailed, phoned or faxed.

In another version of this revenue model, the producer/issuer of the IMS media could essentially market to a merchant the ability to provide the merchant's store on a disk for a percentage of the sales, which were achieved using an IMS system. Since the IMS is producing a sale that would not have existed otherwise, a sale not related to the brick and mortar site, an IMS sale may be a highly profitable type of sale to a merchant. Because of the profitability and because of the no up-front cost to the merchants, the business model of producing IMSs for stores at no cost in exchange for a percentage of sales, may produce considerable revenue for the IMS producer/issuer.

A second way in which the IMS may be used to generate revenue is from a license fee, which may be charged according to the number of IMS media distributed. For example, a specified amount, above the costs of producing the IMS and the mailing, could be charged for each IMS mailed.

A third method of generating income is through an affiliate program. In such a program affiliates may be charged a fee in order to have their URL appear or a commercial appear when a person has signaled that they wish to close their IMS shopping episode. For example, a person leaving an IMS electronics store, where CD music players are on sale, might have an advertisement appear to purchase CDs or order an IMS CD catalog. Affiliates might also pay fees to have their stores, or perhaps an abbreviated version of their stores, available within the IMS application. With a preview store of an affiliate being shown to a user, the user then may signify a desire to receive a full IMS store, for example, on a CD in the mail. Such a system would generate leads for the affiliates and income for the primary IMS merchant.

In another method of receiving affiliate income the IMS's could include affiliate merchant's commercials, banner ads or other advertising embedded on an IMS. Such ads, when viewed or accessed by a user, could, at the user's option, link the user to the affiliate merchant's Internet website. The affiliate merchant would pay the IMS's issuer a “click through” fee and/or a fee for any transaction made by a user who links to their site via the IMS.

A fourth way in which an IMS may be used to generate income is to provide targeted ads to users that merchants would pay a fee for as a further advertising service. For example, the IMS service provider could examine an IMS user profile from the user diary, or one present on the eX-Mother which had been accumulated for the user. If the user profile indicated an interest in a certain type item, an interactive advertisement provided by either the same merchant or another could then be downloaded to the user's system. Once the advertisement was downloaded the advertisement could then be activated. The IMS issuer could provide these targeted advertisements for a fee to merchants. In addition, responses to the ads could be analyzed in light of the local user profile and the shopping diary. Information from this analysis of purchasing demographics then could be provided to the merchants for a fee.

A fifth way of generating income could be to provide IMSs, which generally do not sell anything, but instead are used to examine consumers responses. For example, an automobile manufacturer could provide an IMS through a mailing. The automobile manufacturer might show pictures of its cars, horsepower ratings, prices, etc., etc. The user could then view the disk once or several times and after it had been used for a predetermined number of minutes or views, the user may be prompted to link to a standard on-line website of the automobile manufacturer in order to receive a promotional discount or sales pitch. For example, a user might be prompted by incentives to link to the local dealer for the automobile manufacturer for promotional considerations. For example, a user could be informed that, by logging into the local dealer and accessing their website, the user would receive a free set of car mats, a free window tinting or some other promotional item if they purchased their vehicle from the local showroom. In addition, the local car dealer can be charged for the leads being provided by a variety of methods such as a fixed amount per lead or a fixed percentage of the amount of purchase. In addition to those methods of creating income from the site, data could be gathered on how the user used the IMS, including, for example, which images the user displayed, which videos the user viewed, which items the user spent the most time on, which were most frequently accessed, the order in which the IMS is accessed and a variety of other useful marketing information. This information may be sent to the merchant (through the eX-Mother Server) even if the user does not immediately purchase any product.

In addition a shopper's diary, which had been recorded on the user's host device may be a source of revenue. The shopper's diary may contain valuable information about a purchaser's buying habits, especially with respect to the IMS. The shopper's diary may be uploaded at the time of a purchase being made via the IMS. Such an upload could be used for statistical purposes, for example, to find out which IMS products or pages are most and least popular. Such information may be used to later enhance customers appeal of IMS systems and their offerings displayed therein by delivering targeted advertising based on the feedback received from individual IMS users/customers or groups of users and customers. Merchants may be charged, based on the type and quantity of information the IMS delivered to users and merchants alike.

A further application of the Shopper's Diary enables the IMS to provide real time anonymous profiling which gets sent to the eX-Mother Server so that a merchant can see how the IMS catalog is actually being used and which products are being purchased in the field, right from the commencement of an IMS activity.

Another way of realizing revenue from the IMS is by providing an e-mail facility which would e-mail orders to a merchant. A fee could be charged per e-mail. Another method of providing revenue generation from an IMS is by allowing affiliate click-throughs, for example, on the final screen of the IMS shopping experience. Each click-through that resulted from an IMS could be recorded and used to determine fees to be paid the owner of the clicked-to site.

Although the applications discussed involve a computer user and an IMS application other IMS platforms might also be employed. For example, an IMS application could be utilized in a video game machine or bi-directional cable set top box. A bi-directional cable set top box user may watch a home shopping channel and indicate, by pressing a button on a remote control, that the user is interested in products from the manufacturer who was currently displaying products on the television. A signal then could be generated in the bi-directional cable set top box in order to send a signal to a cable head end (cable operator), which would then cause the downloading of an IMS application. The next time the user turned on the television, one of the menu items available from the bi-directional cable set top box may be a link to go shopping using an IMS application which had been downloaded to the cable box. In such a case the entire shopping episode could be conducted with a remote control and billed through the Cable Company. By having the IMS resident, the problem of the phone line being busy when a home shopping viewer wishes to order, is eliminated. The order is communicated automatically by the IMS application in the cable box. The Cable Company would be able to generate additional revenue for itself because it could then target advertisers to its local customers much more accurately.

With another application of the IMS/VSMS technology, similar Interactive Media Site catalogs on IMSs can be inserted into set top boxes. Currently, many of the set top boxes have hard drive space. The IMS VSMS software can be downloaded to the cable box by inserting a CD, DVD, or mini-disc media into existing slots within the cable box. This will provide local merchants a vehicle for selling their services and wares. All the commercial spots that a Manufacturer or IMS Merchant is airing locally could have commerce-enabling technology. Catalogs on an IMS could be sent to the consumer on a monthly basis, along with their movie guide catalog.

The Cable Company could then generate revenues by (1) billing the consumer for the transaction or (2) charging a fee per downloaded IMS store.

Other preferred embodiments of the present invention provide a VSMS/IMS system running an Interactive Media Site accessible from an IMS storage medium that further includes an intelligent and secure financial card function for use in E-commerce transactions that enables a consumer to shop at off-line or on-line sites without providing any financial card information to the merchants. Embodiments of the present invention advantageously employ portions of infrastructure used in existing financial card E-commerce transactions to provide better security and privacy for a consumer's financial card and personal information by not providing this information to a merchant during an E-commerce transaction.

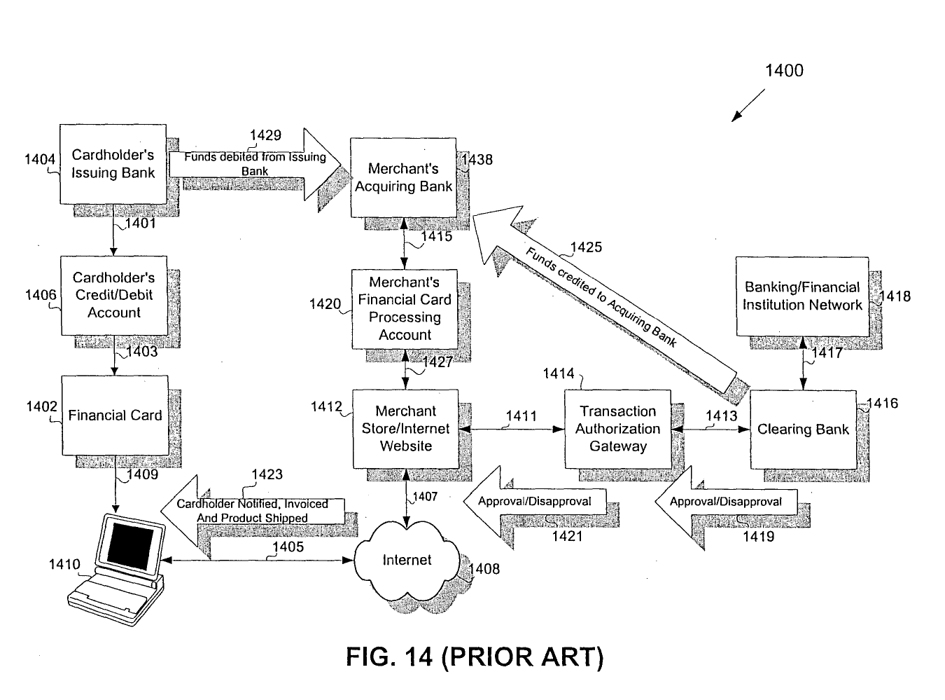

Because some preferred embodiments of the present invention employ portions of infrastructure used in conventional financial card E-commerce transactions, an example of such an infrastructure is first described below in the context of a conventional financial card E-commerce transaction including a conventional financial card authorization and verification system and process. An example of a conventional authorization and verification system and process for a conventional financial card E-commerce transaction 1400 is illustrated in FIG. 14. As shown in FIG. 14, the issuing bank 1404 maintains a credit or debit account 1406 for the consumer, depending on the type of financial card 1402 that may be issued to the consumer, as represented by arrow 1401. Issuing bank 1404 may be any bank or other financial institution or entity that issues financial cards to consumers. The consumer receives a financial card 1402 from an issuing bank 1404, as represented by arrow 1403.

The consumer (also referred to in the present disclosure as the “bank customer”) may engage in an E-commerce transaction using the financial card 1402 by accessing the Internet 1408 from a host device 1410. Host device 1410 may be any one or combination of a variety of computing type platforms such as, but not limited to, a television set top box, a gaming console, a personal computer or a PDA and may use a telephone modem, cable modem, digital subscriber line, wireless interface or other suitable means of communication to connect to the Internet 1408, as represented by double arrow 1405. In order to determine which websites provide the products or services desired by the consumer, the consumer may, for example, employ a search engine and search for the items. The consumer may in this way access a merchant website 1412 connected to the Internet 1408 that provides the items that the consumer desires to purchase, lease or otherwise obtain, as represented by double arrow 1407.

After locating the item that the consumer desires to obtain on the merchant website 1412, the consumer may place an order through an ordering process used by the merchant website 1412. As part of the ordering process, the consumer typically is presented with an HTML form into which the consumer may manually enter financial card 1402 information, as represented by arrow 1409. When the financial card 1402 information is entered in the form, the consumer may finalize the order by, for example, clicking or otherwise selecting an operator on the screen that indicates that the transaction is completed.

The merchant website 1412 may employ a fraud prevention system such as, for example, an address verification system (“AVS”) that is used to verify that the address given by the consumer matches that of the cardholder. The AVS functionality may be provided to the merchant by the transaction authorization agent operating transaction authorization gateway 1414. In the alternative, a transaction authorization agent may perform the AVS functions after the merchant has transferred the financial card information to the transaction authorization gateway 1414. Thus, the merchant website 1412 may submit the financial card 1402 information to the AVS and may receive in response an AVS code that may notify the merchant, for example, whether or not the address and zip code used in the E-commerce transaction match those of the cardholder. Thus, if a consumer purchases a product over the internet and gives a shipping address that is different than the address on the financial card 1402, the AVS system may detect this and alert the merchant.

If the AVS system verifies that the address given by the consumer matches that of the cardholder, the merchant website 1412 may then transfer the financial card 1402 information, along with the transaction amount, and merchant identification information, to the transaction authorization gateway 1414, as represented by double arrow 1411. The transaction authorization gateway 1414 may be operated by a transaction authorization agent such as Authorize.Net™, VeriSign®, or Cardservice International®. The transaction authorization agent operating the transaction authorization gateway 1414 may perform financial card payment processing services for the merchant website 1412, for example for a fee or a percentage of sales.

The information provided by the merchant website 1412 may then be transferred from the transaction authorization gateway 1414 to a clearing bank 1416 for fund availability verification, as represented by double arrow 1413. The clearing bank 1416 may verify that the consumer has sufficient funds available for the transaction and may perform credit/debit functions for the issuing bank 1404 and the merchant's acquiring bank 1438 (“merchant bank 1438”). Merchant bank 1438 holds the merchant's financial card processing account 1420, as represented by double arrow 1415. The clearing bank 1416 may outsource a portion of its functions to a Banking/Financial Institution Network 1418, as represented by double arrow 1417.

Once the fund verification is performed by the clearing bank 1416, the clearing bank 1416 may notify the transaction authorization agent operating the transaction authorization gateway 1414 as to whether or not the consumer's transaction is approved or disapproved, as illustrated by arrow 1419. The transaction authorization agent may then notify the merchant operating the merchant website 1412 of the results of the verification, as illustrated by arrow 1421. If the transaction has been approved, the merchant may then inform the consumer that the transaction has been approved, create an invoice for the transaction and ship the product or provide the service to the consumer, as illustrated by arrow 1423.

As an additional part of a conventional financial card E-commerce transaction, the clearing bank 1416 also typically sends a funds transfer order to merchant bank 1438, as illustrated by arrow 1425. The merchant bank 1438 then transfers funds into the merchant's account 1420. The funds are then accessible to the merchant, as represented by double arrow 1427. Merchant bank 1438 receives in exchange the right to collect on the debt owed by the consumer. The issuing bank 1404 maintains the consumer's credit/debit card account 1406 and must pay out the amount of the transaction to the merchant's account 1420 during a subsequent settlement process, as illustrated by arrow 1429. The issuing bank 1404 then bills the consumer for the debt. Thus, the entry of the consumer's financial card information into the on-line form results, after the authorization and verification process, in a bill to the consumer for the product or service obtained during the E-commerce transaction.

The conventional financial card E-commerce transaction described above has several disadvantages. One disadvantage is that the conventional financial card E-commerce transaction may not provide an adequate level of security for the consumer's financial card information. This is because an inherent part of the transaction is providing to the merchant the consumer's financial card information during the E-commerce transaction. Once the merchant is in possession of the financial card information, the information may no longer be secure from theft by unauthorized individuals.

One reason for this lack of security is that the merchant's employees may have access to the financial card information in a merchant's database and a rogue employee may use the information in fraudulent transactions. Furthermore, the merchant's database may not be secure against attempts by hackers to access the information. In addition, the computer system storing the database may be stolen from the merchant's brick and mortar store or from whatever location the database is physically stored.

Furthermore, the conventional financial card E-commerce transaction may not protect the privacy of the consumer. This is because once the merchant has obtained information from the consumer such as the consumer's name, e-mail address and product preferences, the financial incentive is strong for the merchant to sell this information to other merchants, for example in the form of customer mailing lists. Thus, consumer privacy may be compromised during a conventional financial card E-commerce transaction.

Another disadvantage with the conventional financial card E-commerce transaction described above is that the fraud prevention systems employed for protecting the merchant against financial card fraud may not ensure that the consumer is actually the person authorized to use the financial card, or even that the financial card is a genuine one. Although a merchant may be provided with limited protection by using an AVS, he or she may still be vulnerable to more determined and resourceful perpetrators of Internet financial card fraud.

For example, personal details about a particular person may be obtained illicitly through various techniques such as accessing the person's personnel records, accessing the person's waste baskets and other common methods. This identity theft then enables the perpetrator to apply for a financial card using the identity of the victim of the identity theft. The victim may have a good credit history. Therefore, the E-commerce transaction may be authorized by the fraud prevention system although the person using the card is not the actual person named on the financial card.

In addition, in some cases, as a result of identity theft, the perpetrator has more information about the legitimate cardholder than the issuing bank. Thus, the address of the consumer may be known to the perpetrator, and the address given by the perpetrator may match that of the cardholder, thus bypassing an AVS.

Furthermore, it is possible that algorithms used to produce legitimate financial card numbers, and that are freely available on the Internet, may be used to generate fictitious financial card numbers that will pass existing verification tests. Thus, a totally fictitious financial card may be created and used to bypass the verification safeguards employed by the merchant.

Thus, although verification systems exist for the purpose of verifying that a financial card transaction is genuine, a resourceful Internet criminal can readily bypass the systems and appear to be an authorized user of the financial card. Essentially, this is because conventional verification systems do not verify that use of a financial card is authorized, or even that the financial card is genuine, but only that it appears that the transaction is authorized and that the financial card is genuine.

Yet another disadvantage with the conventional financial card E-commerce transaction described above is that the merchant is required to pay fees to a third party transaction authorization agent. In exchange for the paid fees, the transaction authorization agent performs financial card payment processing services for the merchant website. Thus, the use of the third party transaction authorization agent by the merchant increases the costs of doing business on the Internet and may significantly affect the merchant's bottom line.

Accordingly, to overcome these disadvantages in conventional financial card E-commerce transactions, preferred embodiments of the present invention provide a virtual server consumer authorization, verification and credit update method and article that allows more secure E-commerce transactions with Internet merchants by avoiding the transfer of financial card information to the merchants, while at the same time advantageously employing portions of infrastructure already used in conventional financial card E-commerce transactions.

Further preferred embodiments of the present invention advantageously increase Internet merchants' profits by providing an intelligent financial card that verifies itself and acts as its own transaction authorization agent during an E-commerce transaction, thus eliminating the third-party transaction authorization agent and resultant costs to the merchant.

Additional preferred embodiments of the present invention better protect a consumer's financial card information as well as privacy by enabling an E-commerce transaction with an Internet merchant while avoiding the transfer to the merchant of not just the customer's financial card information, but any customer information at all. The merchant merely receives a customer identification number.

Yet further preferred embodiments of the present invention better protect a merchant against fraudulent E-commerce transactions by providing a customer identity verification system that more reliably verifies that the person using financial card information for the E-commerce transaction is the actual person authorized to do so.

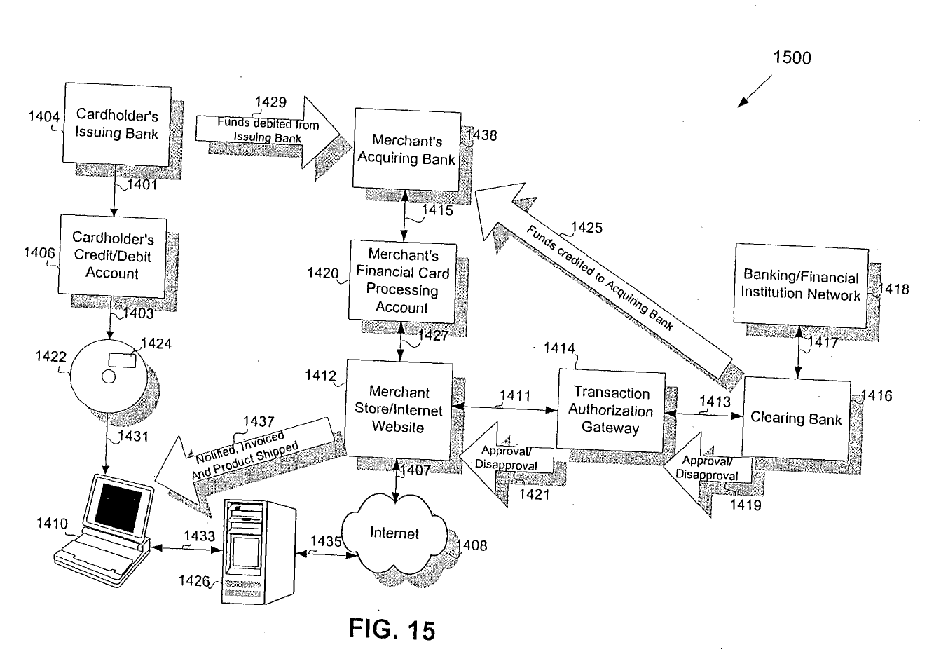

According to one embodiment of the present invention, illustrated in FIG. 15, elements of the conventional financial card authorization and verification process described above in relation to FIG. 14 are employed in combination with an IMS storage medium 1422 including an embedded and encrypted IMS financial card 1424 to provide a more enjoyable and trouble-free E-commerce transaction 1500 than the conventional financial card E-commerce transaction 1400 illustrated in FIG. 14. Like reference numbers in FIGS. 14 and 15 indicate identical or functionally similar elements.

In one embodiment, a bank may issue the IMS financial card to preferred bank customers, for example in a targeted mailing campaign. Thus, issuing bank 1404 may mail or otherwise provide to selected customers, for example based on credit history, account balances, or other suitable criteria, IMS storage medium 1422, which may include embedded and encrypted financial card information 1424 of the selected consumer to whom the IMS storage medium 1422 is provided. In one embodiment, the encrypted financial card information 1424 may be embedded in the IMS storage medium 1422 by employing a plug-in application program interface (“API”) designed and provided to the issuing bank 1404 for that purpose.

The consumer may then use the IMS storage medium 1422 to obtain products or services in an E-commerce transaction. When the consumer desires to engage in an E-commerce transaction, the IMS storage medium 1422 may be inserted into host device 1410 and activated and accessed by the consumer, as represented by arrow 1431. In one embodiment, when the IMS storage medium 1422 is activated and accessed by the host device 1410, the VSMS is loaded into a memory device of the host device 1410, for example RAM memory, as described above. In addition, in one embodiment, the financial card information 1424 of the consumer embedded on the IMS storage medium 1422 is automatically entered into a memory device of the host device 1410, for example RAM memory, transparently to the consumer.

The VSMS may include browser software that may establish a connection with a dedicated server, for example, eX-Mother Server 1426, as described in detail above and represented by double arrow 1433, using a telephone modem, cable modem, digital subscriber line, wireless interface or other suitable means of communication. The eX-Mother Server 1426 may, in turn, contact a remote merchant website 1412 via the Internet 1408, as represented by double arrows 1435 and 1407. The consumer may then search for a desired product or service on the merchant website 1412.

When an order is placed for a desired product or service, the financial card information 1424 may be sent from the memory of the host device 1410 to the eX-Mother Server 1426, transparently to the consumer and without the need to fill in any on-line forms. Thus, the enjoyment of an E-commerce transaction is enhanced by eliminating the tedious manual entry of financial card information into an on-line form.

In one embodiment, the eX-Mother Server 1426 may include software for decrypting the financial card information 1424. After decryption of the financial card information 1424, the eX-Mother Server 1426 may send the decrypted financial card information 1424 to the clearing bank 1416 via merchant website 1412 and transaction authorization gateway 1414 for authorization and verification of availability of funds, as represented by double arrows 1411 and 1413. After authorization and verification of availability of funds, approval or disapproval of the transaction may be communicated from the clearing bank 1416 to the transaction authorization gateway 1414, as represented by arrow 1419. Approval or disapproval of the transaction may then be communicated from the transaction authorization gateway 1414 to the merchant website 1412, as represented by arrow 1421. The merchant website 1412 may, in turn, notify the consumer. If the transaction was approved, an invoice may be processed by the merchant, and the product shipped to the consumer, as represented by arrow 1437.

Thus, instead of manually entering the information on financial card 1402 into an HTML page, as in the conventional financial card E-commerce transaction 1400 illustrated in FIG. 14, embodiments of the present invention embed the bank customer's encrypted financial card information 1424 on the IMS storage medium 1422. The financial card information 1424 may be automatically entered into memory of the host device 1410 when the IMS storage medium 1422 is accessed or activated by the host device 1410, transparently to the user. Or, based on a determination by port security of the host device 1410, the financial card information 1424 may be relegated to first in first out (“FIFO”) access so that the port conveying the secure data is only opened for a short period of time (for example a few seconds). When a selected product or service is ordered on the merchant website 1412, the financial card information 1424 is sent to the merchant website 1412 via the eX-Mother Server 1426, again transparently to the user. Elements of the conventional financial card authorization and verification process described above in relation to FIG. 14 are then used to complete the E-commerce transaction 1500.

Embodiments of the present invention described in relation to FIG. 15 may further include on the IMS storage medium 1422 one or more virtual stores, as described above. Thus, the consumer may engage in off-line E-commerce transactions as well as on-line E-commerce transactions.

Embodiments of the present invention described in relation to FIG. 15 may further include password protection for the financial card information 1424. Thus, the bank customer receiving the IMS storage medium 1422 may be required to call the issuing bank 1404 and provide one or more passwords and/or PINs. In one embodiment, once the consumer has accurately provided one or more passwords and/or PINs to the issuing bank 1404, host device 1410 accesses the IMS storage medium 1422, loads the VSMS and establishes a connection with the eX-Mother Server 1426. The eX-Mother Server 1426 may then establish a connection to the issuing bank 1404 to verify that one or more passwords and/or PINs have been provided by the consumer. The connection may be, but is not limited to, a telephone modem, cable modem, digital subscriber line, wireless interface or other suitable means of communication. The issuing bank 1404 may be provided, in some embodiments, with a proprietary plug-in API that acts as a communication interface with the eX-Mother Server 1426.

In the alternative, the one or more passwords and/or PINs may be encrypted and embedded on the IMS storage medium 1422. In one embodiment, when the consumer accesses the IMS storage medium 1422, the one or more passwords and/or PINs may be loaded into a memory device of the host device 1410, for example, RAM memory, along with the financial card information 1424. The VSMS may also be loaded into memory and may establish a connection with eX-Mother Server 1426, as described above, using a telephone modem, cable modem, digital subscriber line, wireless interface or other suitable means of communication. The eX-Mother Server 1426 may then access and decrypt the one or more passwords and/or PINs and initiate a query/response sequence with the consumer. If the consumer responds to one or more queries with the correct passwords and/or PINs, the eX-Mother Server 1426 may allow the consumer to purchase products and/or services from on-line merchant websites, as well as from virtual stores included on the IMS storage medium 1422, using the financial card information 1424. Once the consumer has finished, the memory of the host device 1410 (for example, RAM memory) may be flushed or overwritten so as to leave no trace of the consumer's financial data or transaction. The operating system of the host device 1410 may also be precluded from placing any of the data into system cache.

Embodiments of the present invention described in relation to FIG. 15 may operate without the eX-Mother Server 1426. Thus, in one embodiment, the VSMS may establish a direct connection with the merchant website 1412 in order to shop for and purchase products and/or services using the financial card information 1424. Merchant website 1412 may be provided with a proprietary plug-in API to act as a communication interface for communication with the VSMS running on the host device 1410.

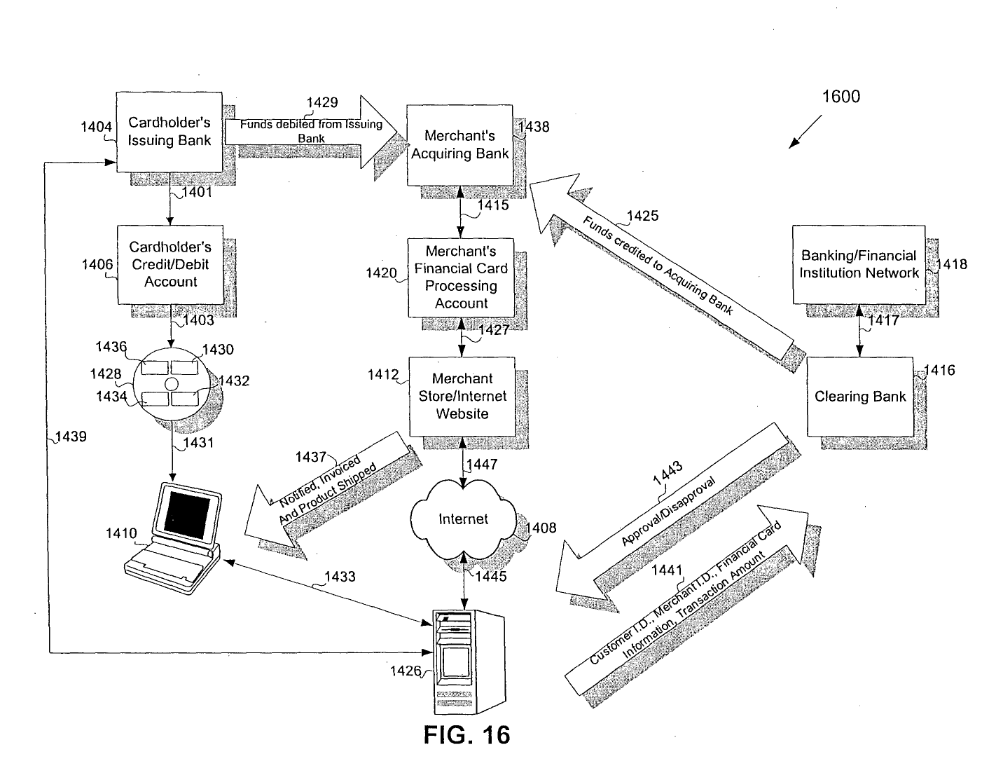

According to another preferred embodiment of the present invention, illustrated in FIG. 16, in E-commerce transaction 1600 no consumer financial card information is provided to merchants, making the consumer's financial card information more secure. In addition, the consumer's financial card information is verified without using a third party transaction authorization agent, vastly reducing transaction costs to the merchant. Elements of the conventional financial card authorization and verification process described above in relation to FIG. 14 are employed in combination with an IMS storage medium 1428 including, in preferred embodiments, embedded and encrypted financial card information 1430, an encrypted consumer banking identification number 1432, encrypted merchant account information 1434 for one or more merchants, and one or more virtual stores such as virtual store 1436. Like reference numbers in FIGS. 14 and 16 indicate identical or functionally similar elements.

In one embodiment, a bank may issue the IMS financial card to preferred bank customers, for example in a targeted mailing campaign. The receipt of the IMS storage medium by the bank's customers would be similar to a bank customer receiving a new ATM or credit card from their bank in the mail. In other preferred embodiments, the bank may require a customer wishing to receive the IMS financial card to pre-register with the bank. Thus, only customers who specifically requested an IMS financial card may receive one. The consumer's financial card information 1430 embedded on the IMS storage medium 1428 may include credit or debit card information (depending, for example, on the credit status of the consumer).

In some embodiments, to provide additional security for the cardholder, the IMS storage medium 1428 may comprise a consumer banking identification number 1432 or other suitable indicia identifying the cardholder and linked to that cardholder's credit/debit account 1406. In some embodiments, the issuing bank 1404 may employ a proprietary plug-in API (not shown) designed and provided to the issuing bank 1404 for the purposes of embedding the consumer banking identification number 1432 on the IMS storage medium 1428 and linking it to the cardholder's credit/debit account 1406. Thus, issuing bank 1404 may provide to selected customers IMS storage medium 1428, which may include embedded and encrypted financial card information 1430 of the selected bank customer to whom the IMS storage medium 1428 is provided, as well as the consumer banking identification number 1432.

As stated above, in preferred embodiments, the IMS storage medium 1428 may include a virtual store 1434 and may further include encrypted merchant account information 1436 of the merchant associated with the virtual store 1434. In one embodiment, the encrypted financial card information 1430, consumer banking identification number 1432, and merchant account information 1436 may have been encrypted and embedded in the IMS storage medium 1428, employing a proprietary plug-in API (not shown).

The consumer may use the IMS storage medium 1428 to obtain products or services in an E-commerce transaction. In one preferred embodiment, when the consumer desires to engage in an E-commerce transaction, the IMS storage medium 1428 may be inserted into host device 1410 and activated and accessed by the host device 1410, as represented by arrow 1431. In one embodiment, when the IMS storage medium 1428 is activated and accessed by the host device 1410, the VSMS is loaded into a memory device of the host device 1410, for example RAM memory, as described above. In addition, in one embodiment, the consumer's financial card information 1430, consumer banking identification number 1432, and merchant account information 1436 embedded on the IMS storage medium 1428 may be automatically entered into a memory device of the host device 1410, for example RAM memory, transparently to the consumer. Or, based on a determination by port security of the host device 1410, the financial card information 1424 may be relegated to first in first out (“FIFO”) access so that the port conveying the secure data is only opened for a short period of time (for example a few seconds). Once the consumer has finished, the memory of the host device 1410 (for example, RAM memory) may be flushed or overwritten so as to leave no trace of the consumer's financial data or transaction. The operating system of the host device 1410 may also be precluded from placing any of the data into system cache.

In some embodiments, the consumer desiring to engage in an E-commerce transaction employing the IMS storage medium 1428 may be required to contact the issuing bank 1404 in order to confirm that they are the person authorized to use the financial card information 1430 embedded on the IMS storage medium 1428 before engaging in the E-commerce transaction. This confirmation process may include providing identity verification information such as, but not limited to, one or more passwords and/or PINs that have been pre-registered with the issuing bank 1404.

In some embodiments, the consumer may confirm the one or more pre-registered passwords and/or PINs to the issuing bank 1404 by entering them, for example, in a form displayed by the IMS to the consumer on host device 1410 for that purpose. A connection, represented by double arrow 1433, may then be established between the VSMS running on the host device 1410 and the eX-Mother Server 1426. The one or more passwords and/or PINs may then be sent from the host device 1410 to the eX-Mother Server 1426. The eX-Mother Server 1426 may then establish a connection with the issuing bank 1404, as represented by double arrow 1439, and provide the one or more passwords and/or PINs to the issuing bank 1404, for example, via a proprietary plug-in API (not shown) provided to the issuing bank 1404. These connections may be, for example, via telephone modem, cable modem, DSL, a wireless interface, or other suitable communication medium. In some embodiments, the information may be decrypted by the eX-Mother Server 1426 before being sent to the issuing bank 1404. A secure protocol, such as, but not limited to, Fortress Technologies' Secure Packet Shield (“SPS™”), may then be used to send the decrypted information to the issuing bank 1404.

In other embodiments, the consumer desiring to engage in an E-commerce transaction employing the IMS storage medium 1428 may be required to call the issuing bank 1404 by telephone in order to confirm that they are the person authorized to use the financial card information 1430 embedded on the IMS storage medium 1428 by providing one or more pre-registered passwords and/or PINs. The issuing bank 1404 may then notify the eX-Mother Server 1426 if the consumer has been authorized.

Thus, in some embodiments, the bank customer may be required to register or activate the received IMS financial card in a manner similar to the activation of a new ATM or other financial card received by mail. As stated above, the registration process may, in some preferred embodiments, involve the designation by the bank customer of the one or more passwords or PINs. In some preferred embodiments, the bank customer's existing PIN (for example, an existing ATM card PIN) may be used in combination with one or more pre-registered passwords and/or additional registered PINs for verification purposes.

By providing the one or more correct passwords and/or PINs to the issuing bank 1404, the consumer desiring to use the IMS storage medium 1428 may be authorized to continue with the desired E-commerce transaction. The authorization may be sent from the issuing bank 1404 to the eX-Mother Server 1426 via the established connection 1439. The eX-Mother Server 1426 may in turn notify the consumer that an authorization has been received and the E-commerce transaction may continue.

Thus, embodiments of the present invention enable the eX-Mother Server 1426 to act as a transaction authorization agent. Also, a more secure authorization process is possible whereby the person desiring to use the financial card information 1430 in an E-commerce transaction is more accurately determined to be the person authorized by the issuing bank 1404 to do so. Thus, unlike conventional verification systems, embodiments of the present invention more accurately verify that the transaction is authorized and that the financial card information is genuine.

In preferred embodiments of the present invention, the VSMS may run an Interactive Media Site that enables an authorized consumer to engage in an off-line E-commerce transaction with one or more virtual stores, such as virtual store 1434 on the IMS storage medium 1428, as previously described above. Thus, the consumer does not need to be connected to the Internet to engage in E-commerce transactions.

Instead, the consumer may shop and buy products and/or services from the merchants' virtual store 1434. The merchant or merchants represented on the IMS storage medium may have contracted with the bank to provide the virtual stores on the IMS storage medium in a business relationship similar to the present practice of including the merchants' promotional fliers within the customers' monthly bank statements. As a result of this business relationship, the bank may advantageously generate additional revenue from financial card sales. Similarly, the merchant may advantageously promote its products and/or services to new customers. In some embodiments, the virtual store 1434 may be accessible to the consumer from the IMS storage medium 1428 for a predetermined time period, for example, for one week, for the duration of a sales promotion, or other suitable time interval. After the designated time period has passed, the virtual store 1434 may become inaccessible to the consumer.

Purchases made at the virtual store 1434 may be processed by the VSMS without the necessity of being on-line in order to view content and make product or service selections and register purchases. Orders placed by the consumer and generated by the VSMS may then be sent, for example via telephone modem, cable modem, DSL, a wireless interface, or other suitable communication medium, to the dedicated eX-Mother Server 1426. These orders may include an E-commerce transaction amount to be verified, the consumer's financial card information 1430, the consumer banking identification number 1432, and the merchant account information 1436 for the merchant involved in the transaction. In other embodiments, the consumer banking identification number 1432 may not be embedded on the IMS storage medium 1428, but instead may be generated by the eX-Mother Server 1426 after receiving the consumer's financial card information 1430. The eX-Mother Server 1426 may then communicate the consumer banking identification number 1432 to the issuing bank 1404 so that the issuing bank 1404 may associate the two numbers.

In preferred embodiments of the present invention, no financial card information 1430 is provided to the merchant website 1412. Instead, the eX-Mother Server 1426 may send financial card information 1430, along with a transaction amount and merchant account information 1434, directly to clearing bank 1416, as represented by arrow 1441. Clearing bank 1416, merchant bank 1438, and issuing bank 1404 may then proceed with fund availability verification, funds transfer and settlement procedures, as described above in relation to FIG. 14. Clearing bank 1416 may use the merchant account information 1436 to identify the merchant. In some embodiments, the clearing bank may also employ a proprietary plug-in API (not shown) that communicates with the eX-Mother Server 1426 and receives and decrypts data sent from the eX-Mother Server 1426. The proprietary plug-in API may be licensed to the clearing bank or may be provided at no charge.

Once the consumer's funds are verified by clearing bank 1416, the clearing bank 1416 may notify the eX-Mother Server 1426 of the results of the verification process, as represented by arrow 1443. The eX-Mother Server 1426 may then notify the consumer about whether or not the E-commerce transaction has been approved, based on the verification results. If the E-commerce transaction has been approved, the eX-Mother Server 1426 may contact the merchant involved in the transaction to notify the merchant of that fact. The eX-Mother Server 1426 may also provide to the merchant at that time, or at a later time, an electronic purchasing order identifying the purchased products and/or services, along with the consumer banking identification number 1432 identifying the customer involved in the E-commerce transaction.

In one embodiment, the consumer banking identification number 1432 may have been pre-registered with the merchant after the financial card information 1430, merchant account information 1436 and merchant's virtual store 1434 were embedded on the IMS storage medium 1428. The merchant may receive at the same time that consumer's name and address so that the merchant may link them to the consumer banking identification number 1432. Thus, the consumer banking identification number 1432 enables the merchant to identify the consumer, create an invoice for the transaction and ship the product or provide the service to the consumer even though the merchant has received no financial card information from the consumer.

In preferred embodiments, the eX-Mother Server 1426 contacts the merchant by establishing a connection to the merchant website 1412 via the Internet 1408, as represented by double arrows 1445 and 1447. This connection may be, for example, via telephone modem, cable modem, DSL, a wireless interface, or other suitable communication medium. In other embodiments, the electronic purchasing order and consumer banking identification number 1432 may be sent to a merchant server over another network. Additionally, other embodiments may employ other means for providing this information to the merchant. For example, the information may be sent via e-mail or even printed out and sent to the merchant via a postal mail service or faxed to the merchant directly.

Thus, embodiments of the present invention described above provide an E-commerce transaction in which no consumer financial card information is provided to a merchant, making the consumer's financial card information more secure. In addition, the consumer's financial card information is verified without using a third party transaction authorization agent, vastly reducing transaction costs to the merchant.

In alternative embodiments of the present invention, the authorization and verification process described above may be bypassed. Thus, the consumer may not be required to provide any passwords or PINs in order to verify that the consumer is authorized to use the financial card information 1430 before engaging in an E-commerce transaction. Thus, when the consumer desires to engage in an E-commerce transaction, the transaction will proceed as described above in relation to FIG. 16 but without the necessity of verifying any passwords or PINs with the issuing bank 1404. The fact that the IMS storage medium 1428 is being used by someone to engage in an E-commerce transaction may be sufficient to allow the E-commerce transaction to be authorized. This embodiment may be preferable to some consumers that find it cumbersome to provide passwords and/or PINs. This embodiment still advantageously avoids providing the merchant with the consumer's financial card information 1430, as described above in relation to FIG. 16.

In other embodiments of the present invention, in addition to the one or more virtual stores on the IMS storage medium 1428 (such as virtual store 1434), the IMS storage medium 1428 may further include one or more links to one or more on-line websites of the merchants having virtual stores on the IMS storage medium 1428. Thus, the consumer may shop for products and/or services on-line from the one or more merchants' websites by selecting such a link. By selecting a particular link, the consumer may be connected to a merchant website via, for example, the Internet 1408. The consumer may then select products or services from the merchants' websites. In one embodiment, once the products or services have been selected by the consumer, the ordering process may be transferred back to the eX-Mother Server to avoid providing the IMS financial card information 1430 to the merchant involved in the E-commerce transaction.

However, in other embodiments of the present invention, even if a link to a merchant's website is included on the IMS storage medium 1428 to enable the consumer to visit that merchant's website, all shopping and ordering functions of the E-commerce transaction may nevertheless be performed only off-line within the merchant's virtual store or catalog located on the IMS storage medium 1428. According to this embodiment, a pre-existing customer of the issuing bank may receive (for example, by mail) an IMS on a storage medium (for example, a CD) with the customer's credit information already embedded on the storage media. The customer's credit information may include a “pre-set” credit/debit card and may also include pre-set merchant account data and a merchant's virtual store. The merchant may be have an affiliation with the issuing bank. Thus, receiving the IMS storage medium the customer receives is similar to receiving a merchant's promotional literature along with an ATM or credit card received from an existing bank. The customer may use the IMS storage media by simply placing the storage media in a computer. The use may be a one-time use or use for a predetermined period of time, according to some embodiments.

The IMS may utilize the eX-Mother Server to act as an Internet financial transaction gateway between the merchant, the clearing bank and the acquiring bank. The eX-Mother Server may receive all orders from the IMS as eX-Virtual Server technology sends the customer's embedded credit information, the order amount to be verified, the customer's banking identification and the merchant's banking identification to the clearing bank. The merchant never receives the customer's credit information. The clearing bank verifies fund availability and notifies the eX-Mother Server of approval or disapproval. The merchant is notified that funds have been approved for a particular customer identification number and for a particular purchase order. The merchant then ships the customer's purchase.

In some preferred embodiments, the merchant website's servers may be running proprietary plug-in APIs that communicate with the eX-Mother Server, identify the merchant (for example by an encrypted merchant identification number), and store in a database consumer's orders and corresponding encrypted consumer identification numbers. The proprietary plug-in APIs may also decrypt the consumer identification numbers. The proprietary plug-in APIs may be provided to the merchant for a fee or at no cost.

In preferred embodiments of the present invention, whether the selection and ordering of products or services is made off-line or on-line, the financial card information 1430 of the consumer is not provided to the merchant. Thus, preferred embodiments of the present invention provide a more secure method of engaging in E-commerce transactions.

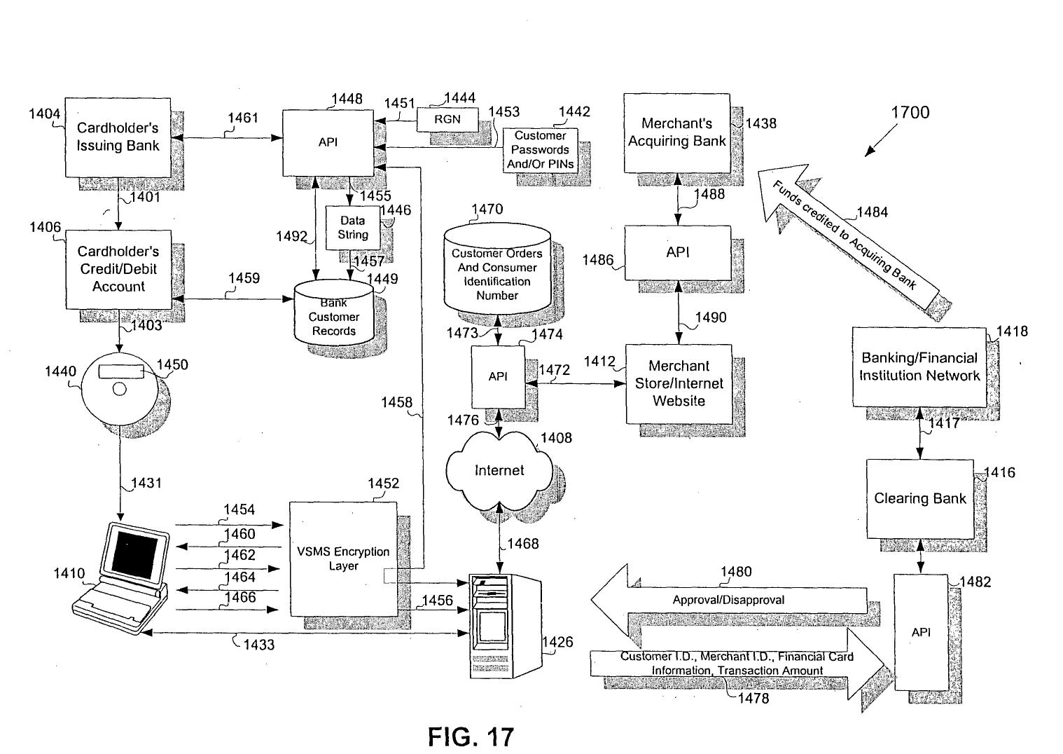

According to a further preferred embodiment of the present invention, illustrated in FIG. 17, in E-commerce transaction 1700, no consumer financial card information is provided to a merchant, similarly to E-commerce transaction 1600 described above. Furthermore, the consumer's financial card information is verified without using a third party transaction authorization agent, as in E-commerce transaction 1600. In addition to these advantages, in embodiments of the invention illustrated by E-commerce transaction 1700, the consumer may shop with enhanced security on a merchant's Internet website using the IMS storage medium regardless of whether or not the merchant has a virtual store on the IMS storage medium.

Enhanced security is provided for shopping on a merchant's Internet website by providing a cardholder identity authorization and verification system that includes an encrypted data string on the IMS storage medium that may be used, in preferred embodiments, in combination with modular re-constructive re-sequencing identity validation algorithms to more accurately verify and authorize the use of the financial card information. Elements of the conventional financial card authorization and verification process described above in relation to FIG. 14 are employed in combination with an IMS storage medium 1440 including, in preferred embodiments, an encrypted data string 1450. Like reference numbers in FIGS. 14 and 17 indicate identical or functionally similar elements.

In preferred embodiments of the present invention, the bank customer wishing to receive the IMS storage medium 1440 from the issuing bank 1404 may pre-register with the issuing bank 1404 and provide to the issuing bank 1404 identity verification information such as, but not limited to, one or more passwords and/or PINs 1442. In embodiments of the present invention described below, two passwords are used to confirm the identity of the bank customer. However, other embodiments may use any number of passwords and/or PINs. In addition, in further embodiments, a bank customer may provide to the issuing bank 1404 machine information, for example an IP address of a host device 1410, to identify a particular host device that may be used to access the IMS storage medium 1440. The issuing bank 1404 may create a randomly generated number (“RGN”) to be associated with and identify the bank customer.

The issuing bank 1404 may then combine the RGN 1444 and all of the passwords, PINs, and/or machine identification, into a first data string 1446, as represented by arrow 1455. First data string 1446 may then be encrypted and stored, for example, in a bank customer records database 1449 associated with a proprietary plug-in API 1448, as represented by double arrow 1457. The proprietary plug-in API 1448 may function as an interface between VSMS encryption layer 1452 and the issuing bank 1404, as represented by double arrow Proprietary plug-in API 1448 First data string 1446 may then be associated with the bank customer's cardholder credit/debit account 1406, as represented by arrow 1459. In some embodiments, the randomly generated number 1444 and passwords, PINs, and or machine identification may be combined as first data string 1446 using a proprietary plug-in API 1448 provided to the bank, as represented by arrows 1451 and 1453, respectively.

In one embodiment, one of the bank customer's passwords or PINs may be combined with RGN 1444 in a second data string 1450 that may be encrypted and embedded on IMS storage medium 1440. The embedded and encrypted second data string 1450 may, in some embodiments, be encrypted and embedded in the IMS storage medium 1440 by the proprietary plug-in API 1448.

In preferred embodiments of the present invention, the IMS storage medium 1440 contains only the second data string 1450. The bank customer's financial card information may not be present on the IMS storage medium 1440. However, the bank customer's financial card information may be derived from the second data string 1450 after an interactive cardholder interactive authorization and verification sequence (“IAVS”) described below.

The bank customer may receive the IMS storage medium 1440 from the issuing bank 1404, for example by mail, as represented by arrow 1403. The consumer may use the IMS storage medium 1440 to obtain products and/or services in an on-line E-commerce transaction. In one preferred embodiment, when the consumer desires to engage in an on-line E-commerce transaction, the IMS storage medium 1440 may be inserted into host device 1410 and activated and accessed by the host device 1410, as represented by arrow 1431. In one embodiment, when the IMS storage medium 1440 is activated and accessed by the host device 1410, the VSMS is loaded into a memory device of the host device 1410, for example RAM memory, as described above. In addition, in one embodiment, the second data string 1450 is automatically entered into a memory device of the host device 1410, for example RAM memory, transparently to the consumer. Or, based on a determination by port security of the host device 1410, the financial card information 1424 may be relegated to first in first out (“FIFO”) access so that the port conveying the secure data is only opened for a short period of time (for example a few seconds). Once the consumer has finished, the memory of the host device 1410 (for example, RAM memory) may be flushed or overwritten so as to leave no trace of the consumer's financial data or transaction. The operating system of the host device 1410 may also be precluded from placing any of the data into system cache.

In preferred embodiments, after the IMS storage medium 1440 is activated and accessed by the host device 1410, and after the VSMS and second data string 1450 are loaded into memory, the VSMS may establish a connection, represented by double arrow 1433, between the VSMS running on the host device 1410 and the eX-Mother Server 1426. The VSMS may then initiate a cardholder IAVS to verify that the person using the IMS storage medium 1440 is the person authorized to do so. In one embodiment, the cardholder IAVS may have to be successfully executed prior to allowing the bank customer to access and shop any on-line merchant websites.

The VSMS may include software for providing one or more encryption layers. Thus, the VSMS may include encryption layer 1452, which may reside in the memory of host device 1410 after the VSMS is loaded from the IMS storage medium 1440. In one embodiment, VSMS encryption layer 1452 allows the bank customer to securely provide identity verification information to the issuing bank 1404. Furthermore, encryption layer 1452 allows for secure retrieval of the bank customer's financial card information from the issuing bank 1404 once such retrieval is authorized.

VSMS encryption layer 1452 employs deconstruction/reconstruction algorithms for disassembling and reassembling the password, PIN, machine identification, and other identity verification information that may be entered by the bank customer in response to queries received from the issuing bank 1404. In addition, sequencing and re-sequencing techniques may be used to continuously and unpredictably alter the sequence in which identity verification information is received from the bank customer and/or the host device 1410. In one embodiment, encryption keys for sequencing, re-sequencing, encrypting, decrypting, disassembling and reassembling identity verification information may reside in the VSMS encryption layer 1452, the eX-Mother Server 1426 and in a proprietary plug-in API 1448 provided to the issuing bank 1404.

The cardholder IAVS may begin, in some embodiments, by the IMS browser displaying to the bank customer a text entry window with a request that the bank customer enter a password or PIN. The bank customer may then enter the password, as represented by arrow 1454. In one embodiment, VSMS encryption layer 1452 may decrypt and disassemble the embedded and encrypted second data string 1450 residing in memory of host device 1410 and isolate a fragment of second data string 1450 corresponding to the password and/or PIN for comparison with the entered password or PIN. If there is a match, the VSMS encryption layer 1452 may then isolate the RGN 1444 fragment of second data string 1450 and store RGN 1444 for later use as a customer identification number. If there is no match, the cardholder IAVS may be discontinued.

Furthermore, if there is a match, a first level of the cardholder IAVS has been successful. Therefore, the VSMS encryption layer 1452 may next reassemble and re-encrypt second data string 1450 and send it, along with an authorization request, to eX-Mother Server 1426, as represented by arrow 1456, via a secure protocol, such as, but not limited to, SPS™. The eX-Mother Server 1426 may then decrypt and disassemble the encrypted second data string 1450 and isolate the RGN 1444 fragment of second data string 1450. The eX-Mother Server 1426 may then establish a connection with the issuing bank 1404 via the VSMS encryption layer 1452 and proprietary plug-in API 1448, as represented by double arrow 1458, using a secure protocol, such as, but not limited to, SPS™. This connection may be, for example, via telephone modem, cable modem, DSL, a wireless interface, or other suitable communication medium.

The eX-Mother Server 1426 may then query the issuing bank 1404 for the cardholder credit/debit account 1406 associated with RGN 1444. In one embodiment, the issuing bank 1404 may then access the bank customer records database 1449, as represented by arrow 1492, and decrypt and disassemble the encrypted first data string 1446, using the encryption key provided in proprietary plug-in API 1448. The issuing bank 1404 may then isolate the RGN 1444 fragment of first data string 1446. The issuing bank 1404 may then access the cardholder credit/debit account 1406 associated with RGN 1444.

In one embodiment, the issuing bank 1404 may isolate the second password fragment of first data string 1446, using an encryption key provided in proprietary plug-in API 1448, and may then initiate a query/response sequence with the bank customer via eX-Mother Server 1426 and VSMS encryption layer 1452. Thus, in one embodiment, issuing bank 1404 may control the remainder of the cardholder IAVS. Thus, issuing bank 1404 may send a request, represented by arrow 1460, to the bank customer, for example in the form of a text entry window, to enter a second password or PIN.

The bank customer may then enter his second password or PIN into the text entry window and send it to issuing bank 1404 via the VSMS encryption layer 1452 and eX-Mother Server 1426, as represented by arrow 1462. The issuing bank 1404 may then compare the second password with the second password fragment of first data string 1446. If there is a match, the issuing bank 1404 may continue to query in this manner for as many additional passwords and/or PINs as may be contained in first data string 1446. If there is no match, the cardholder IAVS may be discontinued.

In embodiments where first data string 1446 contains a machine identification, such as, but not limited to, an IP address of host device 1410, the issuing bank 1404 may also access the host device 1410 for a machine identification, as represented by arrow 1464. Thus, the machine identification of host device 1410 may be provided to issuing bank 1404, transparently to the bank customer, as represented by arrow 1466.

In some embodiments, in order to provide for secure transmission of the identification information, each of the one or more passwords and/or PINs, as well as the machine identification, may be disassembled by the VSMS encryption layer 1452 and each sent separately as one or more data packets in a sequence and at intervals controlled by VSMS encryption layer 1452. In one embodiment, the issuing bank 1404 may receive the one or more packets representing, for example, a password, PIN, or machine identification, and, using its encryption key, re-sequence and reassemble the identification information.

In one embodiment, if all the identification information provided by the bank customer and host device 1410 to the issuing bank 1404, via VSMS encryption layer 1452 and eX-Mother Server 1426, matches the corresponding identification information in first data string 1446, the issuing bank 1404 may notify the eX-Mother Server 1426 that the person using the IMS storage medium 1440 is the person authorized to do so. The issuing bank 1404 may also send to the eX-Mother Server 1426, via VSMS encryption layer 1452, the bank customer's financial card information. In some embodiments, the financial card information may include not only the actual financial card number, but also the authorized consumer's credit/debit card account 1406 information, such as, but not limited to, account balances and credit limit. The financial card information may be disassembled by the proprietary plug-in API 1448 and sent as one or more data packets in a sequence and at intervals controlled by proprietary plug-in API 1448.

The eX-Mother Server 1426 may then notify the bank customer, via the VSMS that Internet shopping has been authorized. In addition, in some embodiments, the eX-Mother Server 1426 may notify merchant website 1412 that the bank customer's identity has been verified. In one embodiment, the notification may include a consumer identification number for the approved bank customer. However, no financial card information for the bank customer would be provided to the merchant.

At that point the VSMS may establish a connection, via eX-Mother Server 1426, with the Internet 1408, as represented by double arrow 1468. The bank customer may then access merchant website 1412, as represented by double arrow 1472. In one embodiment, merchant website 1412 may be accessed via a proprietary plug-in API 1474 provided to merchant website 1412, as represented by double arrow 1476.

When the bank customer makes a purchase, the ordering process may be controlled by the eX-Mother Server 1426. Thus, after the consumer orders a product or service, the eX-Mother Server 1426 may send a customer identification number to proprietary plug-in API 1474. Proprietary plug-in API 1474 may link the customer identification number to the bank customer's order and store both in database 1470, which may be associated with proprietary plug-in API 1474.

The eX-Mother Server 1426 may, in turn, receive a merchant identification number from proprietary plug-in API 1474. The eX-Mother Server 1426 may then send the merchant identification number, customer identification number, financial card information and amount of transaction to clearing bank 1416, via proprietary plug-in API 1482, as represented by arrow 1478. Proprietary plug-in API 1482 may be provided to clearing bank 1416 for a fee or at no cost.

The financial card information may remain disassembled and encrypted after receipt by eX-Mother Server 1426 from proprietary plug-in API 1448. The eX-Mother Server 1426 may thus send the disassembled and encrypted financial card information to proprietary plug-in API 1482 as one or more data packets in a sequence and at intervals controlled by eX-Mother Server 1426. In one embodiment, proprietary plug-in API 1482 may receive the one or more packets and, using its encryption key, re-sequence and reassemble the financial card information. Thus, the financial card information may be read by clearing bank 1416 for verification of the bank customer's funds.

Once the consumer's funds are verified by clearing bank 1416, the clearing bank 1416 may notify the merchant bank 1438 that the consumer's funds are verified and credit funds to the merchant bank 1438, as represented by arrow 1484. The merchant bank 1438 may, in turn, send, via proprietary plug-in API 1486, a payment verification notice to merchant website 1412, as represented by arrows 1488 and 1490. The settlement process may then proceed as described above in relation to earlier embodiments of the present invention.

In one embodiment, the eX-Mother Server 1426 may notify the consumer that payment has been verified. In addition, the eX-Mother Server 1426 may display to the consumer the current balance of the consumer's credit/debit card account 1406 after the consumer's last order.

In some embodiments of the present invention, the functions of the clearing bank, the merchant bank and the issuing bank may be combined into one consolidated banking entity. Thus, for example, when the eX-Mother Server 1426 sends the merchant identification number, customer identification number, financial card information and amount of transaction to the consolidated banking entity, all clearing functions, credit/debit functions, funds transfer orders, and settlement procedures may be performed by the consolidated banking entity without the necessity of passing information between a separate clearing bank, merchant bank and issuing bank. The consolidated banking entity may be provided with a proprietary plug-in API to interface with the eX-Mother Server 1426 and/or the VSMS.

Thus, preferred embodiments of the present invention provide no financial card information to the merchant and the consumer's financial card information is verified without using a third party transaction authorization agent. In addition, in E-commerce transaction 1700, the consumer may shop on a merchant's Internet website using the IMS storage medium regardless of whether or not the merchant has a virtual store on the IMS storage medium. In some embodiments, the IMS storage medium 1440 may further include one or more virtual stores, which have the functionality described above. However, the cardholder IAVS described above enables the bank customer to securely shop on-line at merchants' websites.

Although particular embodiments of the cardholder IAVS are described above, persons skilled in the art will recognize that the cardholder IAVS may be implemented in a variety of ways.

For example, in one alternative embodiment, after a password or PIN is verified, the issuing bank 1404 may send the first data string 1446 to the eX-Mother Server 1426 via proprietary plug-in API 1488 and VSMS encryption layer 1452. Issuing bank 1404 may first disassemble and encrypt first data string 1446 and send it as one or more data packets in a sequence and at intervals controlled by proprietary plug-in API 1488. The eX-Mother Server 1426 may then reassemble and decrypt the first data string 1446 and control the query/response sequence.

Furthermore, in some embodiments, the host device 1410 may connect directly to issuing bank 1404 via VSMS encryption layer 1452 and proprietary plug-in API 1448. The issuing bank 1404 may then control the query/response sequence via proprietary plug-in API 1488.

In addition, although modular re-constructive re-sequencing identity validation algorithms are used in the encryption technique in embodiments of the present invention described above, any suitable encryption algorithms may be used, including, but not limited to, Data Encryption Standard (“DES”), 3DES, and International Data Encryption Algorithm (“IDEA”).

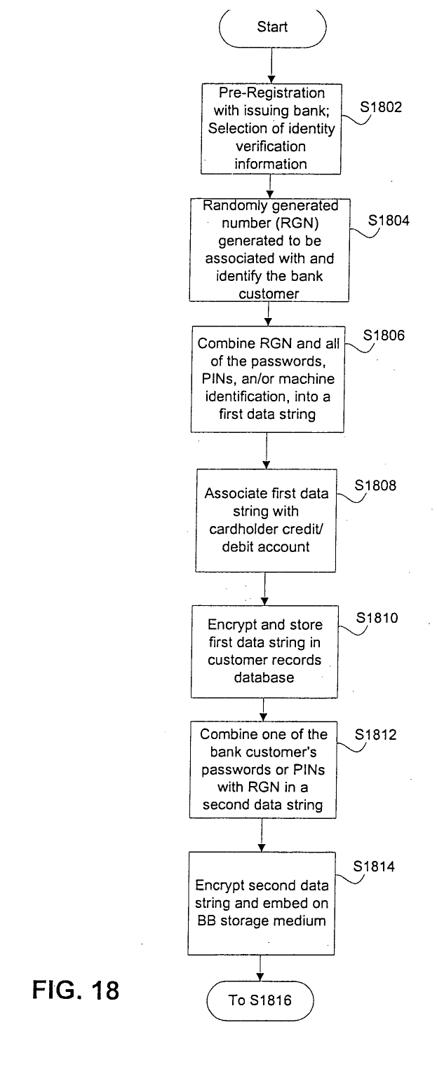

FIGS. 18, 19, 20, 21 and 22 show a flow diagram of an embodiment of the present invention illustrated in FIG. 17. First, the bank customer may pre-register with the issuing bank and may select identity verification information, as shown at S1802. A randomly generated number may be generated by the issuing bank and associated with the bank customer, as shown at S1804. The RGN and all of the passwords, PINs, an/or machine identification may be combined into a first data string, as shown at S1806. The first data string may then be associated with a cardholder credit/debit account belonging to the bank customer, as shown at S1808. The first data string may be encrypted and stored in a customer records database, as shown at S1810. The RGN may be combined with one of the bank customer's passwords or PINs in a second data string, as shown at S1812. The second data string may be encrypted and embedded on an IMS storage medium, as shown at S1814.

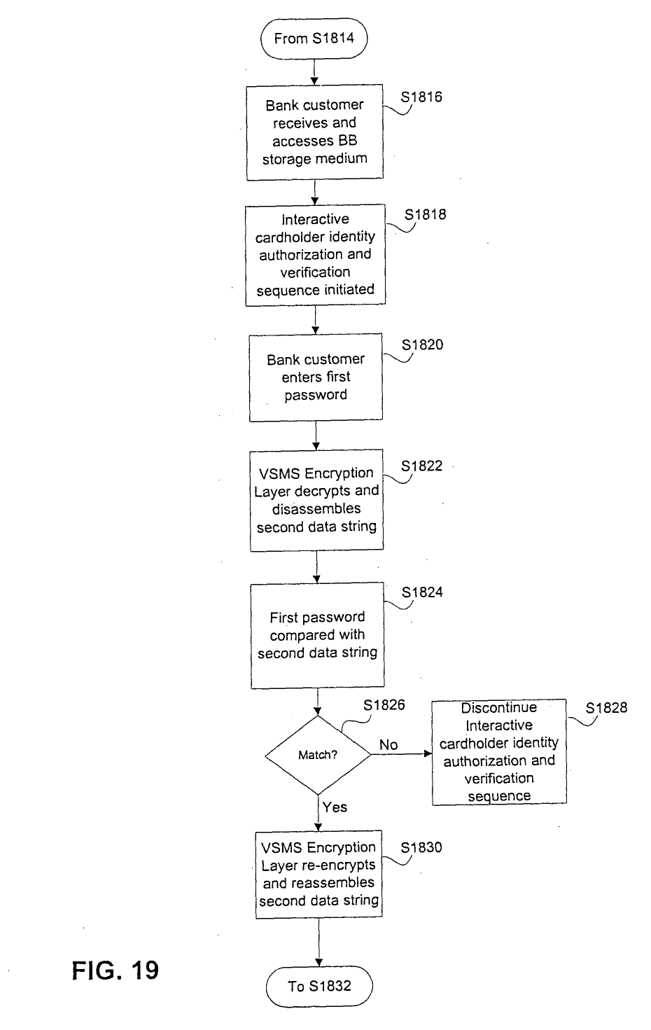

The bank customer may then receive and access the IMS storage medium, as shown at S1816 in FIG. 19. An cardholder IAVS may then be initiated, as shown at S1818. The bank customer may be requested to enter the password, as shown at S1820. The VSMS Encryption Layer may decrypt and disassemble the second data string, as shown at S1822. The password may be compared with the password in the second data string, as shown at S1824. If there is not a match at S1826, then cardholder IAVS may be discontinued, as shown at S1828. If there is a match at S1826, The VSMS Encryption Layer may re-encrypt and reassemble second data string, as shown at S1830.

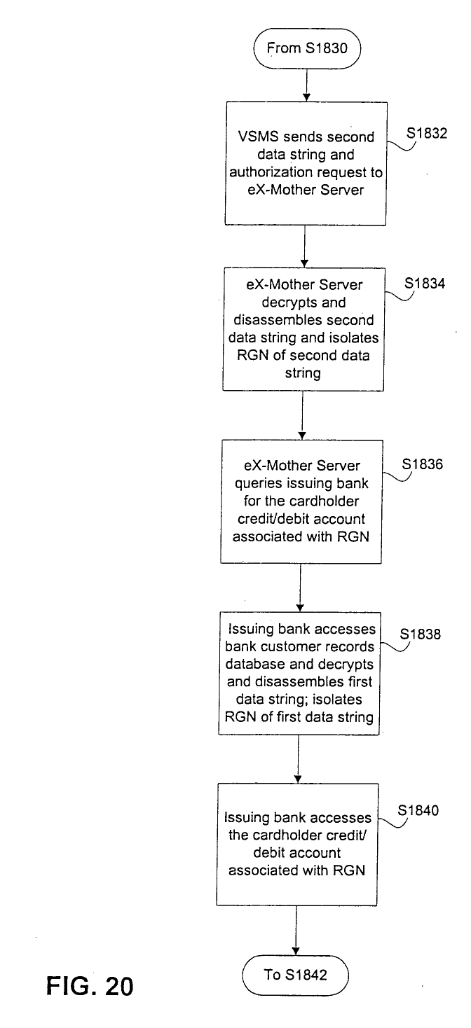

The VSMS may then send the second data string and an authorization request to the eX-Mother Server, as shown at S1832 in FIG. 20. The eX-Mother Server may decrypt and disassemble the second data string and isolate the RGN of the second data string, as shown at S1834. The eX-Mother Server may then query the issuing bank for the cardholder credit/debit account associated with the RGN, as shown at S1836. The Issuing bank may then access the bank customer records database and may decrypt and disassemble the first data string and may isolate the RGN of the first data string, as shown at S1838. The issuing bank may then access the cardholder credit/debit account associated with the RGN, as shown at S1840.

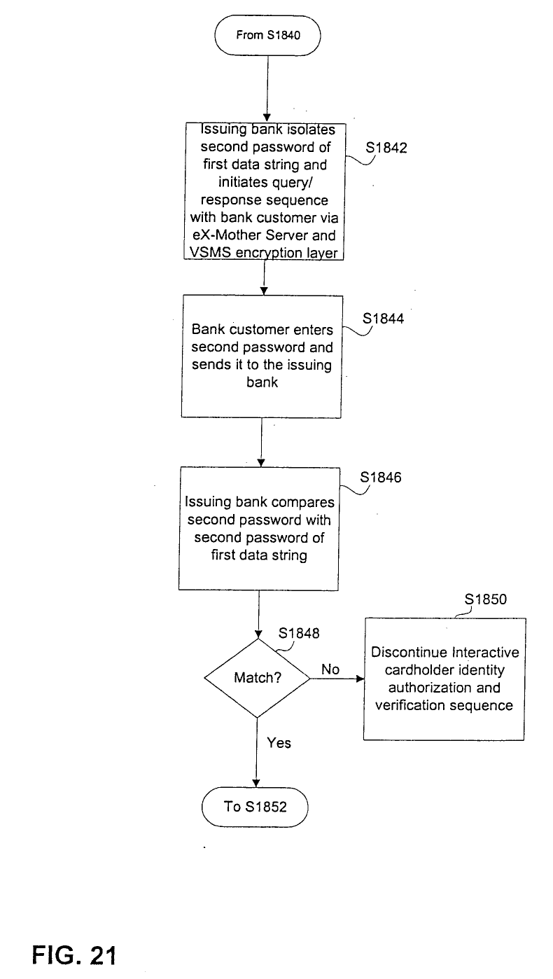

The issuing bank may then isolate the second password of the first data string and initiate a query/response sequence with the bank customer via eX-Mother Server and VSMS encryption layer, as shown at S1842 in FIG. 21. The bank customer may then enter the second password and send it to the issuing bank, as shown at S1844. The issuing bank may compare the second password with the second password of first data string, as shown at S1846. If there is not a match at S1848, then cardholder IAVS may be discontinued, as shown at S1850.

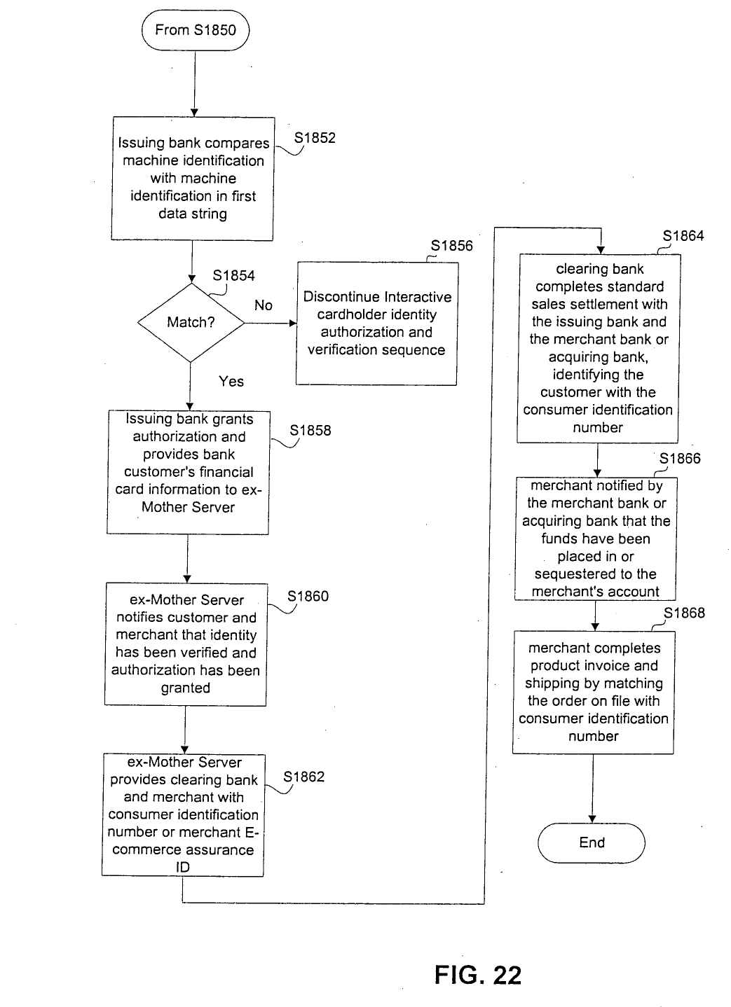

If there is a match at S1848, the issuing bank may compare a machine identification of the host device with the machine identification in the first data string, as shown at S1852 in FIG. 22. If there is not a match at S1854, then cardholder IAVS may be discontinued, as shown at S1856. If there is a match at S1854, the issuing bank may grant authorization and provide the bank customer's financial card information to the ex-Mother Server, as shown at S1858. The ex-Mother Server may then notify the customer and the merchant that identity has been verified and authorization has been granted, as shown at S1860. The ex-Mother Server may then provide to the merchant and the clearing bank a consumer identification number corresponding to the authorized customer or a merchant E-commerce assurance identification, as shown at S1862.

At S1864, the clearing bank may complete a standard sales settlement with the issuing bank and the merchant bank or acquiring bank, identifying the customer with the consumer identification number. At S1866, the merchant may be notified by the merchant bank or acquiring bank that the funds have been placed in or sequestered to the merchant's account (i.e., payment verification is received by the merchant at the merchant's website's plug-in API). At S1868, the merchant may complete the product invoice and shipping by matching the order on file with consumer identification number.

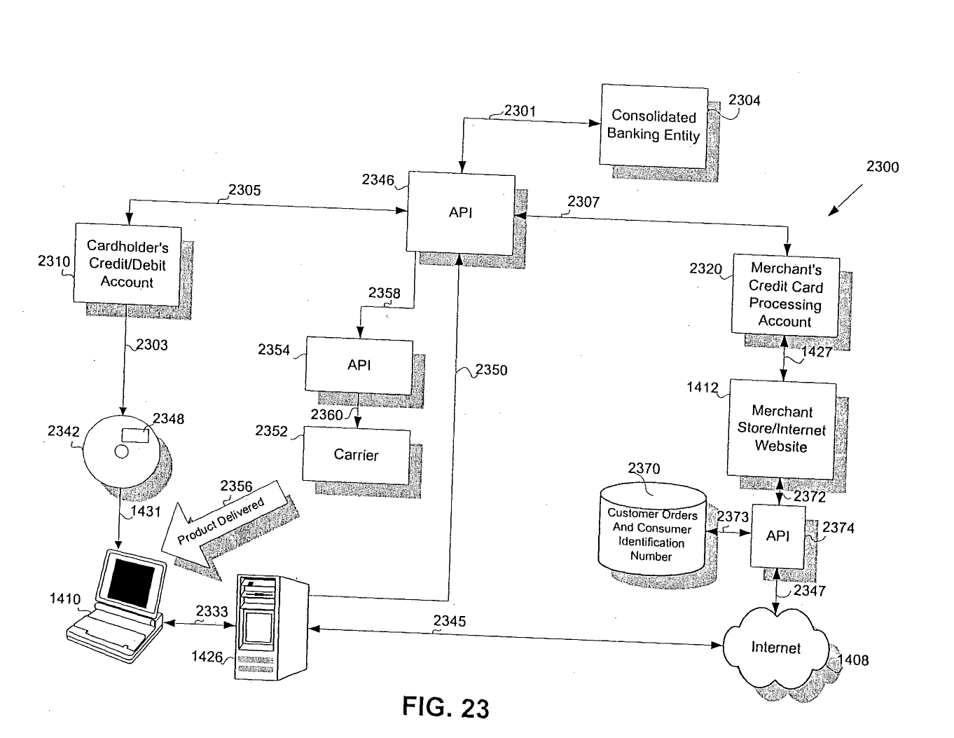

According to a further preferred embodiment of the present invention, illustrated in FIG. 23, in E-commerce transaction 2300, no consumer financial card information is provided to a merchant, similarly to E-commerce transactions 1600 and 1700 described above. Furthermore, in E-commerce transaction 2300 the consumer's financial card information is verified without using a third party transaction authorization agent, as in E-commerce transactions 1600 and 1700. Also, in E-commerce transaction 2300 the consumer may shop on a merchant's Internet website using the IMS storage medium regardless of whether or not the merchant has a virtual store on the IMS storage medium, as in E-commerce transaction 1700. In addition to these advantages, embodiments of the invention illustrated by E-commerce transaction 2300 provide enhanced privacy for the consumer.

Enhanced privacy is provided for shopping on a merchant's Internet website by providing only a customer identification number to a merchant during an E-commerce transaction. No additional consumer information is provided to the merchant. Instead, additional consumer information required for shipping a product to the consumer is provided only to a carrier such as, but not limited to, Federal Express, United Parcel Service, and the U.S. Postal Service. Like reference numbers in FIGS. 14 and 23 indicate identical or functionally similar elements.

In preferred embodiments of the present invention, the bank customer may receive IMS storage medium 2340 from consolidated bank 2342, for example by mail, as represented by arrow 2303. Consolidated bank 2342 combines the functions of a clearing bank, an issuing bank and a merchant bank, as described above. Thus, consolidated bank 2342 maintains a credit or debit account 2310 for the consumer, depending on the type of financial card that may be issued to the consumer, as represented by double arrows 2301 and 2305. Consolidated bank 2342 also may hold the merchant's financial card processing account 2320, as represented by double arrows 2301 and 2307. Consolidated bank 2342 may further perform clearing functions, as described above.

In some embodiments, the consolidated bank 2342 may employ a proprietary plug-in API 2346 designed and provided to the consolidated bank 2342 that may be used to embed an encrypted customer identification number on the IMS storage medium 2342 and link it to the cardholder's credit/debit account 2310. In one embodiment, customer identification number 2348 is embedded on IMS storage medium 2342.

The consumer may then use the IMS storage medium 2342 to obtain products or services in an E-commerce transaction. When the consumer desires to engage in an E-commerce transaction, the IMS storage medium 2342 may be inserted into host device 1410 and activated and accessed by the consumer, as represented by arrow 1431. In one embodiment, when the IMS storage medium 2342 is activated and accessed by the host device 1410, the VSMS is loaded into a memory device of the host device 1410, for example RAM memory, as described above. In addition, in one embodiment, the 2348 of the customer identification number 2348 embedded on the IMS storage medium 2342 is automatically entered into a memory device of the host device 1410, for example RAM memory, transparently to the consumer.

A connection, represented by double arrow 2333, may then be established between a VSMS running on the host device 1410 and the eX-Mother Server 1426. This connection may be, for example, via telephone modem, cable modem, DSL, a wireless interface, or other suitable communication medium.

In preferred embodiments, the eX-Mother Server 1426 contacts the merchant by establishing a connection to the merchant website 1412 via the Internet 1408, as represented by double arrows 2345 and 2347. In some embodiments, a proprietary plug-in API 2374 may be used as an interface between eX-Mother Server 1426 and merchant website 1412, as represented by double arrow 2372. The proprietary plug-in API 2374 may be associated with a database 2370 for storing customer orders and customer identification numbers.

The consumer may then search for a desired product or service on the merchant website 1412. In one preferred embodiment, when the consumer purchases a product in an E-commerce transaction on merchant website 1412, the customer identification number 2348 may be provided to merchant website 1412. The merchant website 1412 may then store the consumer's order along with customer identification number 2348 in a database 2370, as represented by double arrow 2373, while awaiting a payment verification from consolidated bank 2342.

The merchant website 1412 may, in turn, provide to eX-Mother Server 1426, via proprietary plug-in API 2374, a merchant identification number. The eX-Mother Server 1426 may then establish a connection with the consolidated bank 2342, as represented by double arrow 2350, and may provide the amount of the transaction, customer identification number 2348, and merchant identification number to consolidated bank 2342. Consolidated bank 2342 may then associate the customer identification number 2348 with the bank customer's cardholder's credit/debit account 2310. Consolidated bank 2342 may then proceed with all clearing functions, credit/debit functions, funds transfer orders, and settlement procedures.

In one embodiment, if the E-commerce transaction is approved, the consolidated bank 2342 may notify the merchant of this fact. No additional consumer information will be provided to the merchant.

The consolidated bank 2342 may also provide to a carrier 2352, via proprietary plug-in API 2346, the customer identification number 2348, customer address information and a merchant identification number, as represented by arrows 2358 and 2360. In some embodiments, the carrier 2352 may receive this information via a proprietary plug-in API 2354 provided to the carrier 2352.

Thus, the carrier 2352 may contact the merchant identified by the merchant identification number and arrange for pick-up of the product for delivery to the consumer's address, as represented by arrow 2356. When the merchant is contacted by the carrier 2352, the merchant may link the customer identification number 2348 provided by the carrier 2352 to the order by accessing the database 2370 where the merchant previously stored the order and customer identification number 2348.

Thus, the embodiment of the present invention illustrated by FIG. 23 provides none of the consumer's private information to the merchant. The merchant is provided with only a customer identification. Thus, the merchant does not receive the consumer's name or address and cannot provide that information to other merchants. Thus, the consumer's privacy is better protected.

The embodiment of the invention illustrated in FIG. 23 may include password protection as described above in earlier embodiments. It may further include a cardholder identity authorization and verification system that includes the customer identification number 2348 in an encrypted data string on the IMS storage medium that may be used, in preferred embodiments, in combination with modular re-constructive re-sequencing identity validation algorithms, as described above in relation to FIG. 17.

Thus, a virtual server consumer authorization, verification and credit update method and article that allows more secure and private off-line and on-line E-commerce transactions has been described. Various embodiments of the present invention may employ one or more of the above-described features.

The foregoing descriptions of exemplary embodiments of the present disclosure have been presented for the purpose of illustration and description. It is not intended to be exhaustive nor to limit the inventive concepts to the embodiments disclosed. Many modifications and variations are possible in light of the above teaching. It is intended that the scope of the invention be limited not within this detailed description, but rather by the claims appended hereto, which appear below.

1. An article of manufacture comprising a computer readable medium on which server emulation software is stored and from which Interactive Media Site (IMS) software can be accessed by a local host device, wherein the computer readable medium comprises:
at least one virtual store from which a consumer may obtain at least one of a product and a service; and
financial card information for providing payment for the at least one of the product and the service obtained by the consumer.

2. The article of manufacture recited in claim 1, wherein the at least one virtual store comprises at least one virtual catalog of products that the consumer may order.

3. The article of manufacture recited in claim 1, wherein the financial card information comprises at least one of an encrypted credit card number and an encrypted debit card number.

4. The article of manufacture recited in claim 1, wherein the financial card information is embedded on the computer readable medium using an application program interface associated with the server emulation software.

5. The article of manufacture recited in claim 1, wherein the financial card information is automatically loaded into a memory device of the host device when the computer readable medium is accessed.

6. The article of manufacture recited in claim 5, wherein the memory device is a random access memory device.

7. The article of manufacture recited in claim 5, wherein the memory device is at least one of flushed and overwritten when the consumer completes a transaction.

8. The article of manufacture recited in claim 1, wherein the financial card information is relegated to first in first out access in the host device when the computer readable medium is accessed such that a port conveying the financial card information is only opened for a short period of time.

9. The article of manufacture recited in claim 1, wherein the financial card information is password protected.

10. The article of manufacture recited in claim 9, wherein the computer readable medium further comprises at least one of a password and a personal identification number for protecting the financial card information.

11. The article of manufacture recited in claim 10, wherein the at least one of a password and a personal identification number is encrypted.

12. The article of manufacture recited in claim 1, wherein the server emulation software includes software for establishing a connection between the host device and at least one Internet website and for enabling the consumer to shop on the Internet website for at least one of a product and a service.

13. The article of manufacture recited in claim 12, wherein the server emulation software includes software for providing the financial card information to the Internet website when the consumer obtains at least one of a product and a service.

14. The article of manufacture recited in claim 13, wherein the host device is connected to the Internet website via a dedicated server including software associated with the server emulation software for receiving the financial card information.

15. The article of manufacture recited in claim 13, wherein the dedicated server includes software for decrypting the financial card information.

16. The article of manufacture recited in claim 14, wherein the Internet website includes an application program interface associated with the server emulation software for communicating with the server emulation software.

17. An article of manufacture comprising a computer readable medium on which server emulation software is stored and from which Interactive Media Site (IMS) software can be accessed by a local host device, wherein the computer readable medium comprises:
at least one virtual store from which a consumer may obtain at least one of a product and a service;
financial card information for providing payment for the at least one of the product and the service obtained by the consumer;
a consumer banking identification number for associating the consumer with a cardholder account; and
merchant account information identifying at least one merchant associated with the at least one virtual store.

18. The article of manufacture recited in claim 17, wherein the financial card information comprises at least one of an encrypted credit card number and an encrypted debit card number.

19. The article of manufacture recited in claim 17, wherein the merchant account information comprises a number associated with a merchant's financial card processing account.

20. The article of manufacture recited in claim 17, wherein at least one of the consumer banking identification number and the merchant identification number are encrypted.

21. The article of manufacture recited in claim 17, wherein at least one of the financial card information, the consumer banking identification number and the merchant identification number are embedded on the computer readable medium using an application program interface associated with the server emulation software.

22. The article of manufacture recited in claim 17, wherein at least one of the financial card information, the consumer banking identification number and the merchant identification number are automatically loaded into a memory device of the host device when the computer readable medium is accessed.

23. The article of manufacture recited in claim 22, wherein the memory device is a random access memory device.

24. The article of manufacture recited in claim 22, wherein the memory device is at least one of flushed and overwritten when the consumer completes a transaction.

25. The article of manufacture recited in claim 17, wherein the at least one of the financial card information, the consumer banking identification number and the merchant identification number is relegated to first in first out access in the host device when the computer readable medium is accessed such that a port conveying the financial card information is only opened for a short period of time.

26. The article of manufacture recited in claim 17, wherein at least one of the financial card information, the consumer banking identification number and the merchant identification number is password protected.

27. The article of manufacture recited in claim 26, wherein the consumer pre-registers at least one of a password and a personal identification number with a financial institution that issued the computer readable medium to the consumer.

28. The article of manufacture recited in claim 17, wherein the server emulation software includes software for establishing a direct connection between the host device and a clearing bank.

29. The article of manufacture recited in claim 28, wherein when the consumer obtains at least one of a product and a service from the at least one virtual store, the host device provides directly to the clearing bank at least one of a transaction amount, the financial card information, and the merchant account information.

30. The article of manufacture recited in claim 29, wherein the at least one of a transaction amount, the financial card information, and the merchant account information is provided to the clearing bank via a secure communication protocol.

31. The article of manufacture recited in claim 29, wherein the clearing bank employs an application program interface associated with the server emulation software for receiving the at least one of a transaction amount, the financial card information, and the merchant account information.

32. The article of manufacture recited in claim 31, wherein the application program interface decrypts at least one of the financial card information and the merchant account information received directly from the host device.

33. The article of manufacture recited in claim 28, wherein when the consumer obtains at least one of a product and a service from the at least one virtual store, the host device provides to the merchant associated with the at least one virtual store at least one of a purchase order, the consumer banking identification number and the consumer's name and address.

34. The article of manufacture recited in claim 33, wherein the merchant employs an application program interface associated with the server emulation software to receive the at least one of a purchase order, the consumer banking identification number and the consumer's name and address.

35. The article of manufacture recited in claim 33, wherein the at least one of a purchase order, the consumer banking identification number and the consumer's name and address are provided to the merchant via a network.

36. The article of manufacture recited in claim 33, wherein the at least one of a purchase order, the consumer banking identification number and the consumer's name and address are provided to the merchant via the Internet.

37. The article of manufacture recited in claim 33, wherein the at least one of a purchase order, the consumer banking identification number and the consumer's name and address are provided to the merchant via at least one of e-mail, facsimile, or mail.

38. The article of manufacture recited in claim 33, wherein the application program interface decrypts the consumer banking identification number.

39. The article of manufacture recited in claim 17, wherein the server emulation software includes software for establishing a connection between the host device and a clearing bank via a dedicated server including software associated with the server emulation software for receiving at least one of an amount to be verified, the financial card information, the consumer banking identification number and the merchant account information.

40. The article of manufacture recited in claim 39, wherein when the consumer obtains at least one of a product and a service from the at least one virtual store, the host device provides to the dedicated server at least one of a transaction amount, the financial card information, and the merchant account information.

41. The article of manufacture recited in claim 40, wherein the dedicated server provides to the clearing bank the at least one of a transaction amount, the financial card information, and the merchant account information.

42. The article of manufacture recited in claim 17, wherein the at least one virtual store is accessible to the consumer for a predetermined period of time.

43. The article of manufacture recited in claim 17, wherein the server emulation software includes software for establishing a connection between the host device and at least one Internet website and for enabling the consumer to shop on the Internet website for at least one of a product and a service.

44. The article of manufacture recited in claim 43, wherein the host device is connected to the Internet website via a dedicated server including software associated with the server emulation software for receiving the consumer banking identification number.

45. The article of manufacture recited in claim 44, wherein the Internet website includes an application program interface associated with the server emulation software for communicating with the server emulation software.

46. An article of manufacture comprising a computer readable medium on which server emulation software is stored and from which Interactive Media Site (IMS) software can be accessed by a local host device, wherein the computer readable medium comprises:
an encrypted data string including identity verification information; and
software for decrypting the data string.

47. The article of manufacture recited in claim 46, wherein the server emulation software includes software for establishing a connection between the host device and at least one Internet website and for enabling the consumer to shop on the Internet website for at least one of a product and a service.

48. The article of manufacture recited in claim 46, wherein the data string comprises a randomly generated number and at least one of a password and a personal identification number.

49. The article of manufacture recited in claim 48, wherein the at least one of a password and a personal identification number is provided for identity verification by a consumer to a financial institution that issues the computer readable medium to the consumer.

50. The article of manufacture recited in claim 48, wherein the randomly generated number is generated by the issuing financial institution and associated with a cardholder account.

51. The article of manufacture recited in claim 46, wherein the identity verification information is embedded on the computer readable medium using an application program interface associated with the server emulation software.

52. The article of manufacture recited in claim 46, wherein the software for decrypting the data string includes software for providing an encryption layer.

53. The article of manufacture recited in claim 52, wherein the encryption layer comprises algorithms for encrypting and decrypting the identity verification information.

54. The article of manufacture recited in claim 52, wherein the encryption layer comprises algorithms for disassembling and reassembling the identity verification information.

55. The article of manufacture recited in claim 52, wherein the encryption layer comprises algorithms for re-sequencing the identity verification information.

56. The article of manufacture recited in claim 46, wherein the server emulation software further comprises software for establishing a connection with a financial institution that issued the computer readable medium and for providing to the financial institution the identity verification information.

57. The article of manufacture recited in claim 56, wherein the server emulation software comprises algorithms for disassembling the identity verification information before providing the identity verification information to the financial institution.

58. The article of manufacture recited in claim 56, wherein the server emulation software comprises algorithms for altering the sequence in which the identity verification information is received by the financial institution.

59. The article of manufacture recited in claim 56, wherein the server emulation software establishes the connection with the financial institution via an application program interface associated with the server emulation software.

60. The article of manufacture recited in claim 56, wherein the application program interface comprises algorithms for disassembling and reassembling identity verification information.

61. The article of manufacture recited in claim 56, wherein the application program interface comprises algorithms for sequencing and re-sequencing identity verification information.

62. The article of manufacture recited in claim 46, wherein the server emulation software further comprises software for:
querying a consumer for a first password;
reading the first password entered by the consumer;
accessing the identity verification information on the computer readable medium;
decrypting the identity verification information;
isolating the at least one of a password and a personal identification number; and
comparing the at least one of a password and a personal identification number with the first password entered by the consumer.

63. The article of manufacture recited in claim 62, wherein the server emulation software further comprises software for:
isolating the randomly generated number when the at least one of a password and a personal identification number matches the first password entered by the consumer;
establishing a connection with a financial institution that issued the computer readable medium;
accessing a cardholder account associated with the randomly generated number; and
receiving queries from the financial institution.

64. The article of manufacture recited in claim 63, wherein establishing a connection with the financial institution comprises establishing the connection via an application program interface associated with the server emulation software.

65. The article of manufacture recited in claim 63, wherein accessing a cardholder account comprises accessing a data string associated with the cardholder account.

66. The article of manufacture recited in claim 65, wherein accessing a data string associated with the cardholder account comprises accessing the data string via an application program interface associated with the server emulation software.

67. The article of manufacture recited in claim 66, wherein the application program interface includes software for encrypting and decrypting the data string.

68. The article of manufacture recited in claim 66, wherein the application program interface includes software for assembling and disassembling the data string.

69. The article of manufacture recited in claim 66, wherein the application program interface includes software for sequencing and re-sequencing the data string.

70. The article of manufacture recited in claim 63, wherein receiving queries comprises receiving a request for at least one of an additional password, an additional personal identification number, and a machine identification.

71. The article of manufacture recited in claim 65, wherein the data string comprises a copy of the randomly generated number and the at least one of a password and a personal identification number.

72. The article of manufacture recited in claim 71, wherein the data string further comprises additional identity verification information.

73. The article of manufacture recited in claim 72, wherein the additional identity verification information comprises at least one of an additional password and an additional personal identification number.

74. The article of manufacture recited in claim 72, wherein the additional identity verification information comprises a machine identification.

75. The article of manufacture recited in claim 73, wherein the server emulation software further comprises software for:
querying the consumer for a second password;
reading the second password entered by the consumer;
providing the second password to the financial institution; and
receiving from the financial institution the consumer's financial card information, when the second password matches the at least one of an additional password and an additional personal identification number.

76. The article of manufacture recited in claim 74, wherein the server emulation software further comprises software for:
querying the host device for a machine identification;
reading the machine identification from the host device;
providing the machine identification to the financial institution; and
receiving from the financial institution the consumer's financial card information, when the transmitted machine identification matches the machine identification included in the identity verification information.

77. The article of manufacture recited in claim 75, wherein the financial card information comprises at least one of a financial card number and cardholder account information.

78. The article of manufacture recited in claim 75, wherein the server emulation software further comprises software for providing the financial card information directly to a clearing bank.

79. The article of manufacture recited in claim 75, wherein the server emulation software further comprises software for providing the financial card information directly to a consolidated bank.

80. The article of manufacture recited in claim 75, wherein the server emulation software further comprises software for providing the consumer's name and address to a carrier.

81. The article of manufacture recited in claim 47, wherein the server emulation software further comprises software for providing to a merchant a customer identification number.

82. The article of manufacture recited in claim 56, wherein the server emulation software includes software for establishing a connection with the financial institution via a dedicated server.

83. The article of manufacture recited in claim 82, wherein the dedicated server includes software associated with the server emulation software for disassembling the identity verification information before providing the identity verification information to the financial institution.

84. The article of manufacture recited in claim 82, wherein the dedicated server includes software associated with the server emulation software for altering the sequence in which the identity verification information is received by the financial institution.

85. A method for enabling a consumer to engage in an E-commerce transaction requiring a financial card, the method comprising:
providing to the consumer a computer readable medium on which server emulation software is stored and from which Interactive Media Site (IMS) software can be accessed by a local host device;
providing on the computer readable medium at least one virtual store from which a consumer may obtain at least one of a product and a service; and
providing on the computer readable medium financial card information for providing payment for the at least one of the product and the service obtained by the consumer.

86. The method recited in claim 85, further comprising:
providing on the computer readable medium a consumer banking identification number for associating the consumer with a cardholder account; and
providing on the computer readable medium merchant account information identifying at least one merchant associated with the at least one virtual store.

87. A method for enabling a consumer to engage in an E-commerce transaction requiring a financial card, the method comprising:
providing to the consumer a computer readable medium on which server emulation software is stored and from which Interactive Media Site (IMS) software can be accessed by a local host device;
providing on the computer readable medium an encrypted data string including identity verification information; and
providing on the computer readable medium software for decrypting the data string.

88. The method recited in claim 87, further comprising:
querying the consumer for a first password;
reading the first password entered by the consumer;
accessing the identity verification information on the computer readable medium;
decrypting the identity verification information;
isolating at least one of a password and a personal identification number included in the data string; and
comparing the at least one of a password and a personal identification number with the first password entered by the consumer.

89. The method recited in claim 88, further comprising:
isolating a randomly generated number included in the data string when the at least one of a password and a personal identification number matches the first password;
establishing a connection with a financial institution;
accessing a cardholder account associated with the randomly generated number; and
receiving queries from the financial institution.

90. The method recited in claim 89, wherein receiving queries comprises receiving a request for at least one of an additional password, an additional personal identification number, and a machine identification.

91. The method recited in claim 90, further comprising:
querying the consumer for a second password;
reading the second password entered by the consumer;
providing the second password to the financial institution; and
receiving from the financial institution the consumer's financial card information, when the at least one of an additional password and an additional personal identification number matches the second password.

92. A method for enabling a consumer to engage in an E-commerce transaction requiring a financial card, the method comprising:
receiving from a bank customer identity verification information;
generating a randomly generated number;
combining the randomly generated number and identity verification information into a first data string; and
associating the first data string with a cardholder account maintained for the bank customer by a financial institution.

93. The method recited in claim 92, further comprising:
encrypting the first data string; and
storing the first data string in a customer records data base.

94. The method recited in claim 93, wherein the identity verification information comprises at least one of a password and a personal identification number.

95. The method recited in claim 93, wherein the identity verification information comprises a merchant identification.

96. The method recited in claim 93, further comprising:
combining a copy of the randomly generated number and a copy of a portion of the identity verification information into a second data string;
embedding the second data string on a computer readable medium;
providing the computer readable medium to the bank customer.

97. The method recited in claim 96, wherein the a portion of the identity verification information comprises at least one of a password and a personal identification number.

98. The method recited in claim 96, further comprising encrypting the second data string.

99. The method recited in claim 96, wherein providing the computer readable medium to the bank customer comprises sending the computer readable medium to the bank customer by mail.

100. The method recited in claim 96, further comprising providing on the computer readable medium server emulation software from which Interactive Media Site (IMS) software can be accessed by a local host device.

101. The method recited in claim 100, wherein the server emulation software includes software for:
querying the bank customer for a first password;
reading the first password entered by the bank customer;
accessing the identity verification information on the computer readable medium;
decrypting the identity verification information on the computer readable medium;
isolating at least one of a password and a personal identification number included in the second data string; and
comparing the at least one of a password and a personal identification number with the first password entered by the bank customer.

102. The method recited in claim 101, wherein the server emulation software further includes software for:
isolating the copy of the randomly generated number in the second data string when the at least one of a password and a personal identification number matches the first password;
establishing a connection with the financial institution;
accessing the cardholder account associated with the randomly generated number; and
receiving queries from the financial institution.

103. The method recited in claim 102, wherein receiving queries comprises receiving a request for at least one of an additional password, an additional personal identification number, and a machine identification.

104. The method recited in claim 103, wherein the server emulation software further includes software for:
querying the consumer for a second password;
reading the second password entered by the consumer;
providing the second password to the financial institution; and
receiving from the financial institution the consumer's financial card information, when the at least one of an additional password and an additional personal identification number matches the second password.
